(19) United States
(12) Patent Application Publication
(10) Pub. No.: US 2015/0079379 A1
(43) Pub. Date: Mar. 19, 2015

(54) POLYMERIZABLE COMPOSITION, POLYMER, OPTICAL ADHESIVE SHEET, IMAGE DISPLAY DEVICE, AND METHOD FOR MANUFACTURING IMAGE DISPLAY DEVICE

(71) Applicant: SHOWA DENKO K.K., Minato-ku, Tokyo (JP)

(72) Inventors: Kai Suzuki, Minato-ku (JP); Hiroto Kouka, Minato-ku (JP); Kazuhiko Ooga, Minato-ku (JP)

(73) Assignee: SHOWA DENKO K.K., Minato-ku, Tokyo (JP)

(21) Appl. No.: 14/397,259

(22) PCT Filed: Jun. 14, 2013
(86) PCT No.: PCT/JP2013/066496

§ 371 Date: Oct. 27, 2014

(30) Foreign Application Priority Data
Jun. 15, 2012 (JP) 2012-135950

(51) Int. Cl. C09J 151/00; C09J 7/00; C09J 151/08

(52) U.S. Cl. CPC C09J 151/003; C09J 151/08; C09J 7/00; C09J 2451/00; C09J 2423/00; C09J 2203/318
USPC 428/220; 522/18; 522/28; 524/388; 428/523

(57) ABSTRACT

Provided are: a polymerizable composition; a polymer obtained by polymerizing the composition (including an optical adhesive sheet); an image display device using the polymer; and a method for manufacturing the image display device. The polymerizable composition includes: (1) at least one chosen from the group consisting of a compound including a (meth)acrylol group with a polyolefin structural unit, a compound including a (meth)acrylol group with a hydrogenated polyolefin structural unit, a compound including a (meth)acrylol group with a (poly)ester structural unit, and a compound including a (meth)acrylol group with a (poly)carbonate structural unit; (2) a liquid compound including a (meth)acrylol group other than constituent (1); (3) at least one chosen from the group consisting of liquid hydrogenated polybutadiene polyol, liquid hydrogenated polyisoprene polyol, and hydrogenated dimer diol; and (4) a photopolymerization initiator.

### TECHNICAL FIELD

The present invention relates to a polymerizable composition used for an image-display device such as a liquid crystal display device used for a smartphone, a tablet PC, or the like, a polymerization product obtained by polymerizing the composition, a manufacturing method of an image-display device employing the composition, and an image-display device manufactured by the manufacturing method.

### BACKGROUND ART

Conventionally, for example, a liquid crystal display device 101 illustrated in FIG. 6 is known as such an image-display device.

As illustrated in FIG. 6, the liquid crystal display device 101 comprises, on a liquid crystal display panel 102, for example, a transparent protection unit 103 composed of glass or plastics.

In such cases, in order to protect the surface of liquid crystal display panel 102 and a polarizing plate (not illustrated), space 105 is provided between liquid crystal display panel 102 and the protection unit 103 by interposing a spacer 104 between the liquid crystal display panel 102 and the protection unit 103.

However, since there is space 105 between the liquid crystal display panel 102 and protection unit 103, scattering of light occurs, which causes a decrease in the contrast or the brightness. Space 105 is also an obstacle to thin a panel.

Although filling a gap between a liquid crystal display panel and a protection unit with a resin (see FIG. 1) is also proposed in view of such a problem (see, for example, Patent Document 1), stress during curing of the cured resin creates a deformation on an optical glass holding a liquid crystal of the liquid crystal display panel, which causes a display failure such as misalignment of a liquid crystal material.

In order to solve the above-mentioned problems, for example, Patent Document 2 or Patent Document 3 discloses a curable composition with a low elastic modulus and a low volume shrinkage rate when cured using a polyurethane acrylate or an esterified product of a maleic anhydride adduct of a polyisoprene polymer and 2-hydroxyethyl methacrylate.

However, the volume shrinkage rate of the curable composition using a polyurethane acrylate when cured is high (higher than 4.0%), and although the volume shrinkage rate of the curable composition using an esterified product of a maleic anhydride adduct of a polyisoprene polymer and 2-hydroxyethyl methacrylate when cured is low, the thermal coloration of the cured product becomes large, which has been problematic.

In recent years, regarding cellular phones, smartphones are common, and devices referred to as “tablet PC” are also becoming more common. Usually, a capacitive touch panel is mounted on such a device. Polymerization product (layer) (polymerization product (layer) of 5b described in FIG. 2 and FIG. 3) which is filled between a display unit and a touch panel in an Out-Cell type capacitive touch panel display device illustrated in FIG. 2 or FIG. 3 as one example of a capacitive touch panel, or polymerization product (layer) (polymerization product (layer) of 5b described in FIG. 4 and FIG. 5) which is filled between a display unit and a touch sensor integrated protection unit in a cover glass-touch sensor integrated capacitive touch panel display device is desired to be of a material having a low dielectric constant from a viewpoint of preventing malfunction and from a viewpoint of making a film thin.

### PRIOR ART DOCUMENTS

### Patent Documents

### [Patent Document 1] Japanese Laid-open Patent Publication No. 2005-55641

### [Patent Document 2] Japanese Laid-open Patent Publication No. 2008-282000

### [Patent Document 3] Japanese Laid-open Patent Publication No. 2009-186958

### SUMMARY OF INVENTION

### Technical Problem

In order to solve the above-mentioned problems, the present invention aims at providing: a polymerizable composition for manufacturing polymerization product whose volume shrinkage rate during polymerization is small, whose dielectric constant is low, and whose thermal coloration is little; polymerization product (including an optical adhesive sheet) obtained by polymerizing the composition; an image-display device using the polymerization product; and a method of manufacturing the image-display device.

### Solution to Problem

In order to solve the above-mentioned problems, the present inventors conducted a continuous research to find that a photopolymerizable composition containing a (meth)acryloyl group-containing compound having a specific structure has a small volume shrinkage rate during polymerization, that a polymerization product obtained by polymerizing the composition has a low resistance to thermal coloration, and that the dielectric constant is low, thereby completing the invention.

In other words, the invention (I) relates to a polymerizable composition for manufacturing a polymerization product for forming a polymerization product layer interposed between an image-display unit and a light-transmitting protection unit of an image-display device, wherein the polymerizable composition comprises

Component (1): at least one selected from the group consisting of a (meth)acryloyl group-containing compound having a polyolefin structural unit, a (meth)acryloyl group-containing compound having a hydrogenated polyolefin structural unit, a (meth)acryloyl group-containing compound having a (poly)ester structural unit, and a (meth)acryloyl group-containing compound having a (poly) carbonate structural unit;

Component (2): a liquid (meth)acryloyl group-containing compound other than the Component (1);

Component (3): at least one selected from the group consisting of a liquid hydrogenated polybutadiene polyol, a liquid hydrogenated polyisoprene polyol, and a hydrogenated dimer diol; and Component (4): a photopolymerization initiator.

The invention (II) relates to a polymerization product obtained by polymerizing the polymerizable composition of the invention (I).

The invention (III) relates to an optical adhesive sheet having a polymerization product layer with a thickness of 10 to 500 μm, which is obtained by applying the polymerizable composition of the invention (I), and by irradiating the polymerizable composition with a light to which a photopolymerization initiator is photosensitive to polymerize.

The invention (IV) relates to a method of manufacturing an image-display device comprising a base unit having an image-display unit, a light-transmitting protection unit, and a polymerization product layer interposed between the base unit and the protection unit, comprising the steps of

interposing the polymerizable composition of the invention (I) between the base unit and the protection unit; and

irradiating the polymerizable composition with a light to which the photopolymerization initiator is photosensitive to form a polymerization product layer.

The invention (V) relates to a method of manufacturing an image-display device comprising the step of sticking a polymerization product layer between a base unit having an image-display unit and a light-transmitting protection unit by using an optical adhesive sheet, wherein the optical adhesive sheet is the optical adhesive sheet of the invention (III).

The invention (VI) relates to an image-display device manufactured by the method of the invention (IV) or the invention (V).

More specifically, the invention relates to the following items [1] to [12].

[1] A polymerizable composition for manufacturing a polymerization product for forming a polymerization product layer interposed between an image-display unit and a light-transmitting protection unit of an image-display device, wherein the polymerizable composition comprises

Component (1): at least one selected from the group consisting of a (meth)acryloyl group-containing compound having a polyolefin structural unit, a (meth)acryloyl group-containing compound having a hydrogenated polyolefin structural unit, a (meth)acryloyl group-containing compound having a (poly)ester structural unit, and a (meth)acryloyl group-containing compound having a (poly) carbonate structural unit;

Component (2): a liquid (meth)acryloyl group-containing compound other than Component (1);

Component (3): at least one selected from the group consisting of a liquid hydrogenated polybutadiene polyol, a liquid hydrogenated polyisoprene polyol, and a hydrogenated dimer diol; and

Component (4): a photopolymerization initiator.

[2] The polymerizable composition according to claim 1, further comprising

Component (5): at least one selected from the group consisting of hydrogenated polybutadiene, hydrogenated polyisoprene, a poly(α-olefin) liquid substance, an ethylene-propylene copolymer liquid substance, a propylene-α-olefin copolymer liquid substance, an ethylene-α-olefin copolymer liquid substance, liquid polybutene, liquid hydrogenated polybutene, liquid polybutadiene, liquid hydrogenated polybutadiene, liquid polyisoprene, liquid hydrogenated polyisoprene, liquid polybutadiene polyol, and liquid polyisoprene polyol. [3] The polymerizable composition according to [1] or [2], further comprising

Component (6): at least one selected from the group consisting of hydrogenated petroleum resins, hydrogenated terpene resins, and a hydrogenated rosin ester. [4] The polymerizable composition according to any one of [1] to [3], wherein Component (2) comprises a (meth)acryloyl group-containing compound having a hydrocarbon group containing six or more carbon atoms.

[5] The polymerizable composition according to any one of [1] to [4], wherein Component (2) comprises a (meth)acryloyl group-containing compound having an alcoholic hydroxyl group.

[6] A polymerization product obtained by polymerizing the polymerizable composition according to any one of [1] to [5].

[7] A polymerizable composition for manufacturing an optical adhesive sheet used for the polymerization product layer, wherein the polymerizable composition is the polymerizable composition according to any one of [1] to [5].

[8] An optical adhesive sheet having a polymerization product layer with a thickness of 10 to 500 μm, which is obtained by irradiating the polymerizable composition according to [7] with a light to which the photopolymerization initiator is photosensitive to polymerize.

[9] A method of manufacturing an image-display device comprising a base unit having an image-display unit, a light-transmitting protection unit, and a polymerization product layer interposed between the base unit and the protection unit, comprising the steps of

interposing the polymerizable composition according to any one of [1] to [5] between the base unit and the protection unit; and

irradiating the polymerizable composition with a light to which the photopolymerization initiator is photosensitive to form a polymerization product layer.

[10] A method of manufacturing an image-display device, comprising the step of sticking a polymerization product layer between a base unit having an image-display unit and a light-transmitting protection unit by using an optical adhesive sheet, wherein the optical adhesive sheet is the optical adhesive sheet according to [8].

[11] An image-display device manufactured by the method according to [9] or [10].

[12] The image-display device according to [11], wherein the image-display unit is a liquid crystal display panel.

### Advantageous Effects of Invention

The volume shrinkage rate of a polymerizable composition of the invention during polymerization is low, and change in outer appearance such as coloration of a polymerization product obtained by polymerizing the polymerizable composition of the invention is less likely to occur even when the polymerization product is stored under a high temperature condition for a long period of time, and a favorable optical transparency can be maintained.

### BRIEF DESCRIPTION OF DRAWINGS

FIG. 1 is a cross section illustrating a main unit of an embodiment of a display device pertaining to the invention.

FIG. 2 is a cross section illustrating a main unit of an embodiment of a display device pertaining to the invention.

FIG. 3 is a cross section illustrating a main unit of an embodiment of a display device pertaining to the invention.

FIG. 4 is a cross section illustrating a main unit of an embodiment of a display device pertaining to the invention.

FIG. 5 is a cross section illustrating a main unit of an embodiment of a display device pertaining to the invention.

FIG. 6 is a cross section illustrating a main unit of a display device pertaining to a conventional art.

### DESCRIPTION OF EMBODIMENTS

The invention will now be described concretely.

The form of the “polymerization product” described herein is not particularly restricted as long as the polymerization product is a polymerization product obtained by polymerizing a polymerizable composition, and the term “optical adhesive sheet” herein is also included in the term “polymerization product”.

The term “polymerization product layer interposed between an image-display unit and a light-transmitting protection unit” means every polymerization product layer between an image-display unit and a light-transmitting protection unit. For example, any of 5a and 5b in FIG. 2 is included in the terms.

The term “(meth)acryloyl group” herein means an acryloyl group and/or a methacryloyl group.

Further, the term “(poly)ester polyol” herein means a compound having, in one molecule, one or more —COO— bonds (carboxylic acid ester bond) and two or more alcoholic hydroxyl groups, and the term “(poly)carbonate polyol” means a compound having, in one molecule, one or more —OCOO— bonds (carbonate bond) and two or more alcoholic hydroxyl groups.

Herein, in cases in which a polyol (in other word, a polyol which does not have a —COO— bond (carboxylic acid ester bond)) which is a raw material of (poly)ester polyol remains when a (poly)ester polyol which can be a raw material of Component (1) which is an essential raw material component of the polymerizable composition of the invention (I) is manufactured, such a polyol is also defined to be included in the (poly)ester polyol. In addition, herein, when the Component (1) which is an essential component of the polymerizable composition of the invention (I) is manufactured by newly adding a polyol which is a raw material component of a (poly)ester polyol to be used other than a raw material polyol included in the (poly)ester polyol, the added polyol is included in the (poly)ester polyol even when the polyol is a polyol without a —COO— bond (carboxylic acid ester bond).

Further, in cases in which a polyol (in other word, a polyol which does not have a carbonate bond) which is a raw material of (poly)carbonate polyol remains when a (poly) carbonate polyol which can be a raw material of Component (1) which is an essential raw material component of the polymerizable composition of the invention (I) is manufactured, such a polyol is also included in the (poly)carbonate polyol. In addition, herein, when the Component (1) which is an essential component of the polymerizable composition of the invention (I) is manufactured by newly adding a polyol which is a raw material component of a (poly)carbonate polyol to be used other than a raw material polyol included in the (poly)carbonate polyol, the added polyol is included in the (poly)carbonate polyol.

First, the invention (I) will be described.

The invention (I) is a polymerizable composition for forming a polymerization product layer interposed between an image-display unit and a light-transmitting protection unit of an image-display device, characterized in that the polymerizable composition comprises, as essential components, the following Components (1) to (4).

Component (1): at least one selected from the group consisting of a (meth)acryloyl group-containing compound having a polyolefin structural unit, a (meth)acryloyl group-containing compound having a hydrogenated polyolefin structural unit, a (meth)acryloyl group-containing compound having a (poly)ester structural unit, a (meth)acryloyl group-containing compound having a (poly) carbonate structural unit, and a (meth)acryloyl group-containing compound having a polyether structural unit

Component (2): a liquid (meth)acryloyl group-containing compound other than Component (1)

Component (3): at least one selected from the group consisting of a liquid hydrogenated polybutadiene polyol, a liquid hydrogenated polyisoprene polyol, and a hydrogenated dimer diol

Component (4): photopolymerization initiator

The term “a structural unit derived from a (poly)ester polyol” herein refers to the structure of a compound which has, in one molecule, one or more —COO— bonds (carboxylic acid ester bond) and two or more alcoholic hydroxyl groups and in which compound H is removed from at least one of the alcoholic hydroxyl groups.

Further, the term “a structural unit derived from a (poly) carbonate polyol” herein refers to the structure of a compound which has, in one molecule, one or more carbonate bonds and two or more alcoholic hydroxyl groups and in which compound H is removed from at least one of the alcoholic hydroxyl groups.

First, the component (1) which is an essential raw material component for the polymerizable composition of the invention (I) will be described.

The component (1) which is an essential raw material component of polymerizable composition of the invention (I) is at least one (meth)acryloyl group-containing compound selected from the group consisting of a (meth)acryloyl group-containing compound having a polyolefin structural unit, a (meth)acryloyl group-containing compound having a hydrogenated polyolefin structural unit, a (meth)acryloyl group-containing compound having a (poly)ester structural unit, and a (meth)acryloyl group-containing compound having a (poly)carbonate structural unit.

The (meth)acryloyl group-containing compound having a polyolefin structural unit is not particularly restricted as long as it is a compound having a polyolefin structural unit and a (meth)acryloyl group. The polyolefin structural unit is preferably a compound having a polydiene structural unit, and examples thereof include a polydiene structural unit obtained by polymerizing at least one diene selected from the group consisting of 1,3-butadiene, 1,3-pentadiene, isoprene, 2,3-dimethyl-1,3-butadiene, 2-phenyl-1,3-butadiene, 2-propyl-1,3-butadiene, 1,3-heptadiene, 6-methyl-1,3-heptadiene, 1,3-hexadiene, 5-methyl-1,3-hexadiene, 2,4-hexadiene, 2,5-dimethyl-2,4-hexadiene, and 1,3-octadiene.

Among these, preferred is a polybutadiene structural unit, a polyisoprene structural unit, or a poly(butadiene-isoprene) structural unit.

Examples of commercially available (meth)acryloyl group-containing compound having a polyolefin structural unit include: KurapreneUC-102, UC-203 (manufactured by KURARAY CO., LTD.) each of which is a methacryloyl group-containing compound having a polyisoprene structural unit; NISSO-PB TE-2000 (manufactured by Nippon Soda Co., Ltd.) which is a methacryloyl group-containing compound having a polybutadiene structural unit; and NISSO-PB TEA-1000 (manufactured by Nippon Soda Co., Ltd.) which is an acryloyl group-containing compound having a polybutadiene structural unit.

NISSO-PB TE-2000 and NISSO-PB TEA-1000 are a reaction product of a polybutadiene polyol such as NISSO-PB G-1000 or G-2000 (manufactured by Nippon Soda Co., Ltd.), an organic polyisocyanate compound, and an alcoholic hydroxyl group-containing (meth)acrylate. As seen above, a polyolefin polyol is useful as a raw material for manufacturing a (meth)acryloyl group-containing compound having a polyolefin structural unit, and examples of commercially available polyolefin polyol include, other than NISSO PB G-1000, G-2000, or G-3000 (manufactured by Nippon Soda Co., Ltd.) which is a polybutadiene polyol that is a commercially available product of the above-mentioned polyolefin polyol, Poly bd (manufactured by Idemitsu Kosan Co., Ltd.) which is a hydroxyl group end liquid polybutadiene, Poly Ip (manufactured by Idemitsu Kosan Co., Ltd.) which is a hydroxyl group end liquid polyisoprene, and KRASOL (manufactured by Cray Valley Corporation) which is a liquid polybutadiene diol.

A method of manufacturing a (meth)acryloyl group-containing compound having a polyolefin structural unit is not particularly restricted, and the compound can be manufactured, for example, by the following method.

Firstly, a case of obtaining a (meth)acryloyl group-containing compound having a polyolefin structural unit by using a polyolefin polyol, an organic polyisocyanate compound, and an alcoholic hydroxyl group-containing (meth)acrylate as the essential raw material components will be described.

A polyolefin polyol represented by a polybutadiene polyol or a polyisoprene polyol has two or more hydroxyl groups in one molecule, and preferably has two to four hydroxyl groups. The hydroxyl group value of the polyolefin polyol is preferably 10 to 80 mgKOH/g, further preferably 17 to 70 mgKOH/g, and particularly preferably 23 to 65 mgKOH/g. When the hydroxyl group value of a polyolefin polyol compound is smaller than 10 mgKOH/g, the molecular weight and viscosity of a (meth)acrylic group-containing polyolefin compound to be obtained become too high, and handling properties thereof deteriorate, which tends to make it difficult to handle the compound. When the hydroxyl group value of the polyolefin polyol compound is larger than 80 mgKOH/g, the volume shrinkage rate thereof during polymerization becomes too large, and the cohesion of polymerization product becomes too high, and the adhesive performance of polymerization product is not sufficiently exerted in some cases, which is not preferred.

A polybutadiene polyol is a homopolymer of butadiene containing a hydroxyl group. A polyisoprene polyol is a homopolymer of isoprene containing a hydroxyl group.

The organic polyisocyanate compound is not particularly restricted as long as it is an organic compound having, in one molecule, two or more isocyanato groups. Specific examples thereof include 1,4-cyclohexane diisocyanate, isophorone diisocyanate, methylene bis(4-cyclohexyl isocyanate), 1,3-bis(isocyanatomethyl)cyclohexane, 1,4-bis(isocyanatomethyl)cyclohexane, 2,4-tolylenediisocyanate, 2,6-tolylenediisocyanate, diphenylmethane-4,4′-diisocyanate, 1,3-xylylene diisocyanate, 1,4-xylylene diisocyanate, lysine triisocyanate, lysine diisocyanate, hexamethylene diisocyanate, 2,4,4-trimethyl hexamethylene diisocyanate, 2,2,4-trimethylhexanemethylene diisocyanate and norbornane diisocyanate. These may be used singly or in combination of two or more thereof.

The component (1) which is an essential component of the polymerizable composition of the invention (I) desirably has a low viscosity in view of the degree of freedom for the subsequent blending. Specific examples of an organic polyisocyanate compound which meets this purpose preferably include 1,3-bis(isocyanatomethyl)cyclohexane, 1,4-bis(isocyanatomethyl)cyclohexane, 2,4,4-trimethyl hexamethylene diisocyanate, 2,2,4-trimethylhexanemethylene diisocyanate, 1,6-hexamethylene diisocyanate and norbornane diisocyanate, and further preferably include 1,3-bis(isocyanatomethyl)cyclohexane, 2,4,4-trimethyl hexamethylene diisocyanate and 2,2,4-trimethylhexanemethylene diisocyanate, and most preferably include 2,4,4-trimethyl hexamethylene diisocyanate and 2,2,4-trimethylhexanemethylene diisocyanate.

The alcoholic group-containing (meth)acrylate is not particularly restricted as long as it is a (meth)acrylate having, in one molecule, an alcoholic hydroxyl group. Specific examples thereof include 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, 2-hydroxy-3(o-phenyl phenoxy)propyl acrylate, 2-hydroxyethyl acrylamide, 2-hydroxyethyl methacrylate, 2-hydroxypropyl methacrylate, 3-hydroxypropyl methacrylate, 2-hydroxybutyl methacrylate, 4-hydroxybutyl methacrylate, 2-hydroxy-3-phenoxypropyl methacrylate, and 2-hydroxy-3-(o-phenyl phenoxy)propyl methacrylate.

Among these, in view of the polymerization rate of the component (1) which is an essential component of the invention (I), preferred are 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, and 2-hydroxy-3-(o-phenyl phenoxy)propyl acrylate. In view of the reactivity with an isocyanate group, preferred are 2-hydroxyethyl acrylate, 3-hydroxypropyl acrylate, and 4-hydroxybutyl acrylate, and most preferred is 4-hydroxybutyl acrylate.

As a method of reacting a polyolefin polyol, an organic polyisocyanate compound, and an alcoholic hydroxyl group-containing (meth)acrylate, a method in which a polyolefin polyol, an organic polyisocyanate compound and an alcoholic hydroxyl group-containing (meth)acrylate in the presence or absence of a known urethanization catalyst such as dibutyl tin dilaurylate, or dioctyltin dilaurate can be employed to synthesize. In view of shortening the reaction time, the reaction is performed in the presence of a catalyst. It is noted that, since a too large amount of the catalyst may finally adversely affect the physical properties of a cured film during its use, the amount of the catalyst to be used is preferably from 0.001 to 1 parts by mass with respect to 100 parts by mass of the total amount of the polyolefin polyol, the organic polyisocyanate compound, and the alcoholic hydroxyl group-containing (meth)acrylate.

Although the order of blending the raw materials is not particularly restricted, when the end of a compound is almost completely sealed with a compound having, in one molecule, a hydroxyl group including an alcoholic hydroxyl group-containing (meth)acrylate, usually, an organic polyisocyanate compound and, as needed, a urethanization catalyst are input into a reactor and the mixture is stirred, and then a polyolefin polyol, and as needed, a polyol component other than the polyolefin polyol are input successively at a temperature in the reactor of from 40° C. to 140° C., and preferably from 50° C. to 120° C., and thereafter, the resultant mixture is allowed to react at a temperature in the reactor of from 50° C. to 160° C., preferably from 60° C. to 140° C. Then, a polymerization inhibitor and, as needed, a urethanization catalyst are added thereto at a temperature in the reactor of from 30° C. to 120° C., preferably from 50° C. to 100° C., and the alcoholic hydroxyl group-containing (meth)acrylate is input by dropping. During dropping, the temperature in the reactor is preferably maintained at from 30° C. to 120° C., and desirably from 50° C. to 100° C. After the completion of dropping, the temperature in the reactor is maintained at from 30° C. to 120° C., desirably from 50° C. to 100° C. to complete the reaction.

When only a part of the end of the compound is sealed with a compound having, in the molecule, one hydroxyl group including an alcoholic hydroxyl group-containing (meth)acrylate, usually, an organic polyisocyanate compound, and, as needed, a polymerization inhibitor and/or a urethanization catalyst are input into a reactor, and the mixture is stirred, and thereafter, an alcoholic hydroxyl group-containing (meth)acrylate is input by dropping at a temperature in the reactor of from 30° C. to 120° C., preferably from 50° C. to 110° C. During dropping, the temperature in the reactor is preferably maintained at from 30° C. to 120° C., desirably from 50° C. to 110° C. After the completion of dropping, the temperature in the reactor is maintained at from 30° C. to 120° C., desirably from 50° C. to 110° C. to allow the reaction to proceed. Thereafter, the above-mentioned reaction product is input into a reactor in which a polyolefin polyol, and as needed, a polyol component other than the polyester polyol are placed while the mixture is stirred so that the temperature in the reactor can be maintained at from 30° C. to 120° C., preferably from 50° C. to 100° C. After the reaction product is input, the temperature in the reactor is maintained at from 30° C. to 120° C., desirably from 50° C. to 100° C. to complete the reaction.

When the component (1) which is an essential component of the invention (I) is used, in cases where increase in the viscosity of an oligomer is suppressed or the volume shrinkage rate during polymerization needs to be reduced, the oligomer is desired to be an oligomer in which only a part of the end of the compound is sealed with a compound having, in the molecule, one hydroxyl group including an alcoholic hydroxyl group-containing (meth)acrylate.

The charging mole ratio of the raw materials (i.e., (the total number of hydroxyl groups when the number of polyolefin polyols to be used and the number of polyols other than polyolefin polyols to be used are combined)/(the total number of isocyanato groups of the organic polyisocyanate compound to be used)/(the total number of hydroxyl groups when the number of compounds having, in the molecule, one hydroxyl group including an alcoholic hydroxyl group-containing (meth)acrylate to be used is combined)) is adjusted depending on the molecular weight of an objective polyurethane.

It is noted that, when the end of the compound is almost completely sealed with a compound having, in the molecule, one hydroxyl group including an alcoholic hydroxyl group-containing (meth)acrylate, the total number of isocyanato groups of the organic polyisocyanate compound to be used needs to be larger than the total number of hydroxyl groups when the number of polyolefin polyols to be used and the number of polyols other than the polyolefin polyols to be used are combined.

In this case, when the ratio of the total number of hydroxyl groups when the number of polyolefin polyols to be used and the number of polyols other than the polyolefin polyols to be used are combined to the total number of isocyanato groups of the organic polyisocyanate compound to be used is closer to 1.0, the molecular weight becomes larger, and when the ratio becomes far from and smaller than 1.0, the molecular weight becomes smaller.

Although the charging mole ratio of the raw materials is not particularly limited, the ratio of the number of isocyanato groups in the organic polyisocyanate compound to the total number of hydroxyl groups when the number of polyolefin polyol to be used and the number of polyols other than the polyolefin polyol to be used are combined is preferably 1.5:1 or larger.

When the ratio is smaller than 1.5:1, the viscosity may become too high, which is not preferred.

When only a part of the end of the compound is sealed with a compound having, in the molecule, one hydroxyl group including an alcoholic hydroxyl group-containing (meth)acrylate, the total number of hydroxyl groups when the number of polyolefin polyol, the number of polyols other than the polyolefin polyol to be used, and the number of compounds having, in the molecule, one hydroxyl group including an alcoholic hydroxyl group-containing (meth)acrylate to be used needs to be larger than the total number of isocyanato groups in the organic polyisocyanate compound to be used.

It is noted that, in this case, the ratio of the total number of hydroxyl groups when the number of polyolefin polyol, the number of polyols other than the polyolefin polyol to be used, and the number of compounds having, in the molecule, one hydroxyl group including an alcoholic hydroxyl group-containing (meth)acrylate to be used to the total number of isocyanato groups in the organic polyisocyanate compound to be used is preferably 2:1 or lower.

When the ratio is higher than 2:1, the number of molecules without an acryloyl group is increased, and the shape retaining properties of the polymerization product after polymerization may deteriorate, which is not preferred.

When a urethane (meth)acrylate is synthesized by using a polyolefin polyol as a raw material component in this method, a urethane (meth)acrylate which does not have a polyolefin structural unit may be manufactured. Herein, the urethane (meth)acrylate which does not have a polyolefin polyol structural unit is defined to be excluded in the component (1) which is an essential component of the invention (I). For example, when a (meth)acryloyl group-containing compound having a polyolefin structural unit which is the component (1) is manufactured by using a polyolefin polyol, 1,3-bis(isocyanatomethyl)cyclohexane, and 2-hydroxyethyl acrylate, the compound of the following Formula (1) which is a urethane (meth)acrylate which does not have a polyolefin polyol structural unit is also manufactured.

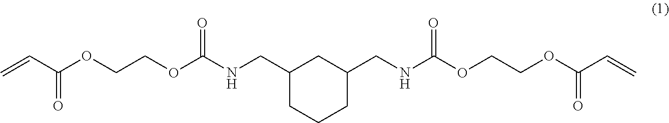

However, herein, the compound of Formula (1) does not have a polyolefin structural unit, which means that the compound is not included in the component (1).

Next, a case of obtaining a (meth)acryloyl group-containing compound having a polyolefin structural unit by using a polyolefin polyol and a (meth)acryloyl group-containing compound having, in one molecule, one isocyanato group as essential raw material components will be described.

The polyolefin polyol is as mentioned above.

Examples of the (meth)acryloyl group-containing compound having an isocyanato group which may be the above-mentioned raw material include 2-isocyanatoethyl acrylate and 2-isocyanatoethyl methacrylate.

Examples of the 2-isocyanatoethyl acrylate include KarenzAOI® manufactured by Showa Denko K.K.

Examples of the 2-isocyanatoethyl methacrylate include KarenzMOI® manufactured by Showa Denko K.K.

A urethane (meth)acrylate obtained by reacting a (meth)acryloyl group-containing compound having a polyolefin structural unit containing, in one molecule, a urethane bond and having, on an end of the molecule, a (meth)acryloyl group is generally synthesized by the following method.

It is noted that all of hydroxyl groups in the polyolefin polyol may be reacted with a (meth)acryloyl group-containing compound having an isocyanato group, only a part of the hydroxyl groups of the polyolefin polyol may be reacted with (meth)acryloyl group-containing compound having an isocyanato group and a part of the hydroxyl groups is remained unreacted.

When all of the hydroxyl groups on the polyolefin polyol are reacted with a (meth)acryloyl group-containing compound having an isocyanato group, the ratio of the total number of the hydroxyl groups of the polyolefin polyol and the number of isocyanato groups isocyanato group-containing (meth)acrylate to be used needs to be one or higher.

When only a part of hydroxyl groups in the polyolefin polyol is reacted with a (meth)acryloyl group-containing compound having an isocyanato group and a part of the hydroxyl groups is remained unreacted, blending needs to be performed such that the total number of hydroxyl groups of the polyolefin polyol is smaller than the total number of isocyanato groups in the isocyanato group-containing (meth)acrylate to be used.

It is noted that, at this time, a polyolefin polyol which is not reacted with the (meth)acryloyl group-containing compound having an isocyanato group and left as it is may exist, which is not considered to be included in Component (1). When the polyolefin polyol is liquid polybutadiene polyol or liquid polyisoprene polyol, the polyolefin polyol is included in Component (5).

Although the manufacturing method is not particularly restricted, in general, a polyolefin polyol, polymerization inhibitor, and as needed, a urethanization catalyst or an antioxidant is added, and input into a reactor, and stirring is started, and then the temperature in the reactor is elevated up to from 40° C. to 120° C., preferably from 50° C. to 100° C. Thereafter, a (meth)acryloyl group-containing compound having an isocyanato group is input by dropping. During dropping, the temperature in the reactor is controlled at from 40° C. to 130° C., preferably from 50° C. to 110° C. After the completion of dropping, the temperature in the reactor is maintained at from 40° C. to 120° C., preferably from 50° C. to 100° C. while continuing stirring, to complete the reaction.

When a urethane bond is not contained in a (meth)acryloyl group-containing compound having a polyolefin structural unit, an object compound is obtained by transesterification of a polyolefin polyol and a (meth)acrylic acid ester and/or dehydration condensation reaction of polyolefin polyol and (meth)acrylic acid. The number of (meth)acryloyl groups in the (meth)acrylate compound may be one or more in one molecule, and more preferably two to four.

As representative synthesis examples of a (meth)acryloyl group-containing compound having a polyolefin structural unit which does not contain a urethane bond, the structural formula of a (meth)acrylate compound generated by transesterification of a polybutadiene diol and an acrylic acid ester or dehydration condensation reaction of a polybutadiene diol and an acrylic acid ester, and the structural formula of a (meth)acrylate compound generated by transesterification of a polyisoprene diol and an acrylic acid ester or dehydration condensation reaction of a polyisoprene diol and an acrylic acid are represented by formula (2) and formula (3), respectively.

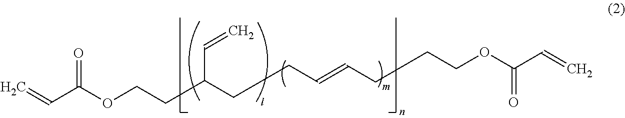

(In formula (2), l, m, and n are an integer of one or more.)

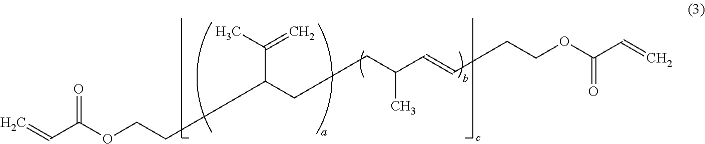

(In formula (3), a, b, and c are an integer of one or more.)

When a (meth)acrylate compound of Component (1) is manufactured by transesterification of a polyolefin polyol and a (meth)acrylic acid ester, generally, the transesterification of a polyolefin polyol and a (meth)acrylic acid ester is performed by heating in the presence of a transesterification catalyst, and the (meth)acrylate of Component (1) is manufactured by evaporating a generated corresponding lower alkyl alcohol. For example, the (meth)acrylate can be manufactured by the method according to Japanese Laid-open Patent Publication No. 2011-195823 or Japanese Laid-open Patent Publication No. 2006-45284.

When a (meth)acrylate compound of Component (1) is manufactured by dehydration condensation reaction of a polyolefin polyol and a (meth)acrylic acid, the (meth)acrylate compound is manufactured by subjecting a polyolefin polyol and a (meth)acrylic acid to a dehydration reaction by heating in the presence of an esterification catalyst. However, when the reaction is performed by heating at a high temperature of 150° C. or higher, there is a risk of radical polymerization of an acryloyl group during the dehydration condensation reaction. Therefore, in general, esterification is performed in the presence of a solvent which forms an azeotropic mixture with water such as cyclohexane or toluene to form an azeotropic mixture with water, and generated water is removed from a reactor by a dehydration condensation reaction. Examples of the catalyst to be used for esterification include an acid catalyst such as a p-toluene sulfonic acid.

As mentioned above, as a method of manufacturing Component (1), a (meth)acryloyl group-containing compound having a polyolefin structural unit which does not contain a urethane bond, there are two types of methods: a method of transesterification of a polyolefin polyol and a (meth)acrylic acid ester; and a method of dehydration condensation reaction of a polyolefin polyol and a (meth)acrylic acid. From the viewpoint of not requiring a solvent, from the viewpoint of not performing a purification process, or from the viewpoint of simplification of a purification process if a purification process is performed, a method of manufacturing Component (1), a (meth)acryloyl group-containing compound having a polyolefin structural unit which does not contain a urethane bond, by transesterification of a polyolefin polyol and a (meth)acrylic acid ester is industrially preferred.

Next, a (meth)acryloyl group-containing compound having a hydrogenated polyolefin structural unit will be described.

The (meth)acryloyl group-containing compound having a hydrogenated polyolefin structural unit is not particularly restricted as long as it is a compound having a hydrogenated polyolefin structural unit and a (meth)acryloyl group. The hydrogenated polyolefin structural unit is preferably a compound having a hydrogenated polydiene structural unit, and examples thereof include a structural unit obtained by hydrogenating a polydiene structural unit obtained by polymerizing at least one diene selected from the group consisting of 1,3-butadiene, 1,3-pentadiene, isoprene, 2,3-dimethyl-1,3-butadiene, 2-phenyl-1,3-butadiene, 2-propyl-1,3-butadiene, 1,3-heptadiene, 6-methyl-1,3-heptadiene, 1,3-hexadiene, 5-methyl-1,3-hexadiene, 2,4-hexadiene, 2,5-dimethyl-2,4-hexadiene, and 1,3-octadiene.

Among these, preferred is a structural unit obtained by hydrogenating a polybutadiene structural unit, a structural unit obtained by hydrogenating a polyisoprene structural unit, or a structural unit obtained by hydrogenating a poly(butadiene-isoprene) structural unit.

Examples of commercially available (meth)acryloyl group-containing compound having a hydrogenated polyolefin structural unit include NISSO-PB TEAI-1000 (manufactured by Nippon Soda Co., Ltd.) which is an acryloyl group-containing compound having a hydrogenated polybutadiene structural unit.

NISSO-PB TEAI-1000 is a reaction product of a hydrogenated polybutadiene polyol such as NISSO-PB GI-1000 (manufactured by Nippon Soda Co., Ltd.), an organic polyisocyanate compound, and an alcoholic hydroxyl group-containing acrylate. As seen above, a hydrogenated polyolefin polyol is useful as a raw material for manufacturing a (meth)acryloyl group-containing compound having a hydrogenated polyolefin structural unit, and examples of commercially available polyolefin polyol include, other than NISSO PB GI-1000 which is a commercially available product of the above-mentioned hydrogenated polybutadiene polyol, NISSO PB GI-2000, GI-3000 (manufactured by Nippon Soda Co., Ltd.), Epol (manufactured by Idemitsu Kosan Co., Ltd.) which is a hydroxyl group end liquid hydrogenated polyisoprene.

A method of manufacturing a (meth)acryloyl group-containing compound having a hydrogenated polyolefin structural unit is not particularly restricted, and the compound can be manufactured, for example, by the following method.

Firstly, a case of obtaining a (meth)acryloyl group-containing compound having a hydrogenated polyolefin structural unit by using a hydrogenated polyolefin polyol, an organic polyisocyanate compound, and an alcoholic hydroxyl group-containing (meth)acrylate as the essential raw material components will be described.

A hydrogenated polyolefin polyol represented by a hydrogenated polybutadiene polyol or a hydrogenated polyisoprene polyol has two or more hydroxyl groups in one molecule, and preferably has two to four hydroxyl groups. The hydroxyl group value of the hydrogenated polyolefin polyol is preferably 10 to 80 mgKOH/g, further preferably 17 to 70 mgKOH/g, and particularly preferably 23 to 65 mgKOH/g. When the hydroxyl group value of a hydrogenated polyolefin polyol compound is smaller than 10 mgKOH/g, the molecular weight and viscosity of a (meth)acrylic group-containing hydrogenated polyolefin compound to be obtained become too high, and handling properties thereof deteriorate, which tends to make it difficult to handle the compound. When the hydroxyl group value of the hydrogenated polyolefin polyol compound is larger than 80 mgKOH/g, the volume shrinkage rate thereof during polymerization becomes too large, and the cohesion of polymerization product becomes too high, and the adhesive performance of polymerization product is not sufficiently exerted in some cases, which is not preferred.

A hydrogenated polybutadiene polyol is a hydrogenated homopolymer of butadiene containing a hydroxyl group. A hydrogenated polyisoprene polyol is a hydrogenated homopolymer of isoprene containing a hydroxyl group.

The organic polyisocyanate compound is not particularly restricted as long as it is an organic compound having, in one molecule, two or more isocyanato groups. Specific examples thereof include 1,4-cyclohexane diisocyanate, isophorone diisocyanate, methylene bis(4-cyclohexyl isocyanate), 1,3-bis(isocyanatomethyl)cyclohexane, 1,4-bis(isocyanatomethyl)cyclohexane, 2,4-tolylenediisocyanate, 2,6-tolylenediisocyanate, diphenylmethane-4,4′-diisocyanate, 1,3-xylylene diisocyanate, 1,4-xylylene diisocyanate, lysine triisocyanate, lysine diisocyanate, hexamethylene diisocyanate, 2,4,4-trimethyl hexamethylene diisocyanate, 2,2,4-trimethylhexanemethylene diisocyanate and norbornane diisocyanate. These may be used singly or in combination of two or more thereof.

The component (1) which is an essential component of the polymerizable composition of the invention (I) desirably has a low viscosity in view of the degree of freedom for the subsequent blending. Specific examples of an organic polyisocyanate compound which meets this purpose preferably include 1,3-bis(isocyanatomethyl)cyclohexane, 1,4-bis(isocyanatomethyl)cyclohexane, 2,4,4-trimethyl hexamethylene diisocyanate, 2,2,4-trimethylhexanemethylene diisocyanate, 1,6-hexamethylene diisocyanate and norbornane diisocyanate, and further preferably include 1,3-bis(isocyanatomethyl)cyclohexane, 2,4,4-trimethyl hexamethylene diisocyanate and 2,2,4-trimethylhexanemethylene diisocyanate, and most preferably include 2,4,4-trimethyl hexamethylene diisocyanate and 2,2,4-trimethylhexanemethylene diisocyanate.

The alcoholic group-containing (meth)acrylate is not particularly restricted as long as it is a (meth)acrylate having, in one molecule, an alcoholic hydroxyl group. Specific examples thereof include 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, 2-hydroxy-3-(o-phenyl phenoxy)propyl acrylate, 2-hydroxyethyl acrylamide, 2-hydroxyethyl methacrylate, 2-hydroxypropyl methacrylate, 3-hydroxypropyl methacrylate, 2-hydroxybutyl methacrylate, 4-hydroxybutyl methacrylate, 2-hydroxy-3-phenoxypropyl methacrylate, and 2-hydroxy-3-(o-phenyl phenoxy)propyl methacrylate.

Among these, in view of the polymerization rate of the component (1) which is an essential component of the invention (I), preferred are 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, and 2-hydroxy-3-(o-phenyl phenoxy)propyl acrylate. In view of the reactivity with an isocyanate group, preferred are 2-hydroxyethyl acrylate, 3-hydroxypropyl acrylate, and 4-hydroxybutyl acrylate, and most preferred is 4-hydroxybutyl acrylate.

As a method of reacting a hydrogenated polyolefin polyol, an organic polyisocyanate compound, and an alcoholic hydroxyl group-containing (meth)acrylate, a method in which a hydrogenated polyolefin polyol, an organic polyisocyanate compound and an alcoholic hydroxyl group-containing (meth)acrylate in the presence or absence of a known urethanization catalyst such as dibutyl tin dilaurylate, or dioctyltin dilaurate can be employed to synthesize. In view of shortening the reaction time, the reaction is performed in the presence of a catalyst. It is noted that, since a too large amount of the catalyst may finally adversely affect the physical properties of a cured film during its use, the amount of the catalyst to be used is preferably from 0.001 to 1 parts by mass with respect to 100 parts by mass of the total amount of the hydrogenated polyolefin polyol, the organic polyisocyanate compound, and the alcoholic hydroxyl group-containing (meth)acrylate.

Although the order of blending the raw materials is not particularly restricted, when the end of a compound is almost completely sealed with a compound having, in one molecule, a hydroxyl group including an alcoholic hydroxyl group-containing (meth)acrylate, usually, an organic polyisocyanate compound and, as needed, a urethanization catalyst are input into a reactor and the mixture is stirred, and then a hydrogenated polyolefin polyol, and as needed, a polyol component other than the hydrogenated polyolefin polyol are input successively at a temperature in the reactor of from 40° C. to 140° C., and preferably from 50° C. to 120° C., and thereafter, the resultant mixture is allowed to react at a temperature in the reactor of from 50° C. to 160° C., preferably from 60° C. to 140° C. Then, a polymerization inhibitor and, as needed, a urethanization catalyst are added thereto at a temperature in the reactor of from 30° C. to 120° C., preferably from 50° C. to 100° C., and the alcoholic hydroxyl group-containing (meth)acrylate is input by dropping. During dropping, the temperature in the reactor is preferably maintained at from 30° C. to 120° C., and desirably from 50° C. to 100° C. After the completion of dropping, the temperature in the reactor is maintained at from 30° C. to 120° C., desirably from 50° C. to 100° C. to complete the reaction.

When only a part of the end of the compound is sealed with a compound having, in the molecule, one hydroxyl group including an alcoholic hydroxyl group-containing (meth)acrylate, usually, an organic polyisocyanate compound, and, as needed, a polymerization inhibitor and/or a urethanization catalyst are input into a reactor, and the mixture is stirred, and thereafter, an alcoholic hydroxyl group-containing (meth)acrylate is input by dropping at a temperature in the reactor of from 30° C. to 120° C., preferably from 50° C. to 110° C. During dropping, the temperature in the reactor is preferably maintained at from 30° C. to 120° C., desirably from 50° C. to 110° C. After the completion of dropping, the temperature in the reactor is maintained at from 30° C. to 120° C., desirably from 50° C. to 110° C. to allow the reaction to proceed. Thereafter, the above-mentioned reaction product is input into a reactor in which a hydrogenated polyolefin polyol, and as needed, a polyol component other than the hydrogenated polyolefin polyol are placed while the mixture is stirred so that the temperature in the reactor can be maintained at from 30° C. to 120° C., preferably from 50° C. to 100° C. After the reaction product is input, the temperature in the reactor is maintained at from 30° C. to 120° C., desirably from 50° C. to 100° C. to complete the reaction.

When the component (1) which is an essential component of the invention (I) is used, in cases where increase in the viscosity of an oligomer is suppressed or the volume shrinkage rate during polymerization needs to be reduced, the oligomer is desired to be an oligomer in which only a part of the end of the compound is sealed with a compound having, in the molecule, one hydroxyl group including an alcoholic hydroxyl group-containing (meth)acrylate.

The charging mole ratio of the raw materials (i.e., (the total number of hydroxyl groups when the number of hydrogenated polyolefin polyols to be used and the number of polyols other than hydrogenated polyolefin polyols to be used are combined)/(the total number of isocyanato groups of the organic polyisocyanate compound to be used)/(the total number of hydroxyl groups when the number of compounds having, in the molecule, one hydroxyl group including an alcoholic hydroxyl group-containing (meth)acrylate to be used is combined)) is adjusted depending on the molecular weight of an objective polyurethane.

It is noted that, when the end of the compound is almost completely sealed with a compound having, in the molecule, one hydroxyl group including an alcoholic hydroxyl group-containing (meth)acrylate, the total number of isocyanato groups of the organic polyisocyanate compound to be used needs to be larger than the total number of hydroxyl groups when the number of hydrogenated polyolefin polyols to be used and the number of polyols other than the hydrogenated polyolefin polyols to be used are combined.

In this case, when the ratio of the total number of hydroxyl groups when the number of hydrogenated polyolefin polyols to be used and the number of polyols other than the hydrogenated polyolefin polyols to be used are combined to the total number of isocyanato groups of the organic polyisocyanate compound to be used is closer to 1.0, the molecular weight becomes larger, and when the ratio becomes far from and smaller than 1.0, the molecular weight becomes smaller.

Although the charging mole ratio of the raw materials is not particularly limited, the ratio of the number of isocyanato groups in the organic polyisocyanate compound to the total number of hydroxyl groups when the number of hydrogenated polyolefin polyol to be used and the number of polyols other than the hydrogenated polyolefin polyol to be used are combined is preferably 1.5:1 or larger.

When the ratio is smaller than 1.5:1, the viscosity may become too high, which is not preferred.

When only a part of the end of the compound is sealed with a compound having, in the molecule, one hydroxyl group including an alcoholic hydroxyl group-containing (meth)acrylate, the total number of hydroxyl groups when the number of hydrogenated polyolefin polyol, the number of polyols other than the hydrogenated polyolefin polyol to be used, and the number of compounds having, in the molecule, one hydroxyl group including an alcoholic hydroxyl group-containing (meth)acrylate to be used needs to be larger than the total number of isocyanato groups in the organic polyisocyanate compound to be used.

It is noted that, in this case, the ratio of the total number of hydroxyl groups when the number of hydrogenated polyolefin polyol, the number of polyols other than the hydrogenated polyolefin polyol to be used, and the number of compounds having, in the molecule, one hydroxyl group including an alcoholic hydroxyl group-containing (meth)acrylate to be used to the total number of isocyanato groups in the organic polyisocyanate compound to be used is preferably 2:1 or lower.

When the ratio is higher than 2:1, the number of molecules without an acryloyl group is increased, and the shape retaining properties of the polymerization product after polymerization may deteriorate, which is not preferred.

When a urethane (meth)acrylate is synthesized by using a hydrogenated polyolefin polyol as a raw material component in this method, a urethane (meth)acrylate which does not have a polyolefin structural unit may be manufactured in a similar manner to the method which is described when a urethane (meth)acrylate which is synthesized by using a polyolefin polyol as a raw material component is synthesized. Herein, the urethane (meth)acrylate which does not have a hydrogenated polyolefin structural unit is defined to be excluded in the component (1) which is an essential component of the invention (I). For example, when a (meth)acryloyl group-containing compound having a hydrogenated polyolefin structural unit which is the component (1) is manufactured by using a hydrogenated polyolefin polyol, 1,3-bis(isocyanatomethyl)cyclohexane, and 2-hydroxyethyl acrylate, the compound of the above-mentioned Formula (1) which is a urethane (meth)acrylate which does not have a hydrogenated polyolefin polyol structural unit is also manufactured. However, herein, the compound of Formula (1) does not have a hydrogenated polyolefin structural unit, which means that the compound is not included in the component (1).

Next, a case of obtaining a (meth)acryloyl group-containing compound having a hydrogenated polyolefin structural unit by using a hydrogenated polyolefin polyol and a (meth)acryloyl group-containing compound having, in one molecule, one isocyanato group as essential raw material components will be described.

The hydrogenated polyolefin polyol is as mentioned above.

Examples of the (meth)acryloyl group-containing compound having an isocyanato group which may be the above-mentioned raw material include the above-mentioned 2-isocyanatoethyl acrylate and 2-isocyanatoethyl methacrylate.

A urethane (meth)acrylate obtained by reacting a (meth)acryloyl group-containing compound having a hydrogenated polyolefin structural unit containing, in one molecule, a urethane bond and having, on an end of the molecule, a (meth)acryloyl group is generally synthesized by the following method.

It is noted that all of hydroxyl groups in the hydrogenated polyolefin polyol may be reacted with a (meth)acryloyl group-containing compound having an isocyanato group, only a part of the hydroxyl groups of the hydrogenated polyolefin polyol may be reacted with (meth)acryloyl group-containing compound having an isocyanato group and a part of the hydroxyl groups is remained unreacted.

When all of the hydroxyl groups on the hydrogenated polyolefin polyol are reacted with a (meth)acryloyl group-containing compound having an isocyanato group, the ratio of the total number of the hydroxyl groups of the hydrogenated polyolefin polyol and the number of isocyanato groups isocyanato group-containing (meth)acrylate to be used needs to be one or higher.

When only a part of hydroxyl groups in the hydrogenated polyolefin polyol is reacted with a (meth)acryloyl group-containing compound having an isocyanato group and a part of the hydroxyl groups is remained unreacted, blending needs to be performed such that the total number of hydroxyl groups of the hydrogenated polyolefin polyol is smaller than the total number of isocyanato groups in the isocyanato group-containing (meth)acrylate to be used.

It is noted that, at this time, a hydrogenated polyolefin polyol which is not reacted with the (meth)acryloyl group-containing compound having an isocyanato group and left as it is may exist, which is not considered to be included in Component (1). When the hydrogenated polyolefin polyol is liquid polybutadiene polyol or liquid hydrogenated polyisoprene polyol, the hydrogenated polyolefin polyol is included in a liquid polybutadiene polyol or a liquid polyisoprene polyol which is the following Component (2).

Although the manufacturing method is not particularly restricted, in general, a hydrogenated polyolefin polyol, polymerization inhibitor, and as needed, a urethanization catalyst or an antioxidant is added, and input into a reactor, and stirring is started, and then the temperature in the reactor is elevated up to from 40° C. to 120° C., preferably from 50° C. to 100° C. Thereafter, a (meth)acryloyl group-containing compound having an isocyanato group is input by dropping. During dropping, the temperature in the reactor is controlled at from 40° C. to 130° C., preferably from 50° C. to 110° C. After the completion of dropping, the temperature in the reactor is maintained at from 40° C. to 120° C., preferably from 50° C. to 100° C. while continuing stirring, to complete the reaction.

When a urethane bond is not contained in a (meth)acryloyl group-containing compound having a hydrogenated polyolefin structural unit, an object compound is obtained by transesterification of a hydrogenated polyolefin polyol and a (meth)acrylic acid ester and/or dehydration condensation reaction of hydrogenated polyolefin polyol and (meth)acrylic acid. The number of (meth)acryloyl groups in the (meth)acrylate compound may be one or more in one molecule, and more preferably two to four.

As representative synthesis examples of a (meth)acryloyl group-containing compound having a hydrogenated polyolefin structural unit which does not contain a urethane bond, the structural formula of a (meth)acrylate compound generated by transesterification of a hydrogenated polybutadiene diol and an acrylic acid ester or dehydration condensation reaction of a hydrogenated polybutadiene diol and an acrylic acid ester, and the structural formula of a (meth)acrylate compound generated by transesterification of a hydrogenated polyisoprene diol and an acrylic acid ester or dehydration condensation reaction of a hydrogenated polyisoprene diol and an acrylic acid are represented by formula (4) and formula (5), respectively.

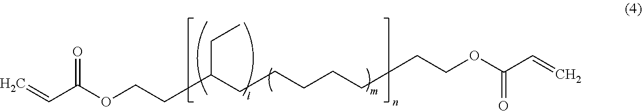

(In formula (4), l, m, and n are an integer of one or more.)

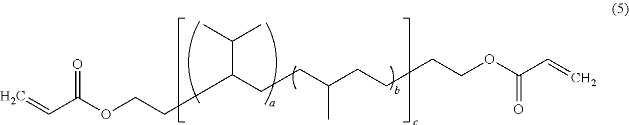

(In formula (5), a, b, and c are an integer of one or more.)

When a (meth)acryloyl group-containing compound of Component (1) is manufactured by transesterification of a hydrogenated polyolefin polyol and a (meth)acrylic acid ester, generally, the transesterification of a hydrogenated polyolefin polyol and a (meth)acrylic acid ester is performed by heating in the presence of a transesterification catalyst, and the (meth)acryloyl group-containing compound of Component (1) is manufactured by evaporating a generated corresponding lower alkyl alcohol. For example, the (meth)acrylate can be manufactured by the method according to Japanese Laid-open Patent Publication No. 2011-195823 or Japanese Laid-open Patent Publication No. 2006-45284.

When a (meth)acryloyl group-containing compound of Component 1 is manufactured by dehydration condensation reaction of a hydrogenated polyolefin polyol and a (meth)acrylic acid, the (meth)acrylate compound is manufactured by subjecting a hydrogenated polyolefin polyol and a (meth)acrylic acid to a dehydration reaction by heating in the presence of an esterification catalyst. However, when the reaction is performed by heating at a high temperature of 150° C. or higher, there is a risk of radical polymerization of an acryloyl group during the dehydration condensation reaction. Therefore, in general, esterification is performed in the presence of a solvent which forms an azeotropic mixture with water such as cyclohexane or toluene to form an azeotropic mixture with water, and generated water is removed from a reactor by a dehydration condensation reaction. Examples of the catalyst to be used for esterification include an acid catalyst such as a p-toluene sulfonic acid.

As mentioned above, as a method of manufacturing a (meth)acryloyl group-containing compound having a hydrogenated polyolefin structural unit which does not contain a urethane bond, there are two types of methods: a method of transesterification of a hydrogenated polyolefin polyol and a (meth)acrylic acid ester; and a method of dehydration condensation reaction of a hydrogenated polyolefin polyol and a (meth)acrylic acid. From the viewpoint of not requiring a solvent, from the viewpoint of not performing a purification process, or from the viewpoint of simplification of a purification process if a purification process is performed, a method of manufacturing the compound by transesterification of a hydrogenated polyolefin polyol and a (meth)acrylic acid ester is industrially preferred.

Next, a (meth)acryloyl group-containing compound having a (poly)ester structural unit will be described.

The (meth)acryloyl group-containing compound having a (poly)ester structural unit is not particularly restricted as long as it is a compound having a structural unit derived from a (poly)ester polyol and a (meth)acryloyl group.

The (poly)ester polyol which can be a raw material of a (meth)acryloyl group-containing compound having a (poly)ester structural unit is not particularly restricted as long as it is a compound having, in one molecule, one or more —COO— bonds (carboxylic acid ester bonds) and two or more alcoholic hydroxyl groups.

Examples of the (poly)ester polyol which may be a raw material of the (meth)acryloyl group-containing compound having a (poly)ester structural unit include a (poly)ester polyol having a structural unit derived from a polycarboxylic acid having a chain-shaped hydrocarbon chain and a structural unit derived from a polyol having a chain-shaped hydrocarbon chain, a (poly)ester polyol having a structural unit derived from a polycarboxylic acid having an alicyclic structure-containing hydrocarbon chain and a structural unit derived from a polyol having a chain-shaped hydrocarbon chain, a (poly)ester polyol having a structural unit derived from a polycarboxylic acid having a chain-shaped hydrocarbon chain and a structural unit derived from a polyol having an alicyclic structure-containing hydrocarbon chain, a (poly)ester polyol having a structural unit derived from a polycarboxylic acid having an alicyclic structure-containing hydrocarbon chain and a structural unit derived from a polyol having an alicyclic structure-containing hydrocarbon chain, a (poly)ester polyol having a structural unit derived from a polycarboxylic acid having an aromatic ring structure-containing hydrocarbon chain and a structural unit derived from a polyol having a chain-shaped hydrocarbon chain, a (poly)ester polyol having a structural unit derived from a polycarboxylic acid having an aromatic ring structure-containing hydrocarbon chain and a structural unit derived from a polyol having an alicyclic structure-containing hydrocarbon chain, a (poly)ester polyol having a structural unit derived from a polycarboxylic acid having a chain-shaped hydrocarbon chain and a structural unit derived from a polyol having an aromatic ring structure-containing hydrocarbon chain, and a (poly)ester polyol having a structural unit derived from a polycarboxylic acid having an alicyclic structure-containing hydrocarbon chain and a structural unit derived from a polyol having an aromatic ring structure-containing hydrocarbon chain.

Among these polyol, preferred are polyols whose number of carbon atoms is eight or more.

Examples of the polyols whose number of carbon atoms is eight or more include 1,4-cyclohexanedimethanol, 1,2-cyclohexanedimethanol, 1,3-cyclohexanedimethanol, 2-methyl-1,1-cyclohexanedimethanol, tricyclo[5.2.1.0^{2,6}]decanedimethanol, 1,9-nonanediol, 2-methyl-1,8-octane diol, 1,10-decadiol, 1,12-dodecanediol, dimer diol, and hydrogenated dimer diol.

Among these polyols whose number of carbon atoms is eight or more, particularly preferred is hydrogenated dimer diol.

Among the polycarboxylic acid, preferred is a polycarboxylic acid whose number of carbon atoms except for the carbon in the carboxylic acid structure (—COOH) is seven or more.

Examples of such a polycarboxylic acid include 1,9-nonanedioic acid, sebacic acid, 1,12-dodecanedioic acid, dimer acid, and hydrogenated dimer acid.

Among the polycarboxylic acids whose number of carbon atoms except for the carbon in the carboxylic acid structure (—COOH) is seven or more, particularly preferred are sebacic acid, 1,12-dodecanedioic acid, and hydrogenated dimer acid.

A preferred combination of a raw material polyol constituting a (poly)ester polyol and a polycarboxylic acid is a combination of a polyol whose number of carbon atoms is eight or more and a polycarboxylic acid whose number of carbon atoms except for the carbon in the carboxylic acid structure (—COOH) is seven or more, and particularly preferably, a combination of hydrogenated dimer diol and at least one selected from sebacic acid, 1,12-dodecanedioic acid, and hydrogenated dimer acid.

In general, the term “dimer acid” refers to a dimer acid obtained by the reaction of a fatty acid whose number of carbon atoms is 14 to 22 having 2 to 4 ethylenic double bonds (hereinafter, referred to as an unsaturated fatty acid A), preferably a fatty acid whose number of carbon atoms 14 to 22 having two ethylenic double bonds, and a fatty acid whose number of carbon atoms is 14 to 22 having 1 to 4 ethylenic double bonds (hereinafter, referred to as an unsaturated fatty acid B), preferably a fatty acid whose number of carbon atoms is 14 to 22 having 1 or 2 ethylenic double bonds at a double bond portion. In the above, examples of the unsaturated fatty acid A include tetradecadienoic acid, hexadecadienoic acid, octadecadienoic acid (linoleic acid, or the like), eicosadienoic acid, docosadienoic acid, octadecatrienoic acid (linolenic acid, or the like), and eicosatetraenoic acid (arachidonic acid, or the like). Most preferred is linoleic acid. Examples of the unsaturated fatty acid B include, other than those illustrated above, as a fatty acid whose number of carbon atoms is 14 to 22 having one ethylenic double bond, tetradecenoic acid (tsuzuic acid, sperm acid, myristoleic acid), hexadecenoic acid (palmitoleic acid, or the like), octadecenoic acid (oleic acid, elaidic acid, vaccenic acid, or the like), eicosenoic acid (gadoleic acid, or the like), docosenoic acid (erucic acid, cetoleic acid, brassidic acid, or the like). Most preferred is oleic acid or linoleic acid.

In the above-mentioned dimerization reaction, the use rates of the unsaturated fatty acid A and the unsaturated fatty acid B (mole fraction) is preferably about from 1:1.2 to 1.2:1, and most preferably 1:1. The above-mentioned dimerization reaction can be conducted according to a known method, for example, the method described in Japanese Laid-open Patent Publication No. H9-136861. In other words, the reaction can be realized, for example, by adding a Lewis acid or Broensted acid type liquid or solid catalyst, preferably a montmorillonite active white clay to the unsaturated fatty acid A and the unsaturated fatty acid B in an amount of from 1 to 20% by weight, preferably from 2 to 8% by weight with respect to A+B and heating the mixture at from 200 to 270° C., preferably from 220 to 250° C. The pressure during the reaction is usually in a state in which a small pressure is applied, and may be a normal pressure. The reaction time varied depending on the amount of catalyst and the reaction temperature, and is usually from 5 to 7 hours. After the reaction, the catalyst is filtered out, and then unreacted raw materials or isomerized fatty acids are evaporated by conducting distillation under reduced pressure, and thereafter, a dimer acid fraction is obtained by distillation. The above-mentioned dimerization reaction is thought to proceed through migration of a double bond (isomerized) and Diels-Alder reaction, without wishing to bound by the theory.

Dimer acids to be obtained is usually a mixture of dimer acids having different structures due to the binding site of a double bond or isomerization. Although the dimer acids having different structures may be separated to be used, the dimer acids can be used as they are. Further, the dimer acid to be obtained may contain a small amount of monomer acid (for example, 3% by weight or smaller, in particular, 1% by weight or smaller), a polymer acid of a trimer or higher acid (for example, 3% by weight or smaller, in particular, 1% by weight or smaller) or the like.

The term “hydrogenated dimer acid” herein refers to a saturated dicarboxylic acid obtained by hydrogenating a carbon-carbon double bond of the above-mentioned dimer acid.

For the above-mentioned dimer acid, when a dimer acid whose number of carbon atoms is 36 manufactured and linoleic acid and linoleic acid or oleic acid is used as a raw material, the structure of the principal component of a hydrogenated dimer acid is the structure represented by the following formula (6) or (7).

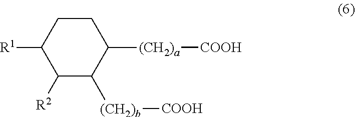

(wherein R¹ and R² are each independently an alkyl group, and the sum of the numbers of carbon atoms contained in R¹ and R², a and b is 28 (i.e., the number of carbon atoms contained in R¹+the number of carbon atoms contained in R²+a+b=28).)

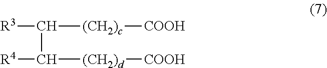

(wherein R³ and R⁴ are each independently an alkyl group, and the sum of the numbers of carbon atoms contained in R³ and R⁴, c and d is 32 (i.e., the number of carbon atoms contained in R³+the number of carbon atoms contained in R⁴+c+d=32).)

Examples of commercially available hydrogenated dimer acids include PRIPOL® 1009 (manufactured by Croda Japan KK), EMPOL® 1008 and EMPOL® 1062 (manufactured by BASF).

The term “hydrogenated dimer diol” herein refers to a diol which includes, as a principal component, the one obtained by reducing at least one of the above-mentioned dimer acid, the above-mentioned hydrogenated dimer acid, and a lower alcohol ester thereof in the presence of a catalyst to make a carboxylic acid or carboxylate portion of the dimer acid into an alcohol, and when a raw material has a carbon-carbon double bond, the double bond is hydrogenated.

For example, when a hydrogenated dimer diol is manufactured by reducing a hydrogenated dimer acid in which the principal component is a compound having a structure represented by the Formula (6) or (7), the structure of the principal component of the hydrogenated dimer diol is the structure represented by the following Formula (8) or (9).

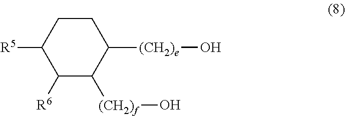

(wherein R⁵ and R⁶ are each independently an alkyl group, and the sum of the number of carbon atoms included in R⁵ and R⁶, e and f is 30 (i.e., the number of carbon atoms included in R⁵+the number of carbon atoms included in R⁶+e+f=30).)

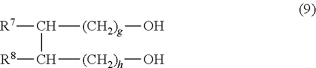

(wherein R⁷ and R⁸ are each independently an alkyl group, and the sum of the numbers of carbon atoms included in R⁷ and R⁸, g and h is 34 (i.e., the number of carbon atoms included in R⁷+the number of carbon atoms included in R⁸+g+h=34).)

Examples of commercially available hydrogenated dimer diol include PRIPOL® 2033 (manufactured by Croda Japan KK) SoVermol® 908 (manufactured by BASF).

A (poly)ester polyol which may be a raw material of a (meth)acryloyl group-containing compound having a (poly)ester structural unit can be manufactured by the condensation reaction of the above-mentioned polycarboxylic acid and polyol components in which the above-mentioned polyol is an essential component in the presence of esterification catalyst.

Since water is removed in the above-mentioned esterification, the reaction is generally performed at a reaction temperature of about from 150 to 250° C. The reaction is generally performed under a normal pressure or a reduced pressure.

A (poly)ester polyol which may be a raw material of a (meth)acryloyl group-containing compound having a (poly)ester structural unit can also be manufactured by transesterification of a lower alkyl ester of the above-mentioned carboxylic acid and a polyol component in which the above-mentioned polyol is an essential component in the presence of a transesterification catalyst.

Since alcohol is removed in the above-mentioned transesterification, the reaction is generally performed at a reaction temperature of about from 120 to 230° C. The reaction is generally performed under a normal pressure or a reduced pressure.

Herein, when a (poly)ester polyol which may be a raw material of a (meth)acryloyl group-containing compound having a (poly)ester structural unit is manufactured, in cases where a polyol which is a raw material for (poly)ester polyol (i.e., a polyol without a —COO— bond (carboxylic acid ester bond)) remains, this polyol is also included in the (poly)ester polyol.

In other words, this means that, when 8% by mass of raw material polyol remains in the (poly)ester polyol, this polyol is also included in the (poly)ester polyol.

Herein, when a (meth)acryloyl group-containing compound having a (poly)ester structural unit is manufactured by newly adding a polyol other than a raw material polyol included in the (poly)ester polyol, the newly added polyol is included in the (poly)ester polyol even the polyol is a polyol without a —COO— bond (carboxylic acid ester bond).

In other words, this means that, when a (poly)ester polyol is synthesized by using a hydrogenated dimer diol as a raw material polyol component of the (poly)ester polyol, in cases where 8 parts by mass of the hydrogenated dimer diol which is a raw material remains, and further, 5 parts by mass of hydrogenated dimer diol is added, whereby the component (1) is manufactured, both the raw material hydrogenated dimer diol which is remained when the component (1) is synthesized and the hydrogenated dimer diol which is added thereafter are included in the (poly)ester polyol.

It should be noted that the hydroxyl group value of a (poly)ester polyol to be used as a raw material of a (meth)acryloyl group-containing compound having a (poly)ester structural unit of Component (1) of the invention (I) is preferably in a range of from 20 to 100 mg KOH/g, more preferably from 25 to 80 mg KOH/g, and still more preferably from 30 to 65 mg KOH/g.

When a polyol which may be a raw material of (poly)ester polyol is used as a raw material of a (meth)acryloyl group-containing compound having a (poly)ester structural unit of the invention (I), the amount thereof, with respect to 100 parts by mass of (poly)ester polyol, is desirably 30 parts by mass or smaller, and preferably 25 parts by mass or smaller.

A method of synthesizing a (meth)acryloyl group-containing compound having a (poly)ester structural unit is not particularly restricted, and examples thereof include: a (meth)acryloyl group-containing compound having a (poly)ester structural unit obtained by performing an addition reaction by using a (poly)ester polyol, an organic polyisocyanate compound and an alcoholic hydroxyl group-containing (meth)acrylate as essential raw materials; and a (meth)acryloyl group-containing compound having a (poly)ester structural unit obtained by performing an addition reaction by using a (poly)ester polyol and (meth)acryloyl group-containing compound having, in one molecule, one isocyanato group as an essential raw material.

First, a (meth)acryloyl group-containing compound having a (poly)ester structural unit obtained by performing an addition reaction by using a (poly)ester polyol, an organic polyisocyanate compound and an alcoholic hydroxyl group-containing (meth)acrylate as essential raw material components will be described.

The (poly)ester polyol is as mentioned above.

The organic polyisocyanate compound is similar to the organic polyisocyanate compound which is described for the raw material components of a (meth)acryloyl group-containing compound having a polyolefin structural unit or a (meth)acryloyl group-containing compound having a hydrogenated polyolefin structural unit.

The alcoholic hydroxyl group-containing (meth)acrylate is also similar to those described in the raw material components of a (meth)acryloyl group-containing compound having a polyolefin structural unit or a (meth)acryloyl group-containing compound having a hydrogenated polyolefin structural unit.

The compound can be manufactured in a similar synthesizing method to a method described in the explanation of cases where a (meth)acryloyl group-containing compound having a polyolefin structural unit is obtained by using the above-mentioned polyolefin polyol, organic polyisocyanate compound, and alcoholic hydroxyl group-containing (meth)acrylate as essential raw material components by replacing the polyolefin polyol with a (poly)ester polyol.

When a urethane (meth)acrylate which is synthesized by using a (poly)ester polyol as a raw material component in this method is synthesized, a urethane (meth)acrylate which does not have a (poly)ester structural unit may also be manufactured in a similar manner to the explanation when a urethane (meth)acrylate which is synthesized by using a polyolefin polyol as a raw material component. However, herein, a urethane (meth)acrylate which does not have a (poly)ester structural unit is defined not to be included in Component (1) which is an essential component of the invention (I). For example, when a (meth)acryloyl group-containing compound having a (poly)ester structural unit of Component (1) is manufactured by using a (poly)ester polyol, a 1,3-bis(isocyanatomethyl) cyclohexane, and a 2-hydroxyethyl acrylate, a compound of the above-mentioned Formula (1) which is a urethane (meth)acrylate which does not have a (poly)ester structural unit is also manufactured. However, the compound of Formula (1) does not have a (poly)ester structural unit, which means that the compound is not included in the Component (1).

Next, a case of obtaining a (meth)acryloyl group-containing compound having a (poly)ester structural unit by using a (poly)ester polyol and (meth)acryloyl group-containing compound having, in one molecule, one isocyanato group as an essential raw material component will be described.

The (poly)ester polyol is as mentioned above.

Examples of a (meth)acryloyl group-containing compound having an isocyanato group which may be the above-mentioned raw material include the above-mentioned 2-isocyanatoethyl acrylate, and 2-isocyanatoethyl methacrylate.

A method of obtaining a (meth)acryloyl group-containing compound having a (poly)ester structural unit by using a (poly)ester polyol and (meth)acryloyl group-containing compound having, in one molecule, one isocyanato group as an essential raw material component is performed in a similar manner to a method of obtaining a (meth)acryloyl group-containing compound having a hydrogenated polyolefin structural unit by using the above-mentioned polyolefin polyol and (meth)acryloyl group-containing compound having, in one molecule, one isocyanato group as essential raw material components by replacing the polyolefin polyol with a (poly)ester polyol.

Next, a (meth)acryloyl group-containing compound having a (poly)carbonate structural unit will be described.

The (meth)acryloyl group-containing compound having a (poly)carbonate structural unit is not particularly restricted, as long as it is a compound having, in one molecule, a structural unit derived from a (poly)carbonate polyol and a (meth)acryloyl group. One or more (meth)acryloyl groups and one or more urethane bonds may be contained in one molecule at the same time. A (poly)carbonate polyol which may be the raw material is not particularly restricted as long as it is a compound having, in one molecule, one or more carbonate bonds (—OCOO—) and two or more alcoholic hydroxyl groups.

Examples of the (poly)carbonate polyol which may be a raw material of a (meth)acryloyl group-containing compound having a (poly)carbonate structural unit include a (poly)carbonate polyol manufactured by using a polyol having a chain-shaped hydrocarbon chain as a raw material, a (poly)carbonate polyol manufactured by using a polyol having an alicyclic structure-containing hydrocarbon chain as a raw material, and a (poly) carbonate polyol manufactured by using a polyol having an aromatic ring structure-containing hydrocarbon chain as a raw material.

Among the polyols which may be a raw material of the (poly) carbonate polyol, preferred are polyols whose number of carbon atoms is eight or more.

Examples of the polyols whose number of carbon atoms is eight or more include 1,4-cyclohexanedimethanol, 1,2-cyclohexanedimethanol, 1,3-cyclohexanedimethanol, 2-methyl-1,1-cyclohexanedimethanol, tricyclo[5.2.1.0^{2,6}]decanedimethanol, 1,9-nonanediol, 2-methyl-1,8-octane diol, 1,10-decadiol, 1,12-dodecanediol, dimer diol, and hydrogenated dimer diol. Among the polyols whose number of carbon atoms is eight or more, still preferred are 1,10-decadiol, 1,12-dodecanediol, and hydrogenated dimer diol, and most preferred is hydrogenated dimer diol.

A (poly)carbonate polyol which may be a raw material of a (meth)acryloyl group-containing compound having a (poly) carbonate structural unit can be manufactured also by the transesterification of the polyol component and dialkyl carbonate, diaryl carbonate, or alkylene carbonate in the presence of a transesterification catalyst.

Since alcohol is removed in the above-mentioned transesterification, the reaction is generally performed at a reaction temperature about from 80 to 230° C. The reaction is generally performed under a normal pressure or a reduced pressure.

The (poly)carbonate polyol which may be a raw material of a (meth)acryloyl group-containing compound having a (poly)carbonate structural unit can be manufactured also by the reaction the polyol and phosgene.

The above-mentioned reaction is generally performed at a reaction temperature of 100° C. or lower. Since hydrochloric acid is produced, a base is generally used to trap the hydrochloric acid.

Herein, when a (poly)carbonate polyol which may be a raw material of the component (1) which is an essential raw material component of the polymerizable composition of the invention (I) is manufactured, in cases where a polyol which is a raw material of the (poly)carbonate polyol (i.e., a polyol without a carbonate bond) remains, this polyol is also included in the (poly)carbonate polyol.

In other words, this means that, when 8% by mass of raw material polyol remains in the (poly)carbonate polyol, this remained polyol is also included in the (poly)ester polyol.

Herein, when a (meth)acryloyl group-containing compound having a (poly)carbonate structural unit is manufactured by newly adding a polyol other than a raw material polyol included in the (poly)carbonate polyol, the newly added polyol is included in the (poly)carbonate polyol even the polyol is a polyol without a carbonate bond.

In other words, this means that, when a (meth)acryloyl group-containing compound having a (poly) carbonate structural unit is synthesized, in cases where 8 parts by mass of the polyol which is a raw material remains, and further, 5 parts by mass of polyol is added, whereby a (meth)acryloyl group-containing compound having a (poly)carbonate structural unit is manufactured, both the raw material polyol which is remained when the component (1) is synthesized and the polyol which is added thereafter are included in the (poly) carbonate polyol.

It is noted that the hydroxyl group value of the (poly) carbonate polyol to be used as a raw material of a (meth)acryloyl group-containing compound having a (poly) carbonate structural unit is preferably in a range of from 20 to 100 mg KOH/g, more preferably from 25 to 80 mg KOH/g, and still more preferably from 30 to 65 mg KOH/g.

When a polyol which may be a raw material of the (poly) carbonate polyol is used as a raw material of a (meth)acryloyl group-containing compound having a (poly) carbonate structural unit, the amount thereof, with respect to 100 parts by mass of (poly)carbonate polyol, is desirably 30 parts by mass or smaller, preferably 25 parts by mass or smaller.

A method of synthesizing a (meth)acryloyl group-containing compound having a (poly)carbonate structural unit is not particularly restricted, and examples thereof include: a (meth)acryloyl group-containing compound having a (poly)carbonate structural unit obtained by performing an addition reaction by using a (poly) carbonate polyol, an organic polyisocyanate compound and an alcoholic hydroxyl group-containing (meth)acrylate as essential raw materials; and a (meth)acryloyl group-containing compound having a (poly) carbonate structural unit obtained by performing an addition reaction by using a (poly)carbonate polyol and (meth)acryloyl group-containing compound having, in one molecule, one isocyanato group as an essential raw material.

First, a (meth)acryloyl group-containing compound having a (poly)carbonate structural unit obtained by performing an addition reaction by using a (poly) carbonate polyol, an organic polyisocyanate compound and an alcoholic hydroxyl group-containing (meth)acrylate as essential raw material components will be described.

The (poly)carbonate polyol is as mentioned above.

The organic polyisocyanate compound is similar to the organic polyisocyanate compound which is described for the raw material components of a (meth)acryloyl group-containing compound having a polyolefin structural unit or a (meth)acryloyl group-containing compound having an hydrogenated polyolefin structural unit.

The alcoholic hydroxyl group-containing (meth)acrylate is also similar to those described in the raw material components of a (meth)acryloyl group-containing compound having a polyolefin structural unit or a (meth)acryloyl group-containing compound having an hydrogenated polyolefin structural unit.

The (meth)acryloyl group-containing compound having a (poly)carbonate structural unit obtained by addition reaction by using a (poly)carbonate polyol, an organic polyisocyanate compound, and an alcoholic hydroxyl group-containing (meth)acrylate as the essential raw material components can be manufactured in a similar synthesizing method to a method described in the explanation of cases where a (meth)acryloyl group-containing compound having a polyolefin structural unit is obtained by using the above-mentioned polyolefin polyol, organic polyisocyanate compound, and alcoholic hydroxyl group-containing (meth)acrylate as essential raw material components by replacing the polyolefin polyol with a (poly)carbonate polyol.

When a urethane (meth)acrylate which is synthesized by using a (poly)carbonate polyol as a raw material component in this method is synthesized, a urethane (meth)acrylate which does not have a (poly)carbonate structural unit may also be manufactured in a similar manner to the explanation when a urethane (meth)acrylate which is synthesized by using a polyolefin polyol as a raw material component. However, herein, a urethane (meth)acrylate which does not have a (poly)carbonate polyol structural unit is defined not to be included in Component (1) which is an essential component of the invention (I). For example, when a (meth)acryloyl group-containing compound having a (poly)carbonate structural unit of Component (1) is manufactured by using a (poly)carbonate polyol, a 1,3-bis(isocyanatomethyl) cyclohexane, and a 2-hydroxyethyl acrylate, a compound of the above-mentioned Formula (1) which is a urethane (meth)acrylate which does not have a (poly)carbonate structural unit is also manufactured. However, the compound of Formula (1) does not have a (poly)carbonate structural unit, which means that the compound is not included in the Component (1).

Next, a case of obtaining a (meth)acryloyl group-containing compound having a (poly)carbonate structural unit by using a (poly)carbonate polyol and (meth)acryloyl group-containing compound having, in one molecule, one isocyanato group as an essential raw material component will be described.

The (poly)carbonate polyol is as mentioned above.

Examples of a (meth)acryloyl group-containing compound having an isocyanato group which may be the above-mentioned raw material include the above-mentioned 2-isocyanatoethyl acrylate, and 2-isocyanatoethyl methacrylate.

A method of obtaining a (meth)acryloyl group-containing compound having a (poly)carbonate structural unit by using a (poly)carbonate polyol and (meth)acryloyl group-containing compound having, in one molecule, one isocyanato group as an essential raw material component is obtained in a similar manner to a method of obtaining a (meth)acryloyl group-containing compound having a hydrogenated polyolefin structural unit by using the above-mentioned polyolefin polyol and (meth)acryloyl group-containing compound having, in one molecule, one isocyanato group as essential raw material components by replacing the polyolefin polyol with a (poly)carbonate polyol.

The amount of the component (1) to be used in the invention (I) is preferably, with respect to the total amount of the polymerizable composition of the invention (I), from 10 to 50% by mass, further preferably, from 12 to 40% by mass, and particularly preferably from 13 to 35% by mass. When the amount of the component (1) to be used is less than 10% by mass with respect to the total amount of the polymerizable composition of the invention (I), the volume shrinkage rate during polymerization of the polymerizable composition of the invention (I) may become high or it may become hard to polymerize the polymerizable composition of the invention (I), which is not preferred. When the amount of the component (1) to be used is larger than 50% by mass with respect to the total amount of the polymerizable composition of the invention (I), the viscosity of the polymerizable composition of the invention (I) may become high, which is not preferred.

Next, Component (2) which is essential raw material components of a polymerizable composition of the invention (I) will be described.

Component (2) is a liquid (meth)acryloyl group-containing compound, and not particularly restricted as long as it is other than Component (1). Examples thereof include a (meth)acryloyl group-containing compound having a linear aliphatic hydrocarbon group, a (meth)acryloyl group-containing compound having a cycloaliphatic group, a (meth)acryloyl group-containing compound having an aromatic ring structure, a (meth)acryloyl group-containing compound having a heterocyclic structure.

Among these, preferred are a (meth)acryloyl group-containing compound having a hydrocarbon group whose number of carbon atoms is six or more. Examples of the (meth)acryloyl group-containing compound having a hydrocarbon group whose number of carbon atoms is six or more include a (meth)acryloyl group-containing compound having a cycloaliphatic group such as benzyl acrylate, cyclohexyl acrylate, isobornyl acrylate, dicylopentenyl acrylate, dicylopentenyl oxyethyl acrylate, dicyclopentanyl acrylate, dicyclopentanyl ethyl acrylate, 4-tert-butyl cyclohexyl acrylate, cyclohexyl methacrylate, isobornyl methacrylate, dicylopentenyl methacrylate, dicylopentenyl oxyethyl methacrylate, dicyclopentanyl methacrylate, dicyclopentanyl ethyl methacrylate, or 4-tert-butyl cyclohexyl methacrylate, and a (meth)acryloyl group-containing compound having a chain aliphatic group such as methoxy triethylene acrylate, ethyl carbitol acrylate, lauryl acrylate, isononyl acrylate, 2-propyl heptyl acrylate, 4-methyl-2-propyl hexyl acrylate, lauryl methacrylate, isononyl methacrylate, 2-propyl heptyl methacrylate, or 4-methyl-2-propyl hexyl methacrylate.

Among these, in view of the resistance to thermal coloration, preferred are cyclohexyl acrylate, isobornyl acrylate, dicyclopentanyl acrylate, dicyclopentanyl oxyethyl acrylate, cyclohexyl methacrylate, isobornyl methacrylate, dicyclopentanyl methacrylate, dicyclopentanyl ethyl methacrylate, methoxy triethylene acrylate, ethyl carbitol acrylate, lauryl acrylate, isononyl acrylate, 2-propyl heptyl acrylate, 4-methyl-2-propyl hexyl acrylate, lauryl methacrylate, isononyl methacrylate, 2-propyl heptyl methacrylate, and 4-methyl-2-propyl hexyl methacrylate; in view of dilution efficiency of the below-mentioned Component (6), further preferred are lauryl acrylate, isononyl acrylate, 2-propyl heptyl acrylate, 4-methyl-2-propyl hexyl acrylate, isononyl methacrylate, 2-propyl heptyl methacrylate, and 4-methyl-2-propyl hexyl methacrylate; and in view of the photopolymerization rate, particularly preferred are lauryl acrylate, isononyl acrylate, 2-propyl heptyl acrylate, and 4-methyl-2-propyl hexyl acrylate.

Further, in the polymerizable composition of the invention (I), Component (2) can contain a (meth)acryloyl group-containing compound having an alcoholic hydroxyl group, which is preferred.

Specific examples of the (meth)acryloyl group-containing compound having an alcoholic hydroxyl group include 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, 2-hydroxy-3-(o-phenyl phenoxy)propyl acrylate, 2-hydroxyethyl acrylamide, 2-hydroxyethyl methacrylate, 2-hydroxypropyl methacrylate, 3-hydroxypropyl methacrylate, 2-hydroxybutyl methacrylate, 4-hydroxybutyl methacrylate, 2-hydroxy-3-phenoxypropyl methacrylate, and 2-hydroxy-3-(o-phenyl phenoxy)propyl methacrylate.

Among these, in view of the compatibility when used as the polymerizable composition of the invention (I), preferred are 2-hydroxybutyl acrylate, 4-hydroxybutyl acrylate, 2-hydroxy-3-phenoxypropyl acrylate, 2-hydroxy-3-(o-phenyl phenoxy)propyl acrylate, 2-hydroxypropyl methacrylate, 3-hydroxypropyl methacrylate, 2-hydroxybutyl methacrylate, and 4-hydroxybutyl methacrylate; more preferred are 4-hydroxybutyl acrylate, 2-hydroxypropyl methacrylate, 3-hydroxypropyl methacrylate, 2-hydroxybutyl methacrylate, and 4-hydroxybutyl methacrylate; and most preferred is 2-hydroxypropyl methacrylate.

The amount of the component (2) to be used is, with respect to the total amount of the polymerizable composition of the invention (I), preferably from 10 to 30% by mass, further preferably, from 13 to 25% by mass, and particularly preferably from 15 to 22% by mass. When the amount of the component (2) to be used is less than 10% by mass with respect to the total amount of the polymerizable composition of the invention (I), the viscosity of the polymerizable composition of the invention (I) may become high, which is not preferred. When the amount of the component (2) to be used is larger than 30% by mass with respect to the total amount of the polymerizable composition of the invention (I), the volume shrinkage rate during polymerization of the polymerizable composition of the invention (I) may become high, which is not preferred.

Next, Component (3) which is an essential component of a polymerizable composition of the invention (I) will be described.

Component (3) is at least one selected from the group consisting of a liquid hydrogenated polybutadiene polyol, a liquid hydrogenated polyisoprene polyol, and a hydrogenated dimer diol.

A liquid hydrogenated polybutadiene polyol is a liquid polyol having a structure obtained by reducing and hydrogenating a polybutadiene polyol or a polybutadiene polycarboxylic acid, and examples thereof include NISSO-PB GI-1000, NISSO-PB GI-2000, and NISSO-PB GI-3000 manufactured by Nippon Soda Co., Ltd.

A liquid hydrogenated polyisoprene polyol is a liquid polyol having a structure obtained by reducing and hydrogenating a polyisoprene polyol or a polyisoprene polycarboxylic acid, and examples thereof include Epol manufactured by Idemitsu Kosan Co., Ltd.

The explanation of a hydrogenated dimer diol has been made above, and is omitted here.

Among these, in view of the resistance to thermal coloration, preferred are a liquid hydrogenated polybutadiene polyol and a liquid hydrogenated polyisoprene polyol, and particularly preferred are a liquid hydrogenated polybutadiene polyol; and in view of low dielectric constant, preferred are a liquid hydrogenated polybutadiene polyol and a liquid hydrogenated polyisoprene polyol, and particularly preferred is a liquid hydrogenated polybutadiene polyol.

The amount of Component (3) to be used is preferably, with respect to the total amount of the polymerizable composition of the invention (I), 10 to 45% by mass, further preferably 12 to 40% by mass, and particularly preferably 15 to 37% by mass. When the amount of Component (3) to be used is smaller than 10% by mass with respect to the total amount of the polymerizable composition of the invention (I), the dielectric constant of the polymerizable composition of the invention (I) may become high, which is not preferred. When the amount of Component (3) to be used is larger than 44% by mass with respect to the total amount of the polymerizable composition of the invention (I), the strength of the polymerizable composition of the invention (I) during polymerization may become small, which is not preferred.

Next, Component (4) which is an essential component of a polymerizable composition of the invention (I) will be described.

The component (4) which is an essential component of the invention (I) is a photopolymerization initiator.

A photopolymerization initiator of the component (4) is not particularly limited as long as it is a compound which generates a radical contributing to the initiation of radical polymerization by irradiation of a light such as a near infrared light, a visible light, or an UV light.

Specific examples of the photopolymerization initiator of the component (4) include acetophenone, 2,2-dimethoxy-2-phenyl acetophenone, diethoxy acetophenone, 1-hydroxycyclohexyl phenyl ketone, 1,2-hydroxy-2-methyl-1-phenyl propane-1-one, α-hydroxycyclohexyl phenyl ketone, 2-hydroxy-2-methyl-1-phenyl propane-1-one, 2-hydroxy-2-methyl-1-(4-isopropylphenyl)propane-1-one, 2-hydroxy-2-methyl-1-(4-dodecylphenyl)propane-1-one, and 2-hydroxy-2-methyl-1-[(2-hydroxyethoxy)phenyl]propanone, benzophenone, 2-methylbenzophenone, 3-methylbenzophenone, 4-methylbenzophenone, 4-methoxybenzophenone, 2-chlorobenzophenone, 4-chlorobenzophenone, 4-bromobenzophenone, 2-carboxybenzophenone, 2-ethoxycarbonyl benzophenone, 4-benzoyl-4′-methyl diphenyl sulfide, benzophenone tetracarboxylic acid or a tetramethyl ester thereof, a 4,4′-bis(dialkylamino)benzophenone (such as 4,4′-bis(dimethylamino)benzophenone, 4,4′-bis(dicyclohexylamino)benzophenone, 4,4′-bis(diethylamino)benzophenone, or 4,4′-bis(dihydroxyethylamino)benzophenone), 4-methoxy-4′-dimethylamino benzophenone, 4,4′-dimethoxybenzophenone, 4-dimethylamino benzophenone, 4-dimethylamino acetophenone, benzil, anthraquinone, 2-t-butylanthraquinone, 2-methylanthraquinone, phenanthraquinone, fluorenone, 2-benzil-2-dimethylamino-1-(4-morpholinophenyl)-1-butanone, 2-(dimethylamino)-2-[(4-methyl phenyl)methyl]-1-[4-(4-morpholinyl)phenyl]-1-butanone, 2-methyl-1-[4-(methylthio)phenyl]-2-morpholino-1-propanone, 2-hydroxy-2-methyl-[4-(1-methylvinyl)phenyl]propanol oligomer, benzoin, a benzoin ether (such as benzoin methylether, benzoin ethylether, benzoin propylether, benzoin isopropylether, benzoin isobutylether, benzoin phenylether, or benzildimethylketal), acridone, chloroacridone, N-methylacridone, N-butylacridone, N-butyl-chloroacridone, 2,4,6-trimethylbenzoyl diphenylphosphine oxide, 2,6-dimethoxybenzoyl diphenylphosphine oxide, 2,6-dichlorobenzoyl diphenylphosphine oxide, 2,4,6-trimethylbenzoyl methoxyphenylphosphine oxide, 2,4,6-trimethylbenzoyl ethoxy phenylphosphine oxide, 2,3,5,6-tetramethylbenzoyl diphenylphosphine oxide, and benzoyl di-(2,6-dimethyl phenyl)phosphonate. Examples of a bisacyl phosphine oxide include bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-propylphenylphosphine oxide, bis-(2,6-dichlorobenzoyl)-1-naphthyl phosphine oxide, bis-(2,6-dimethoxybenzoyl)phenylphosphine oxide, bis-(2,6-dimethoxybenzoyl)-2,4,4-trimethylpentyl phosphine oxide, bis-(2,6-dimethoxybenzoyl)-2,5-dimethylphenylphosphine oxide, bis-(2,4,6-trimethyl benzoyl)phenylphosphine oxide, (2,5,6-trimethyl benzoyl)-2,4,4-trimethylpentyl phosphine oxide, 2-isopropylthioxanthone, 4-isopropylthioxanthone, 2,4-diethylthioxanthone, 2,4-dichlorothioxanthone, and 1-chloro-4-propoxythioxanthone.

As a photopolymerization initiator, a metallocene compound may also be employed. As the metallocene compound, a transition element represented by Fe, Ti, V, Cr, Mn, Co, Ni, Mo, Ru, Rh, Lu, Ta, W, Os, Ir, or the like can be used as a central metal, and examples of the metallocene compound include bis(η5-2,4-cyclopentadien-1-yl)-bis[2,6-difluoro-3-(pyrrole-1-yl)phenyl] titanium.

These photopolymerization initiators can be used singly or in combination of two or more thereof.

Among these, preferred are 2-hydroxy-2-methyl-1-phenyl propane-1-one, 1-hydroxycyclohexyl phenyl ketone, 2,4,6-trimethylbenzoyl diphenylphosphine oxide, and 2,3,5,6-tetramethylbenzoyl diphenylphosphine oxide; particularly preferred are 1-hydroxycyclohexyl phenyl ketone and 2,4,6-trimethylbenzoyl diphenylphosphine oxide; and most preferred is a single use of 2,4,6-trimethylbenzoyl diphenylphosphine oxide or a use of 1-hydroxycyclohexyl phenyl ketone and 2,4,6-trimethylbenzoyl diphenylphosphine oxide in combination.

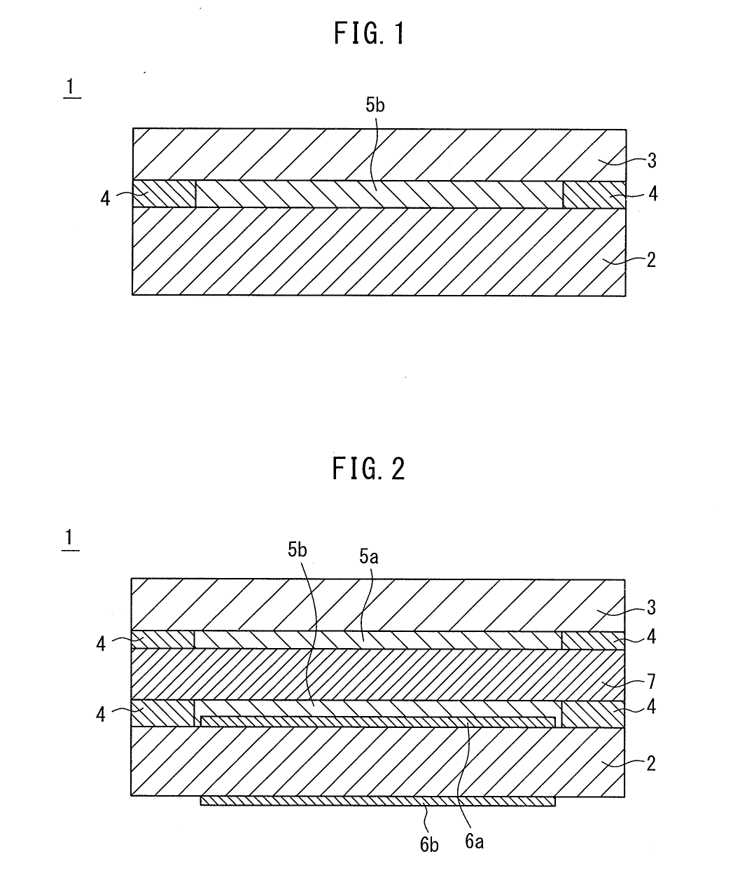

In many cases, a light-transmitting protection unit 103 in FIG. 1 or FIG. 2 is provided with a function of cutting an UV light region from the viewpoint of protecting an image-display unit 105 from a UV light. In this case, 2,4,6-trimethylbenzoyl diphenylphosphine oxide or 2,3,5,6-tetramethylbenzoyl diphenylphosphine oxide which is a photopolymerization initiator photosensitive even in a visible light region is preferably used, and particularly preferably 2,4,6-trimethylbenzoyl diphenylphosphine oxide is used.

The amount of the component (4) to be used is with respect to the total amount of the polymerizable composition of the invention (I), preferably from 0.1 to 4.0% by mass, further preferably from 0.3 to 3.0% by mass, and particularly preferably from 0.5 to 2.0% by mass. When the amount of the component (4) to be used is smaller than 0.1% by mass with respect to the total amount of the polymerizable composition of the invention (I), the polymerization initiation performance of the polymerization initiator may become insufficient, which is not preferred. When the amount of the component (4) to be used is larger than 4.0% by mass with respect to the total amount of the polymerizable composition of the invention (I), a polymerization product of the below-mentioned invention (II) may tend to be colored when placed under a high temperature environment, which is not preferred.

Further, the polymerizable composition of the invention (I) may include the component (5) below, which is preferred.

Component (5): at least one selected from the group consisting of a hydrogenated polybutadiene, a hydrogenated polyisoprene, a poly(α-olefin) liquid substance, an ethylene-propylene copolymer liquid substance, a propylene-α-olefin copolymer liquid substance, an ethylene-α-olefin copolymer liquid substance, a liquid polybutene, a liquid hydrogenated polybutene, a liquid polybutadiene, a liquid hydrogenated polybutadiene, a liquid polyisoprene, a liquid hydrogenated polyisoprene, a liquid polybutadiene polyol, and a liquid polyisoprene polyol

A hydrogenated polybutadiene is a liquid substance at normal temperature obtained by reducing and hydrogenating a butadiene polymer, and examples thereof include NISSO-PB BI-2000 and NISSO-PB BI-3000 manufactured by Nippon Soda Co., Ltd.

A hydrogenated polyisoprene is a liquid compound at normal temperature obtained by reducing and hydrogenating an isoprene polymer, and examples thereof include LIR-200 manufactured by KURARAY CO., LTD.

A poly(α-olefin) liquid substance is a liquid substance manufactured by polymerization of an α-olefin, and an α-olefin is a hydrocarbon compound having, at an end of the molecule, a carbon-carbon double bond, and examples thereof include 1-butene, 1-pentene, 1-hexene, 1-octene, 1-decene, 1-dodecene, 1-tetradecene, 1-hexadecene, and 1-octadecene.

A copolymer liquid substance of a propylene and an α-olefin is a liquid polymer manufactured by copolymerizing a propylene and an α-olefin. An α-olefin is a hydrocarbon compound having, at an end of the molecule, a carbon-carbon double bond, and exampled thereof include 1-butene, 1-pentene, 1-hexene, 1-octene, 1-decene, 1-dodecene, 1-tetradecene, 1-hexadecene, and 1-octadecene.

A copolymer liquid substance of an ethylene and an α-olefin is a liquid polymer manufactured by copolymerizing an ethylene and an α-olefin. An α-olefin is a hydrocarbon compound having, at an end of the molecule, a carbon-carbon double bond, and examples thereof include 1-butene, 1-pentene, 1-hexene, 1-octene, 1-decene, 1-dodecene, 1-tetradecene, 1-hexadecene, and 1-octadecene.

A liquid polybutene is a liquid polymer containing, as a (co)polymer component, an isobutene or an n-butene such as a homopolymer of isobutene, a homopolymer of n-butene, or a copolymer of isobutene and n-butene, and is a compound having, at one end, a carbon-carbon unsaturated bond. Examples of commercially available liquid polybutene include NissekiPolybutene LV-7, LV-50, LV-100, HV-15, HV-35, HV-50, HV-100, and HV-300 manufactured by JX Nippon Oil & Energy Corporation.

A liquid hydrogenated polybutene is a liquid substance having a side chain obtained by hydrogenating the liquid polybutene, and examples thereof include Palm Reel 4, Palm Reel 6, Palm Reel 18, Palm Reel 24, and Palm Reel EX manufactured by NOF CORPORATION.

A liquid polybutadiene is a liquid butadiene polymer at normal temperature, and examples thereof include POLYVEST 110 and POLYVEST 130 manufactured by Evonik Degussa Corporation and NISSO-PB B-1000, NISSO-PB B-2000, and NISSO-PB B-3000 manufactured by Nippon Soda Co., Ltd.

A liquid polyisoprene is a liquid isoprene polymer at normal temperature, and examples thereof include Kuraprene LIR-30 manufactured by KURARAY CO., LTD.

A liquid polybutadiene polyol is a liquid polymer at normal temperature having, at an end of the molecule, two or more hydroxyl groups and having a polybutadiene structural unit, and examples thereof include NISSO-PB G-1000, NISSO-PB G-2000, and NISSO-PB G-3000 manufactured by Nippon Soda Co., Ltd. and Poly bd manufactured by Idemitsu Kosan Co., Ltd.

A liquid polyisoprene polyol is a liquid polymer at normal temperature having, at an end of the molecule, two or more hydroxyl groups and having a polyisoprene structural unit, and examples thereof include Poly ip manufactured by Idemitsu Kosan Co., Ltd.

The amount of Component (5) to be used is, with respect to the total amount of the polymerizable composition of the invention (I), preferably 5 to 35% by mass, further preferably 7 to 32% by mass, and particularly preferably 10 to 30% by mass. When the amount of Component (5) to be used is smaller than 5% by mass with respect to the total amount of the polymerizable composition of the invention (I), the dielectric constant and viscosity of the polymerizable composition of the invention (I) becomes high, which is not preferred. When the amount of Component (5) to be used is larger than 35% by mass with respect to the total amount of the polymerizable composition of the invention (I), the strength of hardened substance of the polymerizable composition of the invention (I) during polymerization becomes low, which is not preferred.

Further, the polymerizable composition of the invention (I) can contain the below-mentioned Component (6), which is preferred.

Component (6): at least one selected from the group consisting of hydrogenated petroleum resins, hydrogenated terpene resins, and hydrogenated rosin ester.

A hydrogenated petroleum resin is a resin obtained by reducing a petroleum resin with hydrogen. Examples of a petroleum resin which is a raw material of a hydrogenated petroleum resin include an aliphatic petroleum resin, an aromatic petroleum resin, an aliphatic-aromatic copolymerization petroleum resin, an alicyclic petroleum resin, a dicyclopentadiene resin and a modified product thereof such as a hydrogenated product thereof. As a synthetic petroleum resin, a C5 petroleum resin or a C9 petroleum resin may be used.

A hydrogenated terpene resin is a resin obtained by reducing a terpene resin with hydrogen. Examples of the terpene resin which is a raw material of the hydrogenated terpene resin include a β-pinene resin, an α-pinene resin, a β-limonene resin, an α-limonene resin, a pinene-limonene copolymer resin, a pinene-limonene-styrene copolymer resin, a terpene-phenol resin, and an aromatic modified terpene resin. Many of these terpene resins do not have a polar group.

A hydrogenated rosin ester is a resin obtained by esterifying a hydrogenated rosin obtained by hydrogenation of a rosin resin, or reducing a rosin ester obtained by esterifying a rosin with hydrogen. Examples of a rosin resin tackifier include a modified rosin such as a gum rosin, a tall oil rosin, a wood rosin, a disproportionated rosin, a polymerized rosin, or a maleated rosin.

The amount of Component (6) to be used in the invention (I) is, with respect to the total amount of the polymerizable composition of the invention (I), preferably 10 to 50% by mass, further preferably 12 to 40% by mass, and particularly preferably 13 to 35% by mass. When the amount of Component (6) to be used is smaller than 10% by mass with respect to the total amount of the polymerizable composition of the invention (I), the shape of hardened film of the polymerizable composition of the invention (I) during polymerization may be less likely to be maintained, which is not preferred. When the amount of Component (6) to be used is larger than 50% by mass with respect to the total amount of the polymerizable composition of the invention (I), the viscosity of the polymerizable composition of the invention (I) may become high, which is not preferred.

When a polymerizable composition of the invention (I) is used for a method of manufacturing an image-display device of the below-mentioned the invention (IV), the volume shrinkage rate of the polymerizable composition of the invention (I) during polymerization is preferably 3.5% or lower, further preferably 2.7% or lower, and most preferably 2.3% or lower. When the volume shrinkage rate of the polymerizable composition of the invention (I) during polymerization is higher than 3.5%, the internal stress which is accumulated in a polymerization product when the polymerizable composition is polymerized becomes too large, and a deformation is generated at the interface between a polymerization product layer 5a or 5b and the display unit 2 which is in contact with the polymerization product layers, the protection unit 3, or a touch panel 7, which is not preferred.

The viscosity of the polymerizable composition of the invention (I) at 25° C. is not particularly restricted, and in view of ease of handling, preferably 10,000 mPa·s or lower, further preferably 7,000 mPa·s or lower, and particularly preferably 5,000 mPa·s or lower.

Regarding a composition whose viscosity is 5000 mPa·s or lower at 25° C., the viscosity herein is a value obtained by the measurement using a Cone/Plate type viscometer (manufactured by Brookfield, type: DV-II+Pro, spindle model: CPE-42), at a temperature of 25.0° C., and at a number of revolutions of 10 rpm.

When the viscosity of the polymerizable composition of the invention (I) at 25° C. is 1,000 mPa·s or lower, in cases in which the polymerizable composition of the invention (I) is applied by drawing-application using a dispenser, spread of the liquid after application becomes easy, and as the result, the composition easily spreads at a needed location in a uniform thickness, and further, involvement of an air bubble is easily inhibited.

To the polymerizable composition of the invention (I), a polymerization suppressor, a polymerization inhibitor, or an antioxidant can be added, which is preferred.

The polymerization inhibitor or polymerization suppressor is not particularly restricted as long as it has a polymerization inhibiting ability or a polymerization suppressing ability, and examples thereof include phenothiazine, hydroquinone, p-methoxyphenol, p-benzoquinone, naphthoquinone, phenanthraquinone, toluquinone, 2,5-diacetoxy-p-benzoquinone, 2,5-dicaproxy-p-benzoquinone, 2,5-acyloxy-p-benzoquinone, p-t-butyl catechol, 2,5-di-t-butylhydroquinone, p-tert-butyl catechol, mono-t-butylhydroquinone, 2,5-di-t-amyl hydroquinone, di-t-butyl para-cresol hydroquinone monomethyl ether, alpha-naphthol, acetamidine acetate, acetamidine sulfate, phenylhydrazine hydrochloride, hydrazine hydrochloride, trimethylbenzylammonium chloride, lauryl pyridinium chloride, cetyl trimethyl ammonium chloride, phenyl trimethyl ammonium chloride, trimethylbenzylammonium oxalate, di(trimethylbenzylammonium)oxalate, trimethylbenzylammonium malate, trimethylbenzylammonium tartarate, trimethylbenzylammonium glycolate, phenyl-β-naphthylamine, parabenzil aminophenol, di-β-naphthyl paraphenylene diamine, dinitrobenzene, trinitrotoluene, picric acid, cyclohexanone oxime, pyrogallol, tannic acid, resorcinol, triethylamine hydrochloride, dimethylaniline hydrochloride and dibutylamine hydrochloride.

These may be used singly or in appropriate combination of two or more thereof.

Among these, hydroquinone, p-methoxyphenol, p-benzoquinone, naphthoquinone, phenanthraquinone, 2,5-diacetoxy-p-benzoquinone, 2,5-dicaproxy-p-benzoquinone, 2,5-acyloxy-p-benzoquinone, p-t-butyl catechol, 2,5-di-t-butylhydroquinone, p-tert-butyl catechol, mono-t-butylhydroquinone, 2,5-di-t-amyl hydroquinone, di-t-butyl·para-cresol hydroquinone monomethyl ether and phenothiazine are suitably employed.

Usually, the polymerization inhibitor can be adjusted such that the amount thereof added is 0.01 to 5 mass % with respect to the total amount of the polymerizable composition of the invention (I). It is noted that the amount of the polymerization inhibitor is a value in which a polymerization inhibitor contained in advance in the component (1), the component (2), or the component (5) is taken into account. In other words, generally, the component (1), the component (2), or the component (5) includes a polymerization inhibitor in advance, and the amount obtained by combining the amount of the polymerization inhibitor and the total amount of a newly added polymerization inhibitors is 0.01 to 5 mass % with respect to the total amount of the polymerizable composition of the invention (I).

The antioxidant is particularly restricted, and examples thereof include pentaerythritol tetrakis[3-(3,5-di-tert-butyl-4-hydroxyphenyl)propionate], octadecyl-3-(3,5-di-tert-butyl-4-hydroxyphenyl)propionate, thiodiethylene bis[3-(3,5-di-tert-butyl-4-hydroxyphenyl)propionate], C7-9 alkyl ester of 3,5-di-tert-butyl-4-hydroxybenzene propanoic acid, 4,6-bis(octyl thiomethyl)-o-cresol, 3,9-bis[2-[3-(3-tert-butyl-4-hydroxy-5-methyl phenyl)propionyloxy]-1,1-dimethylethyl]-2,4,8,10-tetraoxaspiro[5,5]-undecane, 2,2′-methylene bis(6-tert-butyl-4-methyl phenol), 4,4′-butylidene bis(6-tert-butyl-3-methyl phenol), 4,4′-thiobis(2-tert-butyl-5-methyl phenol), N,N′,N″-tris(3,5-di-tert-butyl-4-hydroxybenzil)isocyanurate, 1,1,3-tris(2-methyl-4-hydroxy-5-tert-butylphenyl)butane, and 1,1-bis(2-methyl-4-hydroxy-5-tert-butylphenyl)butane. Among these, preferred are pentaerythritol tetrakis[3-(3,5-di-tert-butyl-4-hydroxyphenyl)propionate] and octadecyl-3-(3,5-di-tert-butyl-4-hydroxyphenyl)propionate; and most preferred is pentaerythritol tetrakis[3-(3,5-di-tert-butyl-4-hydroxyphenyl)propionate].

Usually, the antioxidant can be adjusted such that the amount thereof added is 0.01 to 5 mass % with respect to the total amount of the polymerizable composition of the invention (I). It is noted that the amount of the polymerization inhibitor is a value in which an antioxidant contained in advance in other components such as the components (1) to (6) is taken into account. In other words, generally, the component (2) or the like may include an antioxidant in advance, and the amount obtained by combining the amount of the antioxidant and the total amount of a newly added antioxidants is 0.01 to 5 mass % with respect to the total amount of the polymerizable composition of the invention (I).

Next, the invention (II) will be described.

The invention (II) is a polymerization product obtained by polymerizing the polymerizable composition of the invention (I).

The polymerization product of the invention (II) is obtained by allowing a polymerizable composition to be irradiated with a light to which a photopolymerization initiator is photosensitive via a glass or plastic substrates using a low pressure mercury lamp, a medium pressure mercury lamp, a high pressure mercury lamp, an ultra-high pressure mercury lamp, xenon lamp, a metal halide lamp, electrodeless lamp, an LED or the like as a light source to polymerize.

The polymerization product of the invention (II) is a polymerization product which is used as a polymerization product layer interposed between an image-display unit and a light-transmitting protection unit of an image-display device. In this polymerization product, preferably, the dielectric constant of the polymerization product with a thickness of 2 mm under conditions of 23° C., a frequency of 1 MHz, and an applied voltage of 100 mV is 3.1 or smaller, and the chromatic coordinate b* value in accordance with JIS Z 8729 of the polymerization product whose thickness is adjusted to 200 μm existing between two glass sheets after being stored at 95° C. for 500 hours is smaller than 1.0.

The term “the dielectric constant of a polymerization product under conditions of 23° C., a frequency of 1 MHz, and an applied voltage of 100 mV” herein refers to the dielectric constant of a test piecetest piece (polymerization product) having a thickness of 2 mm under conditions of 23° C., a frequency of 1 MHz, and an applied voltage of 100 mV which is measured under an environment of 23° C. by using 4294A Precision Impedance Analyzer 40 Hz to 110 MHz as an impedance analyzer manufactured by Agilent Technologies Corporation and by using 16451B Dielectric Test Fixture manufactured by Agilent Technologies Corporation as a test fixture.

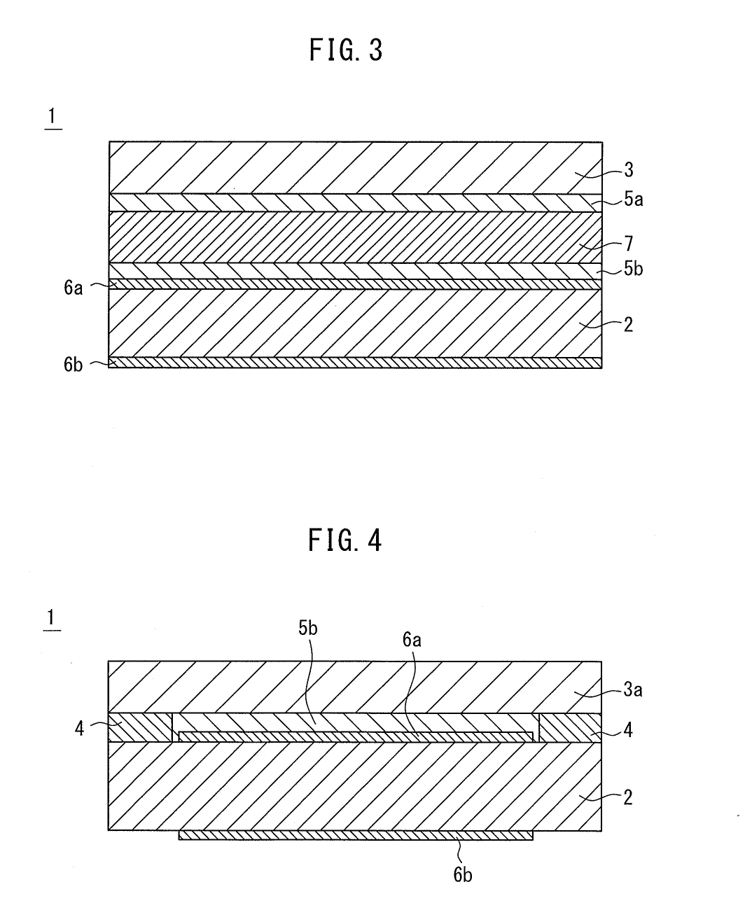

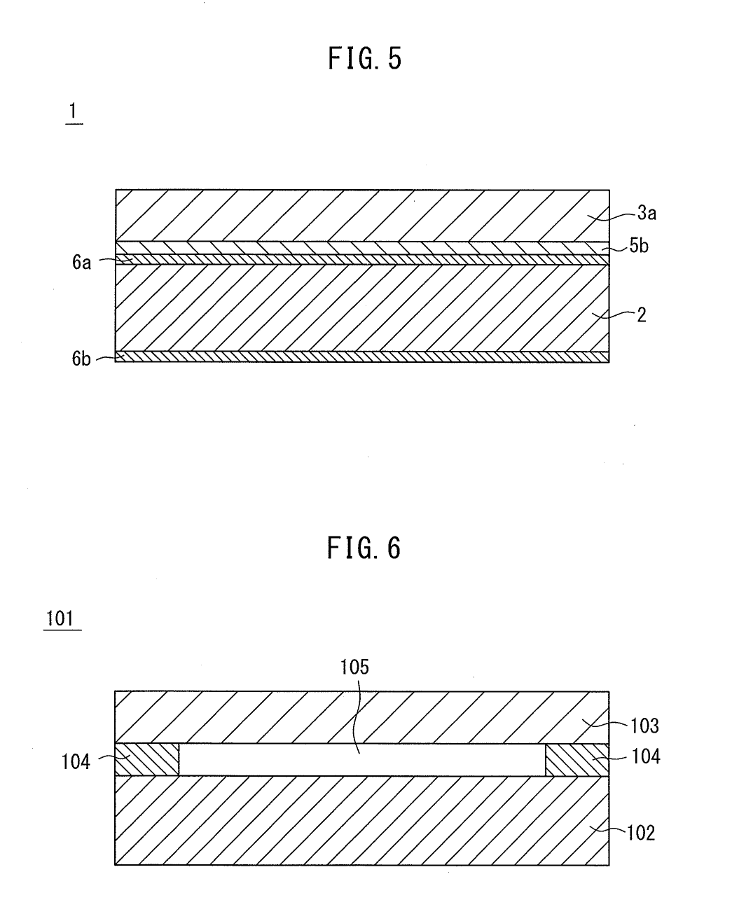

When a polymerization product of the invention (II) is used for a polymerization product (layer) (polymerization product (layer) 5b illustrated in FIG. 2 and FIG. 3) filled between a display unit and a touch panel in an Add-On (Out-Cell) type capacitive touch panel display device illustrated in FIG. 2 or FIG. 3 or a polymerization product (layer) (polymerization product (layer) 5b illustrated in FIG. 4 and FIG. 5) filled between a display unit and a touch sensor integrated protection unit in a cover glass-touch sensor integrated capacitive touch panel display device, preferably, the dielectric constant of the polymerization product of the invention (II) is low. Specifically, a polymerization product in which the dielectric constant of a polymerization product having a thickness of 2 mm under a condition of 23° C., a frequency of 1 MHz, and an applied voltage of 100 mV is 3.1 or lower is preferably used, and a polymerization product in which the dielectric constant of a polymerization product having a thickness of 2 mm under a condition of 23° C., a frequency of 1 MHz, and an applied voltage of 100 mV is 3.0 or lower is further preferably used.

The term “a polymerization product whose thickness is adjusted to 200 μm existing between two glass sheets” is a polymerization product obtained by interposing a sheet-shaped polymerization product having a thickness of 200 μm between two sheets of optical glass (manufactured by Corning Co., Ltd., trade name: EAGLE XG) or a polymerization product having a thickness of 200 μm obtained by interposing a polymerizable composition between two sheets of optical glass (manufactured by Corning Co., Ltd., trade name: EAGLE XG) each having a thickness of 0.7 mm and by allowing the polymerizable composition to be irradiated with a light to which a photopolymerization initiator is photosensitive through the optical glass using a low pressure mercury lamp, a medium pressure mercury lamp, a high pressure mercury lamp, an ultra-high pressure mercury lamp, a xenon lamp, a metal halide lamp, an electrodeless lamp, an LED, or the like as a light source, wherein a spacer, a gasket, sealing agent, or the like is not contained at all in a portion which is sandwiched by two sheets of glass outside the polymerization product layer.

Further, the term “the chromatic coordinate b* value in accordance with JIS Z 8729 after being stored in conditions at 95° C. for 500 hours” is the value of b* of the chromatic coordinates (psychometric chroma coordinates) of a polymerization product whose thickness is adjusted to 200 μm existing between two glass sheets measured by a method in accordance with JIS Z 8729 after being stored in an environment of 95° C. for 500 hours. It is noted that a reference used when the value of b* is measured is one sheet of optical glass (manufactured by Corning Co., Ltd., trade name: EAGLE XG) whose thickness is 0.7 mm. In the invention (II), the value of b* measured under the above-mentioned conditions needs to be smaller than 1.0. Further preferably the value is smaller than 0.9, and still further preferably the value is smaller than 0.8. When the value of b* measured under the above-mentioned conditions is 1.0 or larger, the transmittance of a light of 370 to 450 nm decreases over time, which is not preferred.

The refractive index of the polymerization product of the invention (II) at 25° C. is preferably from 1.48 to 1.52. When the refractive index at 25° C. is smaller than 1.48 or larger than 1.52, it is too smaller than the refractive index of an optical glass or an acrylic resin such as polymethyl methacrylate, and therefore, the refractive index difference at the interface between a display unit and a protection unit becomes large to some extent, thereby increasing scattering and attenuation of an image light from a display unit to some extent, which is not preferred.

The tensile elasticity of the polymerization product of the invention (II) at 23° C. is preferably 1×10⁷ Pa or lower, and further preferably from 1×10³ to 1×10⁶ Pa. When the tensile elasticity of the polymerization product at 23° C. is 1×10⁷ Pa or lower, generation of deformation on an image-display unit and a protection unit by the influence of a stress due to the volume shrinkage during polymerization of the polymerizable composition may be prevented, which is not preferred.

The tensile elasticity herein is a value which is obtained by conducting a test using a drawing speed of 500 mm/min.

Next, the invention (III) will be described.

The invention (III) is to an optical adhesive sheet having a polymerization product layer with a thickness of 10 to 500 μm, which is obtained by applying the composition of the invention (I), and by irradiating the polymerizable composition with a light to which a photopolymerization initiator is photosensitive to polymerize.

The optical adhesive sheet of the invention (III) may be a double-sided adhesive sheet whose both surfaces are an adhesive surface (the surface of the adhesive layer) or may be a single-sided adhesive sheet whose only one surface is an adhesive surface (the surface of the adhesive layer). Among others, from a viewpoint of bonding two members, the optical adhesive sheet is preferably a double-sided adhesive sheet. It is noted that the term “adhesive sheet” herein includes a tape-shaped one, i.e., “an adhesive tape”.

The optical adhesive sheet of the invention (III) may be a so-called “substrate-less type” optical adhesive sheet (hereinafter, also referred to as “substrate-less optical adhesive sheet”) which does not have a substrate (substrate layer) or may be an optical adhesive sheet which has a substrate. Examples of the above-mentioned substrate-less optical adhesive sheet include: a double-sided adhesive sheet composed only of a polymerization product layer composed of a polymerization product of the invention; and a double-sided adhesive sheet composed of a polymerization product layer composed of a polymerization product of the invention and an adhesive layer other than the polymerization product layer. The adhesive sheet which has a substrate is not restricted as long as it has on at least one surface of the substrate, a polymerization product layer composed of a polymerization product of the invention. Among others, from the viewpoint of thinning the optical adhesive sheet and improving optical physical properties such as transparency, the adhesive sheet is preferably a substrate-less optical adhesive sheet (substrate-less double-sided optical adhesive sheet), and more preferably a substrate-less double-sided optical adhesive sheet composed only of a polymerization product layer composed of a polymerization product of the invention. It is noted that the term “substrate (substrate layer)” does not include a separator (release liner) which is released when an adhesive sheet is used (stuck).

The thickness of a polymerization product layer of an optical adhesive sheet of the invention (III) is preferably 10 to 500 μm, more preferably 10 to 350 μm, and further preferably 10 to 300 μm. When the thickness of a polymerization product layer is larger than 500 μm, wrinkle may occur when the layer is rolled up at the time of coating, or the layer may be clouded due to humidification, which is not preferred. When the thickness of the polymerization product layer is smaller than 10 μm, a stress may not be dispersed because the polymerization product layer is thin, whereby peeling may be likely to occur.

The optical adhesive sheet of the invention (III) is used as a polymerization product layer which is interposed between an image-display unit and a light-transmitting protection unit of an image-display device. For example, when an optical adhesive sheet of the invention (III) is used for a polymerization product (layer) (polymerization product (layer) 5b illustrated in FIG. 2 and FIG. 3) filled between a display unit and a touch panel in an Add-On (Out-Cell) type capacitive touch panel display device illustrated in FIG. 2 or FIG. 3 or a polymerization product (layer) (polymerization product (layer) 5b illustrated in FIG. 4 and FIG. 5) filled between a display unit and a touch sensor integrated protection unit in a cover glass-touch sensor integrated capacitive touch panel display device, preferably, the dielectric constant of the optical adhesive sheet of the invention (III) is low. Specifically, an optical adhesive sheet in which the dielectric constant of the optical adhesive sheet having a thickness of 2 mm under a condition of 23° C., a frequency of 1 MHz, and an applied voltage of 100 mV is 3.1 or lower is preferably used, and an optical adhesive sheet in which the dielectric constant of the optical adhesive sheet having a thickness of 2 mm under a condition of 23° C., a frequency of 1 MHz, and an applied voltage of 100 mV is 3.0 or lower is further preferably used.

The chromatic coordinate b* value in accordance with JIS Z 8729 of the adhesive sheet whose thickness is adjusted to 200 μm existing between two glass sheets after being stored at 95° C. for 500 hours is smaller than 1.0.

The optical adhesive sheet of the invention (III) is obtained by allowing the polymerizable composition to be irradiated with a light to which a photopolymerization initiator is photosensitive using a low pressure mercury lamp, a medium pressure mercury lamp, a high pressure mercury lamp, an ultra-high pressure mercury lamp, a xenon lamp, a metal halide lamp, an electrodeless lamp, an LED, or the like as a light source.

In the invention (II), the value of b* measured under the above-mentioned conditions is preferably smaller than 1.0. Most preferably, the value is smaller than 0.9, and still further preferably the value is smaller than 0.8. When the value of b* measured under the above-mentioned conditions is 1.0 or larger, the transmittance of a light of 370 to 450 nm decreases over time, which is not preferred.

The refractive index of the optical adhesive sheet of the invention (III) at 25° C. is preferably from 1.48 to 1.52. When the refractive index at 25° C. is smaller than 1.48 or larger than 1.52, it is too smaller than the refractive index of an optical glass or an acrylic resin such as polymethyl methacrylate, and therefore, the refractive index difference at the interface between a display unit and a protection unit becomes large to some extent, thereby increasing scattering and attenuation of an image light from a display unit to some extent, which is not preferred.

### (Forming Method of Polymerization Product Layer of Optical Adhesive Sheet)

As a forming method of a polymerization product layer of an optical adhesive sheet of the invention (III), a known or commonly used forming method of a polymerization product layer can be used, and not particularly restricted. When a polymerization product layer of an optical adhesive sheet is formed by polymerizing a polymerizable composition having an acryloyl group like a polymerizable composition of the invention, examples of the forming method include the following methods (1) to (3).

(1) A polymerization product layer is formed by: applying (coating) a composition containing a polymerizable composition having an acryloyl group including a photopolymerization initiator and containing as needed an additive on a substrate or a separator (release liner); and allowing the composition to be irradiated with a light to which a photopolymerization initiator is photosensitive by using a light source such as a low pressure mercury lamp, a medium pressure mercury lamp, a high pressure mercury lamp, an ultra-high pressure mercury lamp, a xenon lamp, a metal halide lamp, an electrodeless lamp, or an LED to be polymerized.

(2) A polymerization product layer is formed by: applying (coating) a composition (solution) containing a polymerizable composition having an acryloyl group including a photopolymerization initiator further containing a solvent and containing as needed an additive on a substrate or a separator (release liner); drying; and allowing the composition to be irradiated with a light to which a photopolymerization initiator is photosensitive by using a light source such as a low pressure mercury lamp, a medium pressure mercury lamp, a high pressure mercury lamp, an ultra-high pressure mercury lamp, a xenon lamp, a metal halide lamp, an electrodeless lamp, or an LED to be polymerized.

(3) The polymerization product layer formed in the above-mentioned (1) is further dried.

It is noted that, for application (coating) in the above-mentioned forming method of a polymerization product layer, a known coating method can be used. A commonly used coater such as a gravure roll coater, a reverse roll coater, a kiss roll coater, a dip roll coater, a bar coater, a knife coater, a spray coater, a comma coater, or a direct coater can be used.

### (Substrate)

When the optical adhesive sheet of the invention (III) has a substrate, the substrate is not particularly restricted, and examples thereof include a variety of optical films such as a plastic film, an anti-reflection (AR) film, a polarizing plate, and a retardation plate. Examples of the above-mentioned plastic film or the like include plastic materials such as: a (poly)ester resin such as polyethylene terephthalate (PET); an acrylic resin such as polymethyl methacrylate (PMMA); (poly) carbonate; triacetylcellulose (TAC); polysulfone; polyarylate; polyimide; polyvinyl chloride; polyvinyl acetate; polyethylene; polypropylene; an ethylene-propylene copolymer; a cyclic olefin polymer such as trade name “ARTON (a cyclic olefin polymer; manufactured by JSR)” or trade name “ZEONOR (a cyclic olefin polymer; manufactured by ZEON CORPORATION)”. It is noted that these plastic materials may be used singly or two or more of these may be combined and used. The term “substrate” mentioned above is, when an optical adhesive sheet is used (stuck) for an adherent (an optical member or the like), a portion which is stuck to the adherent together with an adhesive layer. A separator (release liner) which is released when an adhesive sheet is used (stuck) is not included in the “substrate”.

Among the above, a transparent substrate is preferred as a substrate. The above-mentioned “transparent substrate” is preferably, for example, a substrate having an overall light transmittance (in accordance with JIS K7361) in the visible light wavelength region is 85% or higher, and is further preferably, a substrate having an overall light transmittance in the visible light wavelength region is 88% or higher. The haze (in accordance with JIS K7361) of the substrate is preferably 1.5% or lower, and more preferably 1.0% or lower. Examples of the above-mentioned transparent substrate include non-oriented films such as a PET film, trade name “ARTON”, and trade name “ZEONOR”.

The thickness of the above-mentioned substrate is not particularly restricted, and is preferably, for example, 12 to 75 μm. The above-mentioned substrate may have any form of a single layer and a plurality of layers. The surface of the substrate may be appropriately treated with a known or commonly used surface treatment such as: a physical treatment such as a corna discharging treatment or a plasma treatment; or a chemical treatment such as a undercoat treatment.

When an optical adhesive sheet of the invention (III) has a substrate, a variety of functional films may be used as the substrate. In this case, the adhesive sheet of the invention is an adhesive functional film having an adhesive layer of the invention on at least one side of the functional film. The above-mentioned functional film is not particularly restricted, and examples thereof include: a film having an optical functionality (polarizability, photorefractivity, light reflecting property, optical transparency, light absorption property, light diffraction property, optical rotation, visibility, or the like); a film (ITO film or the like) having an electric conductivity; a film having ultraviolet cutting properties; and a film having hard coat properties (scratch resistance). More specific examples thereof include a hard coat film (a plastic film such as a PET film at least one side of which is subjected to a hard coating treatment), a polarizing film, a wavelength plate, a phase difference film, an optical compensation film, a brightness improving film, a light guide plate, a reflection film, an anti-reflection film, a transparent conductive film (for example, an ITO film), a design film, a decorative film, a surface protection film, a prism, and a color filter. The above-mentioned terms “plate” and “film” each include a plate-shaped, film-shaped, or sheet-shaped form. For example, a “polarizing film” includes a “polarizing plate” and a “polarizing sheet”. The “functional film” includes a “functional plate” and a “functional sheet”.

### (Other Adhesive Layers)

When the optical adhesive sheet of the invention (III) has another adhesive layer, the other adhesive layer is not particularly restricted, and examples thereof include a known or commonly used adhesive layer formed by a known adhesive such as a urethane adhesive, an acrylic adhesive, a rubber-based adhesive, a silicone-based adhesive, a (poly)ester adhesive, a polyamide adhesive, an epoxy adhesive, a vinyl alkyl ether adhesive, and/or a fluorinated adhesive. The above-mentioned adhesives may be used singly, or two or more of these may be combined and used.

In the optical adhesive sheet of the invention (III), when the sheet does not include any of a substrate and other adhesive layers, a polymerization product layer obtained by polymerizing a polymerizable composition of the invention (I) is defined as an “adhesive layer”; when the sheet includes another adhesive layer, a layer formed by combining a polymerization product layer obtained by polymerizing a polymerizable composition of the invention (I) and the other adhesive layer is defined as an “adhesive layer”; when the sheet includes a substrate, a layer formed by combining a polymerization product layer obtained by polymerizing a polymerizable composition of the invention (I) and the substrate is defined as an “adhesive layer”; and when the sheet includes both another adhesive layer and a substrate, a layer formed by combining a polymerization product layer obtained by polymerizing a polymerizable composition of the invention (I), the other adhesive layer, and the substrate is defined as an “adhesive layer”.

### (Separator)

The surface of an adhesive layer (adhesive surface) of an optical adhesive sheet of the invention (III) may be protected by a separator (release liner) until its use. When the optical adhesive sheet of the invention is a double-sided adhesive sheet, each adhesive surface may be protected by two separators, or may be protected by one separator whose both sides are release surfaces in a form in which the sheet is wound in a roll shape. The separator is used as a protection material of an adhesive layer, and peeled off when the adhesive layer is stuck on an adherent. When the adhesive sheet of the invention is a substrate-less adhesive sheet, a separator also plays a role of a support of an adhesive layer. The separator may not be necessarily provided. Although not particularly restricted thereto, a commonly used release paper may be used for the above-mentioned separator, and a substrate having a release treatment layer, a low adhesive substrate of fluoropolymer, or a low adhesive substrate of nonpolar polymer can be used. Examples of a substrate having the above-mentioned release treatment layer include a plastic film or a paper which is subjected to a surface treatment by a release treatment agent which is silicone, long chain alkyl, fluorinated, molybdenum sulfide, or the like. Examples of fluorinated polymer in a low adhesive substrate composed of the above-mentioned fluoropolymer include polytetrafluoroethylene, polychlorotrifluoroethylene, polyvinyl fluoride, polyvinylidene fluoride, tetrafluoroethylene-hexafluoropropylene copolymer, and chlorofluoroethylene-vinylidene fluoride copolymer. Examples of the above-mentioned nonpolar polymer include olefin resins (for example, polyethylene and polypropylene). It is noted that the separator cna be formed by a known or commonly used method. The thickness or the like of the separator is also not particularly restricted.

Next, the invention (IV) will be described.

The invention (IV) is a manufacturing method of an image-display device comprising a base unit including an image-display unit, a light-transmitting protection unit, and a polymerization product layer interposed between the base unit and the protection unit, the method comprising: a process in which the polymerizable composition of the invention (I) is interposed between the base unit and the protection unit; and a process in which the polymerizable composition is irradiated with a light to which a photopolymerization initiator is photosensitive to form a polymerization product layer.

The term “between the base unit and the protection unit” means whole portion between a base unit having an image-display unit and a light-transmitting protection unit. For example, anywhere in 5a and 5b in FIG. 2 is included in the phrase “between the base unit and the protection unit”.

A preferred embodiment of the image-display device will be described more specifically with reference to the Drawings. In the Drawings, the same numeral represents the same or a similar component.

For example, FIG. 1, FIG. 2 and FIG. 4 are cross sections illustrating a main unit of one embodiment of an image-display device pertaining to the invention. As illustrated in FIG. 1, FIG. 2 and FIG. 4, the image-display device 1 of the present embodiment is connected to a driving circuit which is not illustrated, and comprises an image-display unit 2 which displays a predetermined image and a light-transmitting protection unit 3 disposed opposed to the image-display unit 2 adjacently with a predetermined distance.

An “image-display device” described herein is not particularly restricted as long as it is a device which displays an image, and a variety of devices are applicable. Examples thereof include a liquid crystal display device or an organic EL display device such as a cellular phone or a portable game device. The image-display unit 2 of the present embodiment is a liquid crystal display panel of such a liquid crystal display device.

In addition, when the image-display unit 2 is a liquid crystal display panel, polarizing plates 6a, 6b are provided on the surface thereof as illustrated in FIG. 2 or FIG. 4.

In a manufacturing method of the image-display device 1 of the present embodiment, for example, firstly, a spacer 4 and a jetty portion which is not illustrated are provided on a periphery portion of the image-display unit 2, and the polymerizable composition of the invention (I) is dropped onto a region inside them in a predetermined amount.

Next, a protection unit 3 is arranged on the spacer 4 of the image-display unit (liquid crystal display panel) 2, and a space between the display unit (liquid crystal display panel) 2 and the protection unit 3 is filled with the polymerizable composition of the invention (I) without a clearance.

Thereafter, the polymerizable composition of the invention (I) is irradiated with a light to which the component (4) which is an essential component of the polymerizable composition of the invention (I) is photosensitive via the protection unit 3 to polymerize the polymerizable composition of the invention (I), thereby obtaining an objective image-display device 1.

By using the image-display device 1, since the refractive indices of the polymerization product layer 5 and the protection unit 3 are similar, the brightness or the contrast can be increased, thereby improving the visibility.

Further, since an influence of a stress induced by the volume shrinkage during polymerization of the polymerizable composition onto the liquid crystal display panel 2 and protection unit 3 can be minimized, a deformation on the image-display unit (liquid crystal display panel) 2 and the protection unit 3 scarcely occurs. As the result, since a deformation is not generated on the image-display unit 2, an image with a high brightness and a high contrast without a display failure can be displayed.

When a polymerization product of the invention (II) is used for a polymerization product layer of FIG. 2 or FIG. 4, the dielectric constant of the polymerization product of polymerization product layer 5b is maintained low. Therefore, even if the thickness of the polymerization product layer is thin, malfunction of an image-display device can be prevented, thereby contributing to the thinness of the image-display device.

Next, the invention (V) will be described.

The invention (V) is a method of manufacturing an image-display device comprising a process in which a polymerization product layer is stuck between a base unit having an image-display unit and a light-transmitting protection unit by using an optical adhesive sheet, wherein the optical adhesive sheet is the optical adhesive sheet of the invention (III).

The term “a polymerization product layer is stuck between a base unit having an image-display unit and a light-transmitting protection unit by using an optical adhesive sheet” herein means that the expression is included in the expression “a polymerization product layer is stuck between a base unit having an image-display unit and a light-transmitting protection unit by using an optical adhesive sheet” wherever a polymerization product layer is stuck between a base unit having an image-display unit and a light-transmitting protection unit. This means, for example, that a case in which an adhesive sheet is used on any of 5a and 5b in FIG. 2 is included in the expression “a polymerization product layer is stuck between a base unit having an image-display unit and a light-transmitting protection unit by using an optical adhesive sheet”.

For the purpose of illustrating a process in which a base unit having an image-display unit and a light-transmitting protection unit are stuck by using an optical adhesive sheet, a manufacture process of a display device in FIG. 5 wherein a first substrate is a touch sensor integrated protection unit and a second substrate is a display unit provided with a polarizing plate will be explained as an example.

An image-display device can be manufactured by a method comprising: a process in which an optical adhesive sheet of the invention (III) is arranged adjacent to the touch sensor-mounted side of a touch sensor integrated protection unit that is a first substrate; a process in which the surface of a display unit provided with a polarizing plate that is a second substrate is arranged adjacent to the optical adhesive sheet of the invention (III); a process in which the optical adhesive sheet of the invention (III) is heated and/or pressurized to follow steps or protrusions; and as needed, a process in which the optical adhesive sheet of the invention (III) is irradiated with a light to which a photopolymerization initiator is photosensitive. These processes can be performed in a variety of orders.

For example, in a specific method, firstly, one side of the optical adhesive sheet of the invention (III) is arranged adjacent to the touch sensor-mounted side of the touch sensor integrated protection unit that is the first substrate, and then, the surface of the display unit provided with a polarizing plate that is the second substrate is arranged adjacent to the other side of the optical adhesive sheet of the invention (III). In other words, the optical adhesive sheet of the invention (III) is sandwiched between a touch sensor integrated protection unit (first substrate) and a display unit (second substrate) provided with a polarizing plate such that the surface on which there are steps or protrusions faces the optical adhesive sheet of the invention (III). Next, the optical adhesive sheet of the invention (III) is heated and/or pressurized, so that the adhesive sheet follows the steps or protrusions. Thereafter, as needed, the optical adhesive sheet of the invention (III) is irradiated with a light to which a photopolymerization initiator is photosensitive on the side of the touch sensor integrated protection unit (first substrate) and/or on the side of the display unit (second substrate) provided with a polarizing plate through the substrate(s). In this way, a touch sensor integrated protection unit (first substrate) and a display unit (second substrate) provided with a polarizing plate can be bonded together without forming a space in the vicinity of steps or protrusions of the touch sensor integrated protection unit (first substrate). In this embodiment, since the adhesive sheet is heated and/or pressurized after arranging a touch sensor integrated protection unit (first substrate) and a display unit (second substrate) provided with a polarizing plate adjacent to the optical adhesive sheet of the invention (III), when there are steps or protrusions on the surface of the display unit (second substrate) provided with a polarizing plate to be bonded (i.e., when the adhesive sheet is applied on a polarizing plate that is attached to an image display module), the adhesive sheet also follows steps or protrusions of a display unit (second substrate) provided with a polarizing plate, whereby the formation of a space also in the vicinity of these shapes can be prevented.

In the above-mentioned method, when a light to which a photopolymerization initiator is photosensitive is irradiated, at least one of the first substrate and the second substrate is at least partly transparent so that the optical adhesive sheet of the invention (IV) can be irradiated with a light to which a photopolymerization initiator is photosensitive through the substrate(s). In cases in which an ultraviolet does not pass through steps or protrusions of the first substrate, when an ultraviolet is irradiated on the first substrate side, a portion immediately below the steps or protrusions is not irradiated with an ultraviolet. However, due to migration of a radical generated at a portion which is irradiated with an ultraviolet or the like, polymerization of an adhesive sheet proceeds to some extent also at a portion which is not irradiated with an ultraviolet.

In another specific method, one side of the optical adhesive sheet of the invention (III) is arranged adjacent to the side of the surface of the touch sensor integrated protection unit (first substrate) on which there are steps or protrusions, and then, the adhesive sheet is heated and/or pressurized, so that the adhesive sheet follows the steps or protrusions. Thereafter, as needed, an open surface of the optical adhesive sheet of the invention (III) is irradiated with an ultraviolet to further polymerize the adhesive sheet, and then, a display unit (second substrate) provided with a polarizing plate is arranged adjacent to the other side of the adhesive sheet, whereby the second substrate is stuck to the adhesive sheet. When a release film is transparent, as needed, the adhesive sheet can be irradiated with an ultraviolet through the release film. In this example, since the whole surface of the adhesive sheet can be irradiated with a light to which a photopolymerization initiator is photosensitive, the adhesive sheet can be polymerized more uniformly. When the first substrate is at least partly transparent in order that it can be irradiated with a light to which a photopolymerization initiator is photosensitive that is needed for polymerization of the adhesive sheet, the adhesive sheet can be irradiated with an ultraviolet from the side of the first substrate. In this way, the first substrate and the second substrate cna be bonded together without forming a space in the vicinity of the steps or protrusions of the first substrate.

The above-mentioned heating process can be performed by using a convection oven, a hot plate, a heat laminator, an autoclave, or the like. In order that the adhesive sheet efficiently follows steps or protrusions by facilitating the flow of the adhesive sheet, heating and pressurization are preferably performed simultaneously by using a heat laminator, an autoclave, or the like. Pressurization using an autoclave is advantageous particularly for defoaming of the optical adhesive sheet. The heating temperature of the optical adhesive sheet of the invention may be a temperature at which the adhesive sheet softens or flows to follow steps or protrusions, and may be generally approximately 30° C. or higher, approximately 40° C. or higher, or approximately 60° C. or higher, and is approximately 150° C. or lower, approximately 120° C. or lower, or approximately 100° C. or lower. When the adhesive sheet is pressurized, the pressure to be applied is generally approximately 0.05 MPa or higher, or approximately 0.1 MPa or higher, and approximately 2 MPa or lower, or approximately 1 MPa or lower.

A process in which the above-mentioned light to which a photopolymerization initiator is photosensitive is irradiated which is performed as needed can be performed by using a general ultraviolet irradiation device such as a belt conveyor type ultraviolet irradiation device which uses as the light source a low pressure mercury lamp, a medium pressure mercury lamp, a high pressure mercury lamp, an ultra-high pressure mercury lamp, a xenon lamp, a metal halide lamp, an electrodeless lamp, or the like. The ultraviolet irradiation amount is generally approximately 1000 mJ/cm² to approximately 5000 mJ/cm².

Next, the invention (VI) will be described.

The invention (VI) is an image-display device manufactured by the method according to the invention (IV) or the invention (V).

When a main body of the image-display device of the invention (VI) is formed of an optical glass, the refractive index (n_{D}) thereof is generally from 1.49 to 1.52. In addition, there exists a tempered glass whose refractive index (n_{D}) is about 1.55.

The protection unit 3 is formed by a light-transmitting member in a shape of plate, sheet or film having approximately the same size as the image-display unit 2. For the light-transmitting member, an optical glass or plastics (for example, an acrylic resin such as polymethyl methacrylate) can be suitably employed. On the front surface or the back surface of the protection unit 3, an optical layer such as an anti-reflection film, a light-shielding film, or a viewing angle control film may be formed.

When the protection unit 3 is formed of an acrylic resin, generally, the refractive index (n_{D}) thereof is from 1.49 to 1.51.

The protection unit 3 is provided on the display unit 2 via a spacer 4 provided on the periphery portion of the image-display unit 2. The thickness of the spacer 4 is about from 0.05 to 1.5 mm, and the distance between the surfaces of the image-display unit 2 and the protection unit 3 is thus maintained about 1 mm.

In order to improve the brightness and contrast, a light-shielding portion having a frame shape which is not illustrated is provided on the periphery portion of the protection unit 3.

First, an image-display device manufactured by a method of manufacturing an image-display device of the invention (IV) will be described in detail.

A polymerization product layer 5a, 5b is interposed between the image-display unit 2 and the protection unit 3. In a case of an image-display device manufactured by a method of manufacturing the image-display device of the invention (IV), since the polymerization product of the invention (II) is interposed in the polymerization product layer 5a or polymerization product layer 5b, the transmittance in the visible light region is 90% or higher. The thickness of the polymerization product layer 5a or polymerization product layer 5b is preferably from 10 to 500 μm. Further preferably the thickness is 10 to 350 μm, and particularly preferably, 10 to 300 μm.

In addition, since the polymerization product of the invention (II) is interposed in the polymerization product layer 5a or polymerization product layer 5b, the refractive index (n_{D}) at 25° C. is from 1.45 to 1.55, preferably 1.48 to 1.52, and therefore, the refractive index is approximately the same as the refractive index of the image-display unit 2 or the protection unit 3, which is preferred. The brightness or contrast of an image light from the image-display unit 2 is thus improved, thereby improving the visibility.

When an image-display device is manufactured by a method of manufacturing the image-display device of the invention (IV), since the polymerization product of the invention (II) is interposed in the polymerization product layer 5a or polymerization product layer 5b, the tensile elasticity at 23° C. is 1×10⁷ Pa or lower, preferably from 1×10³ to 1×10⁶ Pa. Accordingly, generation of a deformation due to an influence of a stress caused by the volume shrinkage during polymerization of the polymerizable composition can be prevented.

When an image-display device is manufactured by a method of manufacturing the image-display device of the invention (IV), since the polymerization product of the invention (II) is interposed in the polymerization product layer 5a or polymerization product layer 5b, the volume shrinkage rate during polymerization of the polymerizable composition is 4.0% or lower, preferably 3.5% or lower, and further preferably 2.7% or lower. By this, the internal stress accumulated in a polymerization product layer during polymerization of the polymerizable composition can be reduced, thereby preventing generation of a deformation at the interface between the polymerization product layer 5a and a touch panel 7 or the protection unit 3. Consequently, when a polymerizable composition is interposed between the touch panel 7 and the protection unit 3, between the touch panel 7 and the image-display unit 2, or between the image-display unit 2 and the protection unit 3, and the polymerizable composition is polymerized, scattering of light generated at the interface between the polymerization product layer 5 and the image-display unit 2, the protection unit 3, or the touch panel 7 can be reduced, and the brightness of an image displayed can be increased, and at the same time, the visibility can be improved.

When the polymerization product of the invention (I) is used for the polymerization product layer 5b, since the dielectric constants of these polymerization products are low, the thickness of the polymerization product layer 5b can be made thin.

Next, an image-display device manufactured by a method of manufacturing an image-display device of the invention (V) will be described in detail.

A polymerization product layer 5a, 5b is interposed between the image-display unit 2 and the protection unit 3. In a case of an image-display device manufactured by a method of manufacturing the image-display device of the invention (V), since the optical adhesive sheet of the invention (III) is interposed in the polymerization product layer 5a or 5b polymerization product layer, the transmittance in the visible light region is 90% or higher. Here, the thickness of the polymerization product layer 5a or polymerization product layer 5b is preferably from 10 to 500 μm. Further preferably the thickness is 10 to 350 μm, and particularly preferably, 10 to 300 μm.

In addition, since the optical adhesive sheet of the invention (III) is interposed in the polymerization product layer 5a or polymerization product layer 5b, the refractive index (n_{D}) at 25° C. is from 1.45 to 1.55, preferably 1.48 to 1.52, and therefore, the refractive index is approximately the same as the refractive index of the image-display unit 2 or the protection unit 3, which is preferred. The brightness or contrast of an image light from the image-display unit 2 is thus improved, thereby improving the visibility.

When an image-display device is manufactured by a method of manufacturing the image-display device of the invention (V), since the optical adhesive sheet of the invention (III) is interposed in the polymerization product layer 5a or polymerization product layer 5b, the adhesive sheet also follows steps or protrusions of the image-display unit or protection unit, whereby the formation of a space also in the vicinity of these shapes can be prevented.

Since the optical adhesive sheet of the invention (III) has flexibility, even when the protection unit 3, the image-display unit 2, or the touch panel 7 has an uneven shape or even when an display surface of the image display unit is further provided with a layer having an uneven surface shape (for example, a polarizing plate), the internal residual stress of the sheet itself is relaxed, thereby preventing display irregularity on the image-display device. For example, in the case of a display device in FIG. 4, since the optical adhesive sheet has a sufficient adhesive force and hydrophilicity, an air bubble or peeling is not generated at the interface between a display surface (for example, polarizing plate) of the image-display unit 2 and the optical adhesive sheet (i.e., polymerization product layer 5b) and the interface between the optical adhesive sheet (i.e., polymerization product layer 5b) and the touch sensor integrated protection unit 3a, and whitening does not occur.

For an optical glass plate to be used for the image-display device of the invention (VI), a glass plate which clamps a liquid crystal of a liquid crystal cell or one which is used as a protection plate of a liquid crystal cell is preferably used. As an acrylic resin plate to be used, the one which is used as a protection plate of a liquid crystal cell can be preferably used. The average surface roughness of the optical glass plate or the acrylic resin plate is usually 1.0 nm or smaller.

Since a space between the image-display unit 2 and the protection unit 3 is filled with a polymerization product of the invention (I) or the polymerization product layer 5 using an optical adhesive sheet of the invention (III), the image-display device of the invention (VI) has a large impact resistance.

In addition, the image-display device can be formed into a thinner shape than a conventional example in which a space has been provided between the image-display unit 2 and the protection unit 3.

The image-display device of the invention (VI) can take a variety of modes. For example, as illustrated in FIG. 3 or FIG. 3, the image-display device 1 may be manufactured by omitting a spacer 4. In the case of the polymerization product layer 5b in FIG. 5, for example, the photopolymerizable composition of the invention (I) is applied on a polarizing plate 6a of the image-display unit 2, the touch panel 7 is placed thereon, and then, photopolymerization is performed in a similar manner to the above, or for example, a laminate composed of a protection unit 3, a polymerization product layer 5a, a touch panel 7 and a polymerization product layer 5b (i.e., optical adhesive sheet 5b) is stuck to the display surface (i.e., the surface of the polarizing plate 6a) of the image-display unit 2, thereby obtaining the image-display device.

In the case of the polymerization product layer 5b in FIG. 5, for example, the photopolymerizable composition of the invention (I) is applied on a polarizing plate 6a of the image-display unit 2, the touch sensor integrated protection unit 3a is placed thereon, and then, photopolymerization is performed in a similar manner to the above, or for example, a laminate composed of the touch sensor integrated protection unit 3a and a polymerization product layer 5b (i.e., optical adhesive sheet 5b) is stuck to the display surface (i.e., the surface of the polarizing plate 6a) of the image-display unit 2, thereby obtaining the image-display device.

Further, the present invention can be applied not only to the above-mentioned liquid crystal display device, but also to a variety of panel displays such as an organic EL and a plasma display device.

### EXAMPLES

In the following, the present invention will be described more concretely by way of Examples, but should not be limited thereto.

### <Measurement of Viscosity>

The viscosity was measured according to the following method.

Using 1 mL of sample, and using a Cone/Plate type viscometer (manufactured by Brookfield, model: DV-II+Pro, spindle model: CPE-42), a value of the viscosity when it became constant at a temperature of 25.0° C., at a number of revolutions of 10 rpm was measured.

### <Number-Average Molecular Weight>

The number-average molecular weight is a value in terms of polystyrene measured by GPC under the conditions below.

device name: manufactured by JASCO Corporation, HPLC unit, HSS-2000

column: Shodex column LF-804

mobile phase: tetrahydrofurane

flow rate: 1.0 mL/min

detector: manufactured by JASCO Corporation, RI-2031Plus

temperature: 40.0° C.

amount of sample: Sample Loop 100 μL

sample concentration: prepared at about 0.5 wt %

### Synthesis Example 1

Into a 300 mL separable flask provided with a condensor, a dropping funnel, a thermometer, and a stirrer, 180 g of polybutadiene polyol (manufactured by Nippon Soda Co., Ltd., trade name: NISSO-PB G-2000, hydroxyl group value 47.3 mgKOH/g), 1.17 g of pentaerythritol tetrakis[3-(3,5-di-tert-butyl-4-hydroxyphenyl)propionate] (manufactured by BASF, trade name: IRGANOX1010), and 20 mg of dioctyltin dilaurate were input, and the internal temperature was elevated to 50° C. by using an oil bath. Thereafter, 22.86 g of 2-isocyanatoethyl methacrylate (trade name; KarenzMOI, manufactured by Showa Denko K.K.) was dropped from the dropping funnel over 15 minutes. During dropping, the internal temperature was maintained at 70° C. or lower. After the completion of dropping, stirring was continued while maintaining the internal temperature at 70±2° C. When it was confirmed by IR that there was no absorption regarding C═O stretching vibration of an isocyanato group, the reaction was completed by stopping stirring to obtain a (meth)acryloyl group-containing compound 1 having a polyolefin structural unit containing a urethane group.

### Synthesis Example 2

Into a 1-L four-necked flask provided with a stirrer and a distillator, 540 g of polybutadiene polyol (manufactured by Nippon Soda Co., Ltd., trade name: NISSO-PB G-3000, hydroxyl group value 29.5 mgKOH/g), 101 g of n-butyl acrylate, 0.81 g of dioctyltin dilaurate, and 3.51 g of pentaerythritol tetrakis[3-(3,5-di-tert-butyl-4-hydroxyphenyl)propionate] (manufactured by BASF, trade name: IRGANOX1010) were input, the mixture was heated under an air flow at 130° C., and a generated mixed liquid of n-butanol and n-butyl acrylate was gradually evaporated off a reaction system over approximately 10 hours while refluxing. After n-butanol and n-butyl acrylate did not generated, the pressure inside the system was reduced to 10 kPa by using a vacuum pump, and again, n-butanol and n-butyl acrylate were decreased to be evaporated outside the system. After maintaining the pressure at 50 Pa for 1.5 hours, the reactor was cooled to obtain a (meth)acryloyl group-containing compound 2 having a polyolefin structural unit.

### Synthesis Example 3

Into a 100 mL reaction vessel provided with a stirrer, a thermometer, a dropping funnel, and a condensor, 23.93 g of mixture of 2,2,4-trimethyl hexamethylene diisocyanate and 2,4,4-trimethyl hexamethylene diisocyanate (trade name: VESTANAT® TMDI, manufactured by Evonik Degussa Corporation), 11 mg of dioctyltin dilaurate, and 5.74 g of pentaerythritol tetrakis[3-(3,5-di-tert-butyl-4-hydroxyphenyl)propionate] (manufactured by BASF, trade name: IRGANOX 1010) were input, and 16.41 g of 4-hydroxyl butyl acrylate was input by dropping using the dropping funnel. During dropping, the temperature in the reaction vessel was maintained at 70° C. or lower. After the completion of dropping, stirring was continued for two hours while maintaining the temperature in the reactor at 65 to 70° C. to obtain a reaction product (hereinafter, referred to as “reaction product α”).

Into a 300 mL reaction vessel provided with a stirrer, a thermometer, and a condensor, 150 g of polyisoprene polyol (manufactured by Idemitsu Kosan Co., Ltd. trade name: Poly ip, hydroxyl group value 47.3 mgKOH/g) and 12 mg of dioctyltin dilaurate were input, and stirring was started. Thereafter, 46.1 g of a reaction product α whose temperature was maintained at 60° C. was divided into several amounts and input into the reaction vessel. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. As the result of the analysis with liquid chromatography, it was confirmed that there was 3% by mass of a reaction product of 4-hydroxybutyl acrylate: VESTANAT® TMDI=2:1 (mole ratio) (i.e., a mixture of the following Formula (10) and (11)) in the product. The reaction product of 4-hydroxybutyl acrylate: VESTANAT® TMDI=2:1 (mole ratio) was designated urethane acrylate monomer α. One which was obtained by removing the urethane acrylate monomer α from the reaction product was designated “a (meth)acryloyl group-containing compound 3 having a polyolefin structural unit containing a urethan group”.

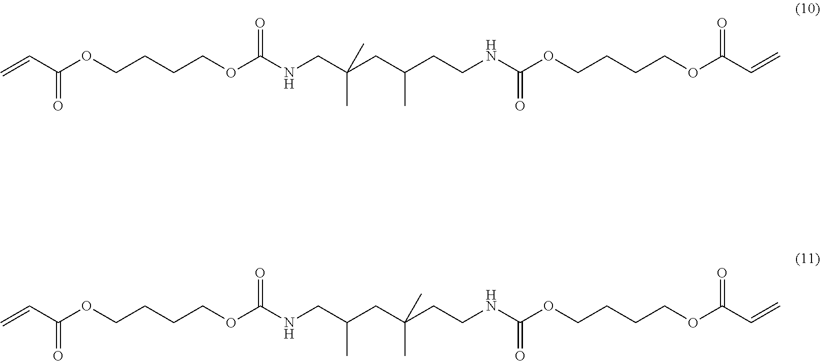

### Synthesis Example 4

Into a 300 mL separable flask provided with a condensor, a dropping funnel, a thermometer, and a stirrer, 180 g of hydrogenated polybutadiene polyol (manufactured by Nippon Soda Co., Ltd., trade name: NISSO-PB GI-2000, hydroxyl group value 47.3 mgKOH/g), 1.17 g of pentaerythritol tetrakis[3-(3,5-di-tert-butyl-4-hydroxyphenyl)propionate] (manufactured by BASF, trade name: IRGANOX1010), and 20 mg of dioctyltin dilaurate were input, and the internal temperature was elevated to 50° C. by using an oil bath. Thereafter, 22.86 g of 2-isocyanatoethyl methacrylate (trade name; KarenzMOI, manufactured by Showa Denko K.K.) was dropped from the dropping funnel over 15 minutes. During dropping, the internal temperature was maintained at 70° C. or lower. After the completion of dropping, stirring was continued while maintaining the internal temperature at 70±2° C. When it was confirmed by IR that there was no absorption regarding C═O stretching vibration of an isocyanato group, the reaction was completed by stopping stirring to obtain a (meth)acryloyl group-containing compound 4 having a hydrogenated polyolefin structural unit containing a urethane group.

### Synthesis Example 5

Into a 1-L four-necked flask provided with a stirrer and a distillator, 540 g of hydrogenated polybutadiene polyol (manufactured by Nippon Soda Co., Ltd., trade name: NISSO-PB GI-3000, hydroxyl group value 29.5 mgKOH/g), 101 g of n-butyl acrylate, 0.81 g of dioctyltin dilaurate, and 3.51 g of pentaerythritol tetrakis[3-(3,5-di-tert-butyl-4-hydroxyphenyl)propionate] (manufactured by BASF, trade name: IRGANOX1010) were input, the mixture was heated under an air flow at 130° C., and a generated mixed liquid of n-butanol and n-butyl acrylate was gradually evaporated off a reaction system over approximately 10 hours while refluxing. After n-butanol and n-butyl acrylate did not generated, the pressure inside the system was reduced to 10 kPa by using a vacuum pump, and again, n-butanol and n-butyl acrylate were decreased to be evaporated outside the system. After maintaining the pressure at 50 Pa for 1.5 hours, the reactor was cooled to obtain a (meth)acryloyl group-containing compound 5 having a hydrogenated polyolefin structural unit.

### Synthesis Example 6

Into a 100 mL reaction vessel provided with a stirrer, a thermometer, a dropping funnel, and a condensor, 23.93 g of mixture of 2,2,4-trimethyl hexamethylene diisocyanate and 2,4,4-trimethyl hexamethylene diisocyanate (trade name: VESTANAT® TMDI, manufactured by Evonik Degussa Corporation), 11 mg of dioctyltin dilaurate, and 5.74 g of pentaerythritol tetrakis[3-(3,5-di-tert-butyl-4-hydroxyphenyl)propionate] (manufactured by BASF, trade name: IRGANOX 1010) were input, and 16.41 g of 4-hydroxyl butyl acrylate was input by dropping using the dropping funnel. During dropping, the temperature in the reaction vessel was maintained at 70° C. or lower. After the completion of dropping, stirring was continued for two hours while maintaining the temperature in the reactor at 65 to 70° C. to obtain a reaction product.

Into a 300 mL reaction vessel provided with a stirrer, a thermometer, and a condensor, 150 g of hydrogenated polyisoprene polyol (manufactured by Idemitsu Kosan Co., Ltd. trade name: Epol, hydroxyl group value 47.3 mgKOH/g) and 12 mg of dioctyltin dilaurate were input, and stirring was started. Thereafter, 46.1 g of a reaction product α whose temperature was maintained at 60° C. was divided into several amounts and input into the reaction vessel. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. As the result of the analysis with liquid chromatography, it was confirmed that, in a similar manner to Synthesis Example 3, there was 3% by mass of a reaction product of 4-hydroxybutyl acrylate: VESTANAT® TMDI=2:1 (mole ratio) (i.e., a mixture of the above-mentioned Formula (I) and (II)) in the product. The reaction product of 4-hydroxybutyl acrylate: VESTANAT® TMDI=2:1 (mole ratio) was designated urethane acrylate monomer α. One which was obtained by removing the urethane acrylate monomer α from the reaction product was designated “a (meth)acryloyl group-containing compound 6 having a hydrogenated polyolefin structural unit containing a urethan group”.

### Synthesis Example 7

Into a reaction vessel provided with a stirrer and a water separator, 270.0 g of Sovermol® 908 (hydrogenated dimer diol manufactured by BASF, hydrogenated dimer diol purity 97.5% by mass), 171.0 g of EMPOL® 1008 (hydrogenated dimer acid manufactured by BASF, hydrogenated dimer acid purity 92.0%) and 100 mg of dioctyltin dilaurate were charged, and then, the mixture was subjected to dehydration esterification starting from approximately 240° C. under a normal pressure while allowing condensed water to flow out under a reduced pressure to obtain a mixture of polyester polyol and hydrogenated dimer diol (hereinafter, referred to as “polyester polyol A”) having a hydroxyl group value of 59 mgKOH/g and a number-average molecular weight of 2000 and containing 15% by mass of hydrogenated dimer diol.

### Synthesis Example 8

Into a 100 mL reaction vessel provided with a stirrer, a thermometer, a dropping funnel, and a condensor, 21.89 g of mixture of 2,2,4-trimethyl hexamethylene diisocyanate and 2,4,4-trimethyl hexamethylene diisocyanate (trade name: VESTANAT® TMDI, manufactured by Evonik Degussa Corporation), 12 mg of dioctyltin dilaurate, and 5.74 g of pentaerythritol tetrakis[3-(3,5-di-tert-butyl-4-hydroxyphenyl)propionate] (manufactured by BASF, trade name: IRGANOX 1010) were input, and 15.16 g of 4-hydroxyl butyl acrylate was input by dropping using the dropping funnel. During dropping, the temperature in the reaction vessel was maintained at 70° C. or lower. After the completion of dropping, stirring was continued for two hours while maintaining the temperature in the reactor at 65 to 70° C. to obtain a reaction product (hereinafter, referred to as “reaction product α”).

Into a 300 mL reaction vessel provided with a stirrer, a thermometer, and a condensor, 180 g of the above-mentioned (poly)ester polyol A, and 12 mg of dioctyltin dilaurate were input, and stirring was started. Thereafter, 33.7 g of a reaction product α whose temperature was maintained at 60° C. was divided into several amounts and input into the reaction vessel. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. As the result of the analysis with liquid chromatography, it was confirmed that, in a similar manner to Synthesis Example 3, there was 3% by mass of a reaction product α of 4-hydroxybutyl acrylate: VESTANAT® TMDI=2:1 (mole ratio) in the product. One which was obtained by removing the urethane acrylate monomer α from the reaction product was designated “a (meth)acryloyl group-containing compound 7 having a polyester structural unit containing a urethan group”.

### Synthesis Example 9

To a 300 mL reaction vessel provided with a stirrer, a thermometer, a dropping funnel, and a condensor, 180.0 g of the above-mentioned (poly)ester polyol A, 5.74 g of pentaerythritol tetrakis[3-(3,5-di-tert-butyl-4-hydroxyphenyl)propionate] (manufactured by BASF, trade name: IRGANOX 1010), and 20 mg of dioctyltin dilaurate were input, and stirring was started. Thereafter, 13.4 g of 2-isocyanatoethyl acrylate (trade name: Karenz® AOI, manufactured by Showa Denko K.K.) was input by dropping. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. The manufactured urethane acrylate was designated “a (meth)acryloyl group-containing compound 8 having a polyester structural unit”.

### Synthesis Example 10

Into a 500 mL reaction vessel provided with a stirrer and a distillator capable of recirculation, 366.6 g of Pripol® 2033 (manufactured by Croda Japan KK, hydrogenated dimer diol, hydroxyl group value 202 mg KOH/g), 54.3 g of diethyl carbonate (manufactured by Tokyo Chemical Industry Co., Ltd.), 0.2 g of titanium tetrabutoxide, 0.12 g of dioctyltin oxide (trade name: DOTO, manufactured by HOKKO CHEMICAL INDUSTRY CO., LTD.) were charged, and the temperature was elevated to 130° C. by using an oil bath, and then, the temperature was elevated 180° C. in accordance with the proceed of the reaction. Transesterification was performed starting at a normal pressure and reducing the pressure while distilling ethanol. In addition, the amount of diethyl carbonate (manufactured by Tokyo Chemical Industry Co., Ltd.) which was distilled together with ethanol during distilling ethanol was confirmed by gas chromatography, and the distillated amount of diethyl carbonate was added. The total amount of distillated ethanol was 29.5 g. A (poly) carbonate polyol whose hydroxyl group value was 57.3 mg KOH/g (hereinafter, referred to as “(poly)carbonate polyol A”) was obtained.

### Synthesis Example 11

Into a 300 mL reaction vessel provided with a stirrer, a thermometer, a dropping funnel and a condensor, the above-mentioned 177.8 g of (poly)carbonate polyol A, 2.2 g of Pripol® 2033 (manufactured by Croda Japan KK, hydrogenated dimer diol, hydroxyl group value 202 mg KOH/g), 5.74 g of pentaerythritol tetrakis[3-(3,5-di-tert-butyl-4-hydroxyphenyl)propionate] (manufactured by BASF, trade name: IRGANOX 1010), and 20 mg of dioctyltin dilaurate were input, and stirring was started. Thereafter, 14.7 g of 2-isocyanatoethyl methacrylate (trade name: Karenz® MOI, manufactured by Showa Denko K.K.) was input by dropping. During this operation, the temperature in the reactor was kept at not higher than 70° C. Thereafter, the temperature in the reactor was maintained at from 65 to 70° C., and stirring was continued. When it was confirmed by IR that there was no absorption regarding C═O stretching vibration of an isocyanato group, the reaction was completed. The manufactured urethane methacrylate was designated “(meth)acryloyl group-containing compound 9 having a polycarbonate structural unit”.

### Synthesis Example 12

Into a 100 mL reaction vessel provided with a stirrer, a thermometer, a dropping funnel, and a condensor, 21.89 g of mixture of 2,2,4-trimethyl hexamethylene diisocyanate and 2,4,4-trimethyl hexamethylene diisocyanate (trade name: VESTANAT® TMDI, manufactured by Evonik Degussa Corporation), 12 mg of dioctyltin dilaurate, and 5.74 g of pentaerythritol tetrakis[3-(3,5-di-tert-butyl-4-hydroxyphenyl)propionate] (manufactured by BASF, trade name: IRGANOX 1010) were input, and 15.16 g of 4-hydroxyl butyl acrylate was input by dropping using the dropping funnel. During dropping, the temperature in the reaction vessel was maintained at 70° C. or lower. After the completion of dropping, stirring was continued for two hours while maintaining the temperature in the reactor at 65 to 70° C. to obtain a reaction product (hereinafter, referred to as “reaction product α”).

Into a 300 mL reaction vessel provided with a stirrer, a thermometer, and a condensor, 178.9 g of (poly)carbonate polyol A, 1.1 g of Pripol® 2033 (hydrogenated dimer diol manufactured by Croda Japan K.K., hydroxyl group value 202 mgKOH/g), and 12 mg of dioctyltin dilaurate were input, and stirring was started. Thereafter, the temperature in the reactor was maintained at from 65 to 70° C., and stirring was continued. When it was confirmed by IR that there was no absorption regarding C═O stretching vibration of an isocyanato group, the reaction was completed. As the result of the analysis with liquid chromatography, it was confirmed that, in a similar manner to Synthesis Example 3, there was 3% by mass of a reaction product α of 4-hydroxybutyl acrylate: VESTANAT® TMDI=2:1 (mole ratio) in the product. One which was obtained by removing the urethane acrylate monomer α from the reaction product was designated “a (meth)acryloyl group-containing compound 10 having a polycarbonate structural unit containing a urethan group”.

### Blending Example 1

60.0 parts by mass of a (meth)acryloyl group-containing compound 1 having a polyolefin structural unit, 20.0 parts by mass of isostearyl acrylate (manufactured by Osaka Organic Chemical Industry Ltd., trade name: ISTA), 20.0 parts by mass of a hydrogenated dimer diol (manufactured by Croda Japan K.K., trade name: Pripol 2033), 0.8 parts by mass of 1-hydroxycyclohexyl phenyl ketone (manufactured by BASF, trade name: Irgacure 184), and 0.4 parts by mass of 2,4,6-trimethylbenzoyl diphenylphosphine oxide (manufactured by Lambson, trade name: SpeedCure TPO) were mixed by using Planetary and Centrifugal Mixer (manufactured by THINKY CORPORATION, trade name: Awatori-rentaro ARE-310). This blend was designated polymerizable composition A1. The viscosity of the polymerizable composition A1 at 25° C. was 5700 mPa·s.

### Blending Examples 2 to 11 and Comparative Blending Example 1 and 2

In a similar manner to Blending Example 1, blending was performed in accordance with the blend compositions listed on Table 1. The blends prepared in Blending Examples 2 to 11 were designated polymerizable compositions A2 to A11, respectively. The blends prepared in Comparative Blending Example 1 and Comparative Blending Example 2 were designated polymerizable composition B1 and polymerizable composition B2, respectively.

TABLE 1

| | Blending | Blending | Blending | Blending | Blending | Blending | Blending |
|---|---|---|---|---|---|---|---|
| | Example 1 | Example 2 | Example 3 | Example 4 | Example 5 | Example 6 | Example 7 |
| Name of polymerizable | polymeri- | polymeri- | polymeri- | polymeri- | polymeri- | polymeri- | polymeri- |
| composition used | zable | zable | zable | zable | zable | zable | zable |
| | composi- | composi- | composi- | composi- | composi- | composi- | composi- |
| | tion A1 | tion A2 | tion A3 | tion A4 | tion A5 | tion A6 | tion A7 |
| (Meth)acryloyl group-containing | 50.0 | | | | | | |
| compound having a polyolefin structural | | | | | | | |
| unit 1 | | | | | | | |
| (Meth)acryloyl group-containing compound | | 50.0 | | | | | |
| having a polyolefin structural unit 2 | | | | | | | |
| (Meth)acryloyl group-containing compound | | | 29.1 | | | | |
| having a polyolefin structural unit 3 | | | | | | | |
| (Meth)acryloyl group-containing compound | | | | | 20.0 | | |
| having a hydrogenated polyolefin | | | | | | | |
| structural unit 4 | | | | | | | |
| (Meth)acryloyl group-containing compound | | | | | | 25.0 | |
| having a hydrogenated polyolefin | | | | | | | |
| structural unit 5 | | | | | | | |
| (Meth)acryloyl group-containing compound | | | | | | | |
| having a hydrogenated polyolefin | | | | | | | |
| structural unit 6 | | | | | | | |
| (Meth)acryloyl group-containing compound | | | | 35.9 | | | |
| having a polyester structural unit 7 | | | | | | | |
| (Meth)acryloyl group-containing compound | | | | | | | |
| having a polyester structural unit 8 | | | | | | | |
| (Meth)acryloyl group-containing compound | | | | | | | 34.0 |
| having a polycarbonate structural unit 9 | | | | | | | |
| (Meth)acryloyl group-containing compound | | | | | | | |
| having a polycarbonate structural unit 10 | | | | | | | |
| Urethane acrylate SHIKOH UV-3000B*¹ | | | | | | | |
| Claprene ® UC-203*² | | | | | | | |
| Urethane acrylate monomer α | | | 0.9 | 1.1 | | | 1.1 |
| Isobornyl acrylate *³ | | | | 9.0 | | | |
| Dicyclopentenyl oxylethyl methacrylate*⁴ | | | | | | | 18.0 |
| Lauryl acrylate *⁵ | | 15.0 | 8.5 | 9.0 | | 14.5 | |
| Isostearyl acrylate *⁶ | 20.0 | | 8.5 | | 15.0 | | |
| 2-hydroxypropyl methacrylate *⁷ | | | | | | 3.5 | |
| 4-hydroxyl butyl acrylate *⁸ | | | | | | | 3.0 |
| 2-hydroxy butyl methacrylate *⁹ | | | | 3.0 | 3.0 | | |
| Hydrogenated terpene resin | | | 11.0 | | 14.0 | | |
| Clearon ®p85*¹⁰ | | | | | | | |
| Hydrogenated terpene resin | | | 11.0 | 20.0 | 14.0 | 24.0 | |
| Clearon ®k100*¹¹ | | | | | | | |
| Hydrogenated terpene resin | | | | | | | 22.0 |
| Clearon ®m105*¹² | | | | | | | |
| Hydrogenated polybutadiene polyol | 20.0 | 20.0 | 20.0 | | 10.0 | 17.0 | |
| Nisso-pb gi-1000*¹³ | | | | | | | |
| Hydrogenated polyisoprene polyol | | | | 15.0 | | | 13.0 |
| Epol *¹⁴ | | | | | | | |
| Hydrogenated dimer diol | 10.0 | | | | 6.0 | | |
| Pripol2033*¹⁵ | | | | | | | |
| Hydrogenated polybutadiene | | | | | 7.0 | 0.0 | |
| Nisso-pb bi-2000*¹⁶ | | | | | | | |
| Poly(α-olefin)liquid substance | | 10.0 | 5.0 | 7.0 | 5.0 | 10.0 | |
| Spectrasyn40*¹⁷ | | | | | | | |
| Ethylene-α-olefin copolymer liquid | | | | | | | 8.0 |
| substance HC-40*¹⁸ | | | | | | | |
| Liquid polybutene HV-35*¹⁹ | | 5.0 | | | | 5.0 | |
| Liquid polybutadiene POLYVEST 110*²⁰ | | | 5.0 | | 5.0 | | |
| Irganox1010*²¹ | | | | | 1.0 | 1.0 | 1.0 |
| Photopolymerization initiator speedcure | 0.4 | 0.4 | 0.4 | 0.4 | 1.0 | 1.0 | 1.0 |
| TPO*²² | | | | | | | |
| Photopolymerization initiator IRGACURE | 0.8 | 0.8 | 0.8 | 0.8 | | | |
| 184*²³ | | | | | | | |
| Viscosity of polymerizable composition | 5700 mPa · s | 4400 mPa · s | 5200 mPa · s | 4400 mPa · s | 4700 mPa · s | 3900 mPa · s | 4900 mPa · s |
| (25° C.) | | | | | | | |

| | | | | | Comparative | Comparative |
|---|---|---|---|---|---|---|
| | Blending | Blending | Blending | Blending | Blending | Blending |
| | Example 8 | Example 9 | Example 10 | Example 11 | Example 1 | Example 2 |
| Name of polymerizable | polymeri- | polymeri- | polymeri- | polymeri- | polymeri- | polymeri- |
| composition used | zable | zable | zable | zable | zable | zable |
| | composi- | composi- | composi- | composi- | composi- | composi- |
| | tion A8 | tion A9 | tion A10 | tion A11 | tion AB1 | tion B2 |
| (Meth)acryloyl group-containing | | | | | | |
| compound having a polyolefin structural | | | | | | |
| unit 1 | | | | | | |
| (Meth)acryloyl group-containing compound | | | | | | |
| having a polyolefin structural unit 2 | | | | | | |
| (Meth)acryloyl group-containing compound | | | | | | |
| having a polyolefin structural unit 3 | | | | | | |
| (Meth)acryloyl group-containing compound | | | | | | |
| having a hydrogenated polyolefin | | | | | | |
| structural unit 4 | | | | | | |
| (Meth)acryloyl group-containing compound | | | 35.0 | | | |
| having a hydrogenated polyolefin | | | | | | |
| structural unit 5 | | | | | | |
| (Meth)acryloyl group-containing compound | | | | 19.4 | | |
| having a hydrogenated polyolefin | | | | | | |
| structural unit 6 | | | | | | |
| (Meth)acryloyl group-containing compound | | | | | | |
| having a polyester structural unit 7 | | | | | | |
| (Meth)acryloyl group-containing compound | 30.0 | | | | | |
| having a polyester structural unit 8 | | | | | | |
| (Meth)acryloyl group-containing compound | | | | | | |
| having a polycarbonate structural unit 9 | | | | | | |
| (Meth)acryloyl group-containing compound | | 32.0 | | | | |
| having a polycarbonate structural unit 10 | | | | | | |
| Urethane acrylate SHIKOH UV-3000B*¹ | | | | | 50.0 | |
| Claprene ® UC-203*² | | | | | | 70.0 |
| Urethane acrylate monomer α | | | | 0.6 | | |
| Isobornyl acrylate *³ | | 10.0 | | | 30.0 | |
| Dicyclopentenyl oxylethyl methacrylate*⁴ | | 10.0 | | | | 30.0 |
| Lauryl acrylate *⁵ | 10.0 | | 5.0 | 15.0 | | |
| Isostearyl acrylate *⁶ | 10.0 | | 10.0 | | | |
| 2-hydroxypropyl methacrylate *⁷ | | | 3.5 | 3.5 | | |
| 4-hydroxyl butyl acrylate *⁸ | | | | | | |
| 2-hydroxy butyl methacrylate *⁹ | 4.0 | | | | | 10.0 |
| Hydrogenated terpene resin | | 21.0 | 12.0 | | | 30.0 |
| Clearon ®p85*¹⁰ | | | | | | |
| Hydrogenated terpene resin | 20.0 | | 12.0 | | | |
| Clearon ®k100*¹¹ | | | | | | |
| Hydrogenated terpene resin | | | | | | |
| Clearon ®m105*¹² | | | | | | |
| Hydrogenated polybutadiene polyol | 19.0 | 5.0 | 15.0 | 39.5 | | |
| Nisso-pb gi-1000*¹³ | | | | | | |
| Hydrogenated polyisoprene polyol | | | | | | |
| Epol *¹⁴ | | | | | | |
| Hydrogenated dimer diol | | 9.0 | | | | |
| Pripol2033*¹⁵ | | | | | | |
| Hydrogenated polybutadiene | | | | | | |
| Nisso-pb bi-2000*¹⁶ | | | | | | |
| Poly(α-olefin)liquid substance | 6.0 | | 6.5 | 11.0 | | |
| Spectrasyn40*¹⁷ | | | | | | |
| Ethylene-α-olefin copolymer liquid | | 12.0 | | | | |
| substance HC-40*¹⁸ | | | | | | |
| Liquid polybutene HV-35*¹⁹ | | | | 10.0 | | |
| Liquid polybutadiene POLYVEST 110*²⁰ | | | | | | 140.0 |
| Irganox1010*²¹ | 1.0 | 1.0 | 1.0 | 1.0 | | 0.3 |
| Photopolymerization initiator speedcure | 1.0 | 1.0 | 1.0 | 1.0 | 1.0 | 0.5 |
| TPO*²² | | | | | | |
| Photopolymerization initiator IRGACURE | | | | | 3.0 | 4.0 |
| 184*²³ | | | | | | |
| Viscosity of polymerizable composition | 3200 mPa · s | 2900 mPa · s | 4200 mPa · s | 3300 mPa · s | 3000 mPa · s | 3500 mPa · s |
| (25° C.) | | | | | | |

*¹Urethane acrylate SHIKOH UV-3000B (polyester type urethane acrylate, manufactured by The Nippon Synthetic Chemical Industry Co., Ltd.)
*²Kuraprene UC-203 (esterified product of a maleic anhydride adduct of a polyisoprene polymer and 2-hydroxyethyl methacrylate, manufactured by KURARAY CO., LTD.)
*³ Isobornyl acrylate (trade name; IBXA, manufactured by Osaka Organic Chemical Industry Ltd.)
*⁴Dicylopentenyl oxylethyl methacrylate (trade name; FA-512M, manufactured by Hitachi Chemical Co., Ltd.)
*⁵ Lauryl acrylate (trade name; BLEMMER LA, manufactured by NOF CORPORATION)
*⁶ Isostearyl acrylate (trade name; ISTA, manufactured by Osaka Organic Chemical Industry Ltd.)
*⁷ 2-hydroxypropyl methacrylate (trade name; HPMA, manufactured by MITSUBISHI RAYON CO., LTD.)
*⁸ 4-hydroxyl butyl acrylate (trade name; 4HBA, manufactured by Osaka Organic Chemical Industry Ltd.)
*⁹ 2-hydroxy butyl methacrylate (trade name; Light Ester HOB (N), manufactured by kyoeisha Chemical Co., Ltd.)
*¹⁰Hydrogenated terpene resins CLEARON ® P85 (manufactured by YASUHARA CHEMICAL Co., Ltd.)
*¹¹Hydrogenated terpene resins CLEARON ® K100 (manufactured by YASUHARA CHEMICAL Co., Ltd.)
*¹²Hydrogenated terpene resins CLEARON ® M105 (manufactured by YASUHARA CHEMICAL Co., Ltd.)
*¹³Hydrogenated polybutadiene polyol NISSO-PB GI-1000 (manufactured by Nippon Soda Co., Ltd.)
*¹⁴ Hydrogenated polyisoprene polyol Epol (manufactured by Idemitsu Kosan Co., Ltd.)
*¹⁵Hydrogenated dimer diol Pripol ® 2033 (manufactured by Croda Japan K.K.)
*¹⁶Hydrogenated polybutadiene NISSO-PB BI-2000 (manufactured by Nippon Soda Co., Ltd.)
*¹⁷Poly(α-olefin) liquid substance Spectrasyn 40 (manufactured by Exxon Mobil Corporation)
*¹⁸Ethylene-α-olefin copolymer liquid substance HC-40 (manufactured by Mitsui Chemicals, Inc.)
*¹⁹Liquid polybutene HV-35 (manufactured by JX Nippon Oil & Energy Corporation)
*²⁰Liquid polybutadiene POLYVEST 110 (Evonik Degussa Corporation manufactured by)
*²¹IRGANOX 1010 (compound name: pentaerythritol tetrakis[3-(3,5-di-tert-butyl-4-hydroxyphenyl)propionate], manufactured by BASF)
*²²Photopolymerization initiator SpeedCure TPO (compound name: 2,4,6-trimethylbenzoyl diphenylphosphine oxide, manufactured by Lambson)
*²³Photopolymerization initiator IRGACURE 184 (compound name: 1-hydroxycyclohexyl phenyl ketone, manufactured by BASF)

### <Manufacturing of Optical Adhesive Sheet>

Polymerizable compositions A1 to A11, and polymerizable compositions B1 and B2 as listed on Table 1 were applied on a silicone-coated polyethylene terephthalate (hereinafter, referred to as PET) film (100 mm×100 mm×50 μm) by using an applicator such that the thickness of the film was 200 μm. The upper surface was covered with a silicone-coated PET film having a thickness of 25 μm, and then, was irradiated with an ultraviolet through the silicone-coated PET film by using a conveyer type UV irradiation system (manufactured by GS Yuasa Lighting Ltd., trade name: GSN2-40) using a metal halide lamp under conditions of an irradiation intensity of 190 mW/cm² (value at 365 nm) and an irradiation amount of 2800 mJ/cm² (value at 365 nm) to be polymerized, thereby obtaining an optical adhesive sheet whose film thickness in a state in which the optical adhesive sheet was sandwiched between mold releasing PET films was approximately 200 μm. The optical adhesive sheets manufactured by using polymerizable compositions A1 to A11, and polymerizable compositions B1 and B2 were designated adhesive sheets A1 to A11, and adhesive sheets B1 and B2, respectively.

### <Preparation Method of Test Piece by Using the Adhesive Sheet and Evaluation of Initial Optical Properties>

Using the adhesive sheets A1 to A11, and adhesive sheets B1 and B2, test pieces were prepared by sticking two glass plates (50 mm×50 mm×0.7 mm, type of the glass, trade name: EAGLE XG®, manufactured by CORNING) on each adhesive sheet such that the adhesive sheet was sandwiched between the glass plates on both sides thereof and such that an air bubble did not enter the interface.

The test pieces prepared by using the adhesive sheets A1 to A11, and adhesive sheets B1 and B2 were designated test pieces AS1 to AS11, and test pieces BS1 and BS2, respectively. The overall light transmittance and b* of the test pieces were measured by the following methods. The results thereof are listed on Table 3.

### <Preparation Method of Test Piece and Evaluation of Initial Optical Properties>

Polymerizable compositions A4 to A11, and polymerizable compositions B1 and B2 were applied on a glass plate (50 mm×50 mm×0.7 mm, glass type, trade name: EAGLE XG®, manufactured by CORNING) by using a bar coater such that the thickness of the film was 200 μm. Each glass plate was sandwiched between glass plates each having a similar type and a similar shape, and then, was irradiated with an ultraviolet through the glass plate by using a conveyer type ultraviolet irradiation device (manufactured by GS Yuasa Lighting Ltd., trade name: GSN2-40) using a metal halide lamp under conditions of an irradiation intensity of 190 mW/cm² (value at 365 nm) and an irradiation amount of 2800 mJ/cm² (value at 365 nm) to be polymerized, thereby obtaining a polymerization product film for an evaluation test whose film thickness in a state in which the optical adhesive sheet was sandwiched between the glass plates was approximately 200 μm. The polymerization product films for an evaluation test whose film thickness in a state in which the optical adhesive sheet was sandwiched between the glass plates was approximately 200 μm which were manufactured by using the polymerizable compositions A4 to A11, and the polymerizable compositions B1 and B2 were designated test pieces AL4 to AL11, and test pieces BL1 and BL2, respectively. The overall light transmittance and b* of the test pieces were measured by the following method. The results thereof are listed on Table 3.

### <Measurement of Overall Light Transmittance>

By using a glass plate (50 mm×50 mm×0.7 mm, type of glass, trade name: EAGLE XG®, manufactured by CORNING) as a reference, the overall light transmittance of each of the test pieces AS1 to AS11, test pieces AL4 to AL11, test piece BS1, test piece BS2, test piece BL1 and test piece BL2 was measured in accordance with JIS K 7361-1. The results thereof are listed on Table 3.

<Measurement of b*>

By using a glass plate (50 mm×50 mm×0.7 mm, type of glass, trade name: EAGLE XG®, manufactured by CORNING) as a reference, the b* of each of the test pieces AS1 to AS11, test pieces AL4 to AL11, test piece BS1, test piece BS2, test piece BL1 and test piece BL2 was measured in accordance with JIS Z 8729. The results thereof are listed on Table 3.

### <Measurement of Haze>

By using a glass plate (50 mm×50 mm×0.7 mm, type of glass, trade name: EAGLE XG®, manufactured by CORNING) as a reference, the haze of each of the test pieces AS1 to AS11, test pieces AL4 to AL11, test piece BS1, test piece BS2, test piece BL1 and test piece BL2 was measured in accordance with JIS K 7136. The results thereof are listed on Table 3.

### <Measurement of Dielectric Constant>

By using two silicone coated PET films, polymerizable compositions A1 to A11, polymerizable composition B1 and polymerizable composition B2 were sandwiched therebetween such that the film thickness was 2 mm, and then, was irradiated with a UV light having an irradiation intensity of 190 mW/cm² (value at 365 nm) and having an irradiation amount of 2800 mJ/cm² (value at 365 nm) through a silicone coated PET film using a conveyer type ultraviolet irradiation device (manufactured by GS Yuasa Lighting Ltd., trade name: GSN2-40) using a metal halide lamp to polymerize, thereby obtaining a polymerization product film for evaluation test in which the film thickness between the silicone coated PET films was about 2 mm. This polymerization product film was separated from a silicone coated PET film, and measurement was performed by using an impedance analyzer (manufactured by Agilent Technologies Inc., trade name: 4294A Precision Impedance Analyzer 40 Hz to 110 MHz). The results thereof are listed on Table 2.

Polymerization product films having a thickness of 2 mm separated from silicone coated PET films obtained by polymerizing polymerizable compositions A1 to A11, polymerizable composition B1 and polymerizable composition B2 are designated polymerization product films A1 to A11, and polymerization product film B1 and polymerization product film B2, respectively.

### <Measurement of Volume Shrinkage Rate During Polymerization>

The densities of polymerizable compositions A1 to A11, polymerizable composition B1 and polymerizable composition B2 before polymerization, and polymerization product thereof were measured using a specific gravity meter (model: DMA-220H, manufactured by SHINKO DENSHI CO., LTD.) in a temperature condition of 23° C., and the volume shrinkage rate during polymerization was calculated based on the following formula:

volume shrinkage rate (%) during polymerization=(density of polymerization product−density of polymerizable composition)/(density of polymerization product)×100.

The results thereof are listed on Table 2.

### <Measurement of Refractive Index>

By using the polymerization product films A1 to A11, and polymerization product films B1 and B2, the refractive index was measured in accordance with JIS K 7105. The results thereof are listed on Table 2.

### <Measurement of Tensile Elasticity>

Polymerization product films A1 to A11, polymerization product films B1 and B2 were fixed on a tensile tester (manufactured by SHIMADZU CORPORATION, EZ Test/CE), and a test was performed at a drawing speed of 500 mm/min at 23° C. to determine the tensile elasticity. The results thereof are listed on Table 2.

<Measurement of Overall Light Transmittance, b* Value and Haze when Stored in a High Temperature Condition>

Each of the test pieces AS1 to AS11, test pieces AL4 to AL11, test piece BS1, test piece BS2, test piece BL1 and test piece BL2 was input in a constant temperature apparatuse whose temperature was 70° C., 85° C. or 95° C., and by using a test piece which was left to stand for 500 hours, the overall light transmittance, b* value and haze thereof were measured by the above-mentioned methods. The results thereof are listed on Table 3.

<Measurement of Overall Light Transmittance, b* Value and Haze when Stored in a High Temperature and High Humidity Condition>

Each of the test pieces AS1 to AS11, test pieces AL4 to AL11, test piece BS1, test piece BS2, test piece BL1, and test piece BL2 was input in a constant temperature apparatus whose temperature and humidity were 60° C. and 90% RH, respectively, and by using a test piece which was left to stand for 500 hours, the overall light transmittance, b* value and haze thereof were measured by the above-mentioned methods. The results thereof are listed on Table 3.

TABLE 2

| | Name of polymerizable composition used | | | | | | |
|---|---|---|---|---|---|---|---|
| | Polymerizable | Polymerizable | Polymerizable | Polymerizable | Polymerizable | Polymerizable | Polymerizable |
| | composition | composition | composition | composition | composition | composition | composition |
| | A1 | A2 | A3 | A4 | A5 | A6 | A7 |
| Name of | Polymerization | Polymerization | Polymerization | Polymerization | Polymerization | Polymerization | Polymerization |
| polymerization | product film | product film | product film | product film | product film | product film | product film |
| product film | A1 | A2 | A3 | A4 | A5 | A6 | A7 |
| used | | | | | | | |
| Volume | 3.5% | 2.8% | 3.8% | 2.4% | 1.9% | 1.8% | 2.4% |
| shrinkage rate | | | | | | | |
| during | | | | | | | |
| polymerization | | | | | | | |
| (23° C.) | | | | | | | |
| Refractive | 1.49 | 1.49 | 1.50 | 1.50 | 1.49 | 1.49 | 1.53 |
| index of | | | | | | | |
| polymerization | | | | | | | |
| product film | | | | | | | |
| n_{D} (25° C.) | | | | | | | |
| Tensile | 1.8 × 10⁵ Pa | 0.9 × 10⁵ Pa | 2.2 × 10⁵ Pa | 1.8 × 10⁵ Pa | 1.3 × 10⁵ Pa | 0.9 × 10⁵ Pa | 1.9 × 10⁵ Pa |
| elasticity | | | | | | | |
| (23° C.) | | | | | | | |
| Dielectric | 3.0 | 2.9 | 2.9 | 3.0 | 2.9 | 2.7 | 3.0 |
| constant | | | | | | | |
| (23° C., 1 MHz, | | | | | | | |
| 100 mV) | | | | | | | |

| | Name of polymerizable composition used | | | | | |
|---|---|---|---|---|---|---|
| | Polymerizable | Polymerizable | Polymerizable | Polymerizable | Polymerizable | Polymerizable |
| | composition | composition | composition | composition | composition | composition |
| | A8 | A9 | A10 | A11 | B1 | B2 |
| Name of | Polymerization | Polymerization | Polymerization | Polymerization | Composition | Composition |
| polymerization | product film | product film | product film | product film | B1 | B2 |
| product film | A8 | A9 | A10 | A11 | | |
| used | | | | | | |
| Volume | 3.3% | 3.7% | 2.1% | 2.0% | 4.5% | 1.8% |
| shrinkage rate | | | | | | |
| during | | | | | | |
| polymerization | | | | | | |
| (23° C.) | | | | | | |
| Refractive | 1.50 | 1.52 | 1.49 | 1.48 | 1.47 | 1.52 |
| index of | | | | | | |
| polymerization | | | | | | |
| product film | | | | | | |
| n_{D} (25° C.) | | | | | | |
| Tensile | 1.7 × 10⁵ Pa | 1.8 × 10⁵ Pa | 1.1 × 10⁵ Pa | 1.5 × 10⁵ Pa | 1.0 × 10⁵ Pa | 1.0 × 10⁴ Pa |
| elasticity | | | | | | |
| (23° C.) | | | | | | |
| Dielectric | 3.0 | 3.0 | 2.8 | 2.8 | 3.2 | 2.9 |
| constant | | | | | | |
| (23° C., 1 MHz, | | | | | | |
| 100 mV) | | | | | | |

TABLE 3

| | | Temperature condition | | | | | | | |
|---|---|---|---|---|---|---|---|---|---|
| | | 70° C. | 85° C. | 95° C. | 60° C., 90% RH | | | | |
| | | Immediately after polymerization | | | | 70° C. | 85° C. | 95° C. | 60° C., 90% RH |
| | | (after 0 hours) | | | | After 500 hours | | | |
| Test | b* | 0.20 | 0.19 | 0.17 | 0.16 | 0.19 | 0.60 | 0.91 | 0.34 |
| piece | Total light transmittance | 99.8 | 99.8 | 99.8 | 99.8 | 99.8 | 99.7 | 99.7 | 99.7 |
| AS1 | Haze | 0.0 | 0.0 | 0.0 | 0.0 | 0.0 | 0.1 | 0.3 | 4.0 |
| Test | b* | 0.24 | 0.24 | 0.22 | 0.21 | 0.28 | 0.50 | 0.77 | 0.30 |
| piece | Total light transmittance | 99.8 | 99.8 | 99.8 | 99.8 | 99.9 | 99.8 | 99.8 | 99.7 |
| AS2 | Haze | 0.0 | 0.0 | 0.0 | 0.0 | 0.0 | 0.0 | 0.2 | 3.7 |
| Test | b* | 0.20 | 0.18 | 0.16 | 0.14 | 0.31 | 0.60 | 1.01 | 0.34 |
| piece | Total light transmittance | 99.8 | 99.8 | 99.8 | 99.8 | 99.8 | 99.7 | 99.7 | 99.7 |
| AS3 | Haze | 0.0 | 0.0 | 0.0 | 0.0 | 0.0 | 0.1 | 0.1 | 3.9 |
| Test | b* | 0.19 | 0.16 | 0.18 | 0.14 | 0.23 | 0.60 | 0.97 | 0.34 |
| piece | Total light transmittance | 99.8 | 99.8 | 99.8 | 99.8 | 99.8 | 99.7 | 99.7 | 99.7 |
| AS4 | Haze | 0.0 | 0.0 | 0.0 | 0.0 | 0.0 | 0.1 | 0.1 | 0.3 |
| Test | b* | 0.17 | 0.17 | 0.18 | 0.14 | 0.18 | 0.24 | 0.29 | 0.22 |
| piece | Total light transmittance | 99.7 | 99.8 | 99.9 | 99.8 | 99.8 | 99.8 | 99.6 | 99.5 |
| AS5 | Haze | 0.1 | 0.1 | 0.1 | 0.1 | 0.1 | 0.1 | 0.1 | 0.3 |
| Test | b* | 0.21 | 0.19 | 0.17 | 0.18 | 0.21 | 0.23 | 0.28 | 0.22 |
| piece | Total light transmittance | 99.8 | 99.8 | 99.9 | 99.9 | 99.9 | 99.8 | 99.8 | 99.7 |
| AS6 | Haze | 0.0 | 0.0 | 0.0 | 0.0 | 0.0 | 0.0 | 0.00 | 0.0 |
| Test | b* | 0.20 | 0.23 | 0.25 | 0.22 | 0.22 | 0.38 | 0.76 | 0.22 |
| piece | Total light transmittance | 99.8 | 99.8 | 99.8 | 99.8 | 99.8 | 99.8 | 99.7 | 99.7 |
| AS7 | Haze | 0.0 | 0.0 | 0.0 | 0.0 | 0.1 | 0.0 | 0.0 | 0.1 |
| Test | b* | 0.20 | 0.18 | 0.16 | 0.22 | 0.22 | 0.39 | 0.67 | 0.30 |
| piece | Total light transmittance | 99.8 | 99.8 | 99.8 | 99.8 | 99.8 | 99.7 | 99.7 | 99.7 |
| AS8 | Haze | 0.0 | 0.0 | 0.0 | 0.0 | 0.0 | 0.1 | 0.1 | 0.0 |
| Test | b* | 0.19 | 0.16 | 0.18 | 0.22 | 0.21 | 0.41 | 0.69 | 0.22 |
| piece | Total light transmittance | 99.8 | 99.8 | 99.8 | 99.8 | 99.8 | 99.7 | 99.7 | 99.7 |
| AS9 | Haze | 0.0 | 0.0 | 0.0 | 0.0 | 0.0 | 0.1 | 0.1 | 0.0 |
| Test | b* | 0.20 | 0.21 | 0.21 | 0.22 | 0.21 | 0.24 | 0.34 | 0.22 |
| piece | Total light transmittance | 99.8 | 99.8 | 99.8 | 99.9 | 99.8 | 99.7 | 99.7 | 99.7 |
| AS10 | Haze | 0.0 | 0.0 | 0.0 | 0.0 | 0.0 | 0.1 | 0.1 | 0.0 |
| Test | b* | 0.19 | 0.16 | 0.18 | 0.19 | 0.21 | 0.34 | 0.36 | 0.22 |
| piece | Total light transmittance | 99.8 | 99.8 | 99.8 | 99.8 | 99.8 | 99.7 | 99.7 | 99.7 |
| AS11 | Haze | 0.0 | 0.0 | 0.0 | 0.0 | 0.0 | 0.1 | 0.1 | 0.1 |
| Test | b* | 0.19 | 0.16 | 0.18 | 0.14 | 0.23 | 0.60 | 0.97 | 0.34 |
| piece | Total light transmittance | 99.8 | 99.8 | 99.8 | 99.8 | 99.8 | 99.7 | 99.7 | 99.7 |
| AL4 | Haze | 0.0 | 0.0 | 0.0 | 0.0 | 0.0 | 0.1 | 0.1 | 0.3 |
| Test | b* | 0.17 | 0.17 | 0.18 | 0.14 | 0.18 | 0.24 | 0.29 | 0.22 |
| piece | Total light transmittance | 99.7 | 99.8 | 99.9 | 99.8 | 99.8 | 99.8 | 99.6 | 99.5 |
| AL5 | Haze | 0.1 | 0.1 | 0.1 | 0.1 | 0.1 | 0.1 | 0.1 | 0.3 |
| Test | b* | 0.21 | 0.19 | 0.17 | 0.18 | 0.21 | 0.23 | 0.28 | 0.22 |
| piece | Total light transmittance | 99.8 | 99.8 | 99.9 | 99.9 | 99.9 | 99.8 | 99.8 | 99.7 |
| AL6 | Haze | 0.0 | 0.0 | 0.0 | 0.0 | 0.0 | 0.0 | 0.00 | 0.0 |
| Test | b* | 0.20 | 0.23 | 0.25 | 0.22 | 0.22 | 0.38 | 0.76 | 0.22 |
| piece | Total light transmittance | 99.8 | 99.8 | 99.8 | 99.8 | 99.8 | 99.8 | 99.7 | 99.7 |
| AL7 | Haze | 0.0 | 0.0 | 0.0 | 0.0 | 0.1 | 0.0 | 0.0 | 0.1 |
| Test | b* | 0.20 | 0.18 | 0.16 | 0.22 | 0.22 | 0.39 | 0.67 | 0.30 |
| piece | Total light transmittance | 99.8 | 99.8 | 99.8 | 99.8 | 99.8 | 99.7 | 99.7 | 99.7 |
| AL8 | Haze | 0.0 | 0.0 | 0.0 | 0.0 | 0.0 | 0.1 | 0.1 | 0.0 |
| Test | b* | 0.19 | 0.16 | 0.18 | 0.22 | 0.21 | 0.41 | 0.69 | 0.22 |
| piece | Total light transmittance | 99.8 | 99.8 | 99.8 | 99.8 | 99.8 | 99.7 | 99.7 | 99.7 |
| AL9 | Haze | 0.0 | 0.0 | 0.0 | 0.0 | 0.0 | 0.1 | 0.1 | 0.0 |
| Test | b* | 0.20 | 0.21 | 0.21 | 0.22 | 0.21 | 0.24 | 0.34 | 0.22 |
| piece | Total light transmittance | 99.8 | 99.8 | 99.8 | 99.9 | 99.8 | 99.7 | 99.7 | 99.7 |
| AL10 | Haze | 0.0 | 0.0 | 0.0 | 0.0 | 0.0 | 0.1 | 0.1 | 0.0 |
| Test | b* | 0.19 | 0.16 | 0.18 | 0.19 | 0.21 | 0.34 | 0.36 | 0.22 |
| piece | Total light transmittance | 99.8 | 99.8 | 99.8 | 99.8 | 99.8 | 99.7 | 99.7 | 99.7 |
| AL11 | Haze | 0.0 | 0.0 | 0.0 | 0.0 | 0.0 | 0.1 | 0.1 | 0.1 |
| Test | b* | 0.22 | 0.22 | 0.22 | 0.22 | 0.23 | 0.27 | 0.60 | 0.34 |
| piece | Total light transmittance | 99.8 | 99.8 | 99.8 | 99.8 | 99.8 | 99.8 | 99.8 | 99.7 |
| BS1 | Haze | 0.2 | 0.2 | 0.2 | 0.0 | 0.0 | 0.0 | 0.1 | 4.0 |
| Test | b* | 0.19 | 0.19 | 0.19 | 0.19 | 0.32 | 0.40 | 0.90 | 0.35 |
| piece | Total light transmittance | 99.8 | 99.8 | 99.8 | 99.8 | 99.8 | 99.8 | 99.8 | 99.7 |
| BS2 | Haze | 0.1 | 0.1 | 0.1 | 0.0 | 0.1 | 0.1 | 0.1 | 0.1 |
| Test | b* | 0.22 | 0.22 | 0.22 | 0.22 | 0.23 | 0.27 | 0.60 | 0.34 |
| piece | Total light transmittance | 99.8 | 99.8 | 99.8 | 99.8 | 99.8 | 99.8 | 99.8 | 99.7 |
| BL1 | Haze | 0.2 | 0.2 | 0.2 | 0.0 | 0.0 | 0.0 | 0.1 | 4.0 |
| Test | b* | 0.19 | 0.19 | 0.19 | 0.19 | 0.32 | 0.40 | 0.90 | 0.35 |
| piece | Total light transmittance | 99.8 | 99.8 | 99.8 | 99.8 | 99.8 | 99.8 | 99.8 | 99.7 |
| BL2 | Haze | 0.1 | 0.1 | 0.1 | 0.0 | 0.1 | 0.1 | 0.1 | 0.1 |

From the results in Table 2 and Table 3, it was found that the polymerizable composition of the invention (I) had a low volume shrinkage rate during polymerization, and in the polymerization product obtained by polymerizing the polymerizable composition of the invention (II), a change in the outer appearance such as coloration hardly occurred when stored for a long term in a high temperature condition, and a favorable optical transparency can be maintained.

### INDUSTRIAL APPLICABILITY

As mentioned above, the polymerizable composition of the invention (I) has a low volume shrinkage rate during polymerization, and in the polymerization product film obtained by polymerizing the polymerizable composition of the invention (I), a change in the outer appearance such as coloration hardly occurs when stored for a long term in a high temperature condition, and a favorable optical transparency can be maintained. Accordingly, a favorable optical adhesive layer can be provided when the polymerization product film is used as a transparent optical resin layer interposed between the image-display unit and the light-transmitting protection unit of the image-display device.

In other words, the use of the polymerization product for an image-display device is advantageous.

### DESCRIPTION OF THE REFERENCE NUMERALS

1 Image-display device
2 Image-display unit
3 Protection unit
3a Touch sensor integrated protection unit
4 Spacer
5a,5b Polymerization product layer
6a,6b Polarizing plate

1. A polymerizable composition for manufacturing a polymerization product for forming a polymerization product layer interposed between an image-display unit and a light-transmitting protection unit of an image-display device, wherein the polymerizable composition comprises
Component (1): at least one selected from the group consisting of a (meth)acryloyl group-containing compound having a polyolefin structural unit, a (meth)acryloyl group-containing compound having a hydrogenated polyolefin structural unit, a (meth)acryloyl group-containing compound having a (poly)ester structural unit, and a (meth)acryloyl group-containing compound having a (poly)carbonate structural unit;
Component (2): a liquid (meth)acryloyl group-containing compound other than Component (1);
Component (3): at least one selected from the group consisting of a liquid hydrogenated polybutadiene polyol, a liquid hydrogenated polyisoprene polyol, and a hydrogenated dimer diol; and
Component (4): a photopolymerization initiator.

2. The polymerizable composition according to claim 1, further comprising
Component (5): at least one selected from the group consisting of hydrogenated polybutadiene, hydrogenated polyisoprene, a poly(α-olefin) liquid substance, an ethylene-propylene copolymer liquid substance, a propylene-α-olefin copolymer liquid substance, an ethylene-α-olefin copolymer liquid substance, liquid polybutene, liquid hydrogenated polybutene, liquid polybutadiene, liquid hydrogenated polybutadiene, liquid polyisoprene, liquid hydrogenated polyisoprene, liquid polybutadiene polyol, and liquid polyisoprene polyol.

3. The polymerizable composition according to claim 1, further comprising
Component (6): at least one selected from the group consisting of hydrogenated petroleum resins, hydrogenated terpene resins, and a hydrogenated rosin ester.

4. The polymerizable composition according to claim 1, wherein Component (2) comprises a (meth)acryloyl group-containing compound having a hydrocarbon group containing six or more carbon atoms.

5. The polymerizable composition according to claim 1, wherein Component (2) comprises a (meth)acryloyl group-containing compound having an alcoholic hydroxyl group.

6. A polymerization product obtained by polymerizing the polymerizable composition according to claim 1.

7. A polymerizable composition for manufacturing an optical adhesive sheet used for the polymerization product layer, wherein the polymerizable composition is the polymerizable composition according to claim 1.

8. An optical adhesive sheet having a polymerization product layer having a thickness of 10 to 500 μm, which is obtained by irradiating the polymerizable composition according to claim 7 with a light to which the photopolymerization initiator is photosensitive to polymerize.

9. A method of manufacturing an image-display device comprising a base unit having an image-display unit, a light-transmitting protection unit, and a polymerization product layer interposed between the base unit and the protection unit, comprising the steps of
interposing the polymerizable composition according to claim 1 between the base unit and the protection unit; and
irradiating the polymerizable composition with a light to which the photopolymerization initiator is photosensitive to form a polymerization product layer.

10. A method of manufacturing an image-display device, comprising the step of sticking a polymerization product layer between a base unit having an image-display unit and a light-transmitting protection unit by using an optical adhesive sheet, wherein the optical adhesive sheet is the optical adhesive sheet according to claim 8.

11. An image-display device manufactured by the method according to claim 9.

12. The image-display device according to claim 11, wherein the image-display unit is a liquid crystal display panel.

13. The polymerizable composition according to claim 2, further comprising
Component (6): at least one selected from the group consisting of hydrogenated petroleum resins, hydrogenated terpene resins, and a hydrogenated rosin ester.
